(19) United States
(12) Patent Application Publication
(10) Pub. No.: US 2018/0345289 A1
(43) Pub. Date: Dec. 6, 2018

(54) SPECIMEN PROCESSING CHIP, LIQUID FEEDER AND LIQUID FEEDING METHOD OF SPECIMEN PROCESSING CHIP

(71) Applicant: SYSMEX CORPORATION, Kobe-shi (JP)

(72) Inventors: Nobuhiro KITAGAWA, Kobe-shi (JP); Yoshinobu MIURA, Kobe-shi (JP); Michitaka NOTOYA, Kobe-shi, (JP); Kenichiro SUZUKI, Kobe-shi (JP)

(21) Appl. No.: 15/992,921

(22) Filed: May 30, 2018

(30) Foreign Application Priority Data
May 31, 2017 (JP) 2017-108847

(51) Int. Cl. B01L 3/00

(52) U.S. Cl. CPC B01L 3/545; B01L 3/502715; B01L 3/50855; B01L 2300/0832; B01L 2200/10; B01L 2300/021; B01L 2200/0642

(57) ABSTRACT

Disclosed is a specimen processing chip installed in a liquid feeder, comprising a flow path into which a first liquid and a second liquid flow, a first well having a first injection port into which the first liquid is injected by an operator, and a first liquid feed port for feeding the first liquid injected from the first injection port to the flow path, that is smaller in diameter than the first injection port, a second well having a second injection port into which the second liquid fed from the liquid feeder is injected, and a second liquid feed port for feeding the second liquid injected from the second injection port to the flow path, that is smaller in diameter than the second injection port, and an identification section for distinguishing between the first injection port and the second injection port.

### CROSS REFERENCE TO RELATED APPLICATIONS

This application claims priority from prior Japanese Patent Application No. 2017-108847, filed on May 31, 2017, entitled “SPECIMEN PROCESSING CHIP, LIQUID FEEDER AND LIQUID FEEDING METHOD OF SPECIMEN PROCESSING CHIP”, the entire contents of which are incorporated herein by reference.

### TECHNICAL FIELD

There is a technique of feeding various liquids to a specimen processing chip in order to perform specimen processing using a cartridge type specimen processing chip (see, for example, U.S. Pat. No. 9,126,160).

### BACKGROUND

U.S. Pat. No. 9,126,160 discloses, as shown in FIG. 62, a technique of feeding various liquids for performing specimen processing using a cartridge 900 that is a specimen processing chip on which a plurality of wells 901 for holding liquid is formed. In FIG. 62, the cartridge 900 includes four wells 901 of two oil wells 901a, one sample well 901b, and one collection well 901c. Each well 901 is connected via a fluid channel 902 formed in the cartridge 900. The oil fed from the two oil wells 901a and a sample and a reagent fed from the sample well 901b join in the fluid channel 902, and droplets of the sample and the reagent are formed in the oil and stored in the collection well 901c. A liquid can be injected into each well 901 manually by the user.

### SUMMARY OF THE INVENTION

The scope of the present invention is defined solely by the appended claims, and is not affected to any degree by the statements within this summary.

In the technique described in U.S. Pat. No. 9,126,160, a plurality of types of liquids such as oils and samples used for processing is injected into corresponding wells 901, respectively, and then liquid is fed. Thus, when injecting each liquid, it is necessary to prevent injection into the wrong well 901. However, when there is a plurality of similar wells 901, the operator easily mistakes well 901 in which the liquid is to be injected, and it is desirable that an error in the injection position of the liquid is suppressed.

In addition, an operation of injecting the liquid to all the wells 901 holding the liquid by the user causes complication of the specimen processing work. Therefore, it is desirable to reduce the operation of injecting various liquids used for processing. It is desirable to reduce the operation of injecting the liquid, also from the viewpoint of suppressing the injection of the liquid into wrong well 901.

The present invention is directed, when injecting a liquid into a specimen processing chip, to suppress an error in the liquid injection position by the operator while suppressing complication of operations.

A specimen processing chip according to a first aspect of this invention is a specimen processing chip (100) installed in a liquid feeder (500), comprising a flow path (110) into which a first liquid (10) and a second liquid (20) flow, a first well (120) having a first injection port (121) into which the first liquid (10) is injected by an operator, and a first liquid feed port (122) for feeding the first liquid (10) injected from the first injection port (121) to the flow path (110), that is smaller in diameter than the first injection port (121), a second well (130) having a second injection port (131) into which the second liquid (20) is fed from the liquid feeder (500), and a second liquid feed port (132) for feeding the second liquid (20) injected from the second injection port (131) to the flow path (110), that is smaller in diameter than the second injection port (131), and an identification section (180) for distinguishing between the first injection port (121) and the second injection port (131).

A specimen processing chip according to a second aspect of this invention is a specimen processing chip (100) installed in a liquid feeder (500), comprising a flow path (110) into which a first liquid (10) and a second liquid (20) flow, a first well (120) having a first injection port (121) into which the first liquid (10) is injected by an operator, a second well (130) having a second injection port (131) into which the second liquid (20) is fed from the liquid feeder (500), and an identification section (180) for distinguishing between the first injection port (121) and the second injection port (131), wherein the first injection port (121) and the second injection port (131) are substantially the same in diameter.

A specimen processing chip according to a third aspect of this invention is a specimen processing chip (100) installed in a liquid feeder (500), comprising a flow path (110) into which a first liquid (10) and a second liquid (20) flow, a first well (120) having a first injection port (121) having a diameter of 2 mm or more and 15 mm or less and into which the first liquid (10) is injected from the first injection port (121) by an operator, a second well (130) having a second injection port (131) having a diameter of 2 mm or more and 15 mm or less and into which the second liquid (20) fed from the liquid feeder (500) is injected, and an identification section (180) for distinguishing between the first injection port (121) and the second injection port (131).

A specimen processing chip according to a fourth aspect of this invention is a specimen processing chip (100) installed in a liquid feeder (500), comprising a flow path (110) into which a first liquid (10) and a second liquid (20) flow, a first well (120) having a first injection port (121) into which the first liquid (10) is injected by an operator, a second well (130) having a second injection port (131) into which the second liquid (20) is fed from the liquid feeder (500), and an identification section (180) for distinguishing between the first injection port (121) and the second injection port (131), wherein the positions of the first injection port (121) and the second injection port (131) in the thickness direction of the specimen processing chip (100) substantially coincide.

The liquid feeder for a specimen processing chip according to a fifth aspect of this invention is a liquid feeder (500) for feeding liquid to a specimen processing chip (100) having a flow path (110) into which liquid flows, comprising an installation section (550) on which the specimen processing chip (100) is installed, a first liquid feeding mechanism (510) for feeding a first liquid (10) injected into a first well (120) through a first injection port (121) formed in the first well (120) of the specimen processing chip (100) to the flow path (110) from a first liquid feed port (122) smaller than the first injection port (121), that is formed in the first well (120), a second liquid feeding mechanism (520) for feeding liquid to a second well (130) through a second injection port (131) formed in the second well (130) of the specimen processing chip (100) and feeding a second liquid (20) fed to the second well (130) to the flow path (110) from a second liquid feed port (132) smaller than the second injection port (131) formed in the second well (130), and an identification mechanism (540) for distinguishing between the first injection port (121) and the second injection port (131), in the specimen processing chip (100) installed in the installation section (550).

The liquid feeding method for feeding liquid to a specimen processing chip (100) according to a sixth aspect of this invention is a liquid feeding method for feeding liquid to a specimen processing chip (100) having a flow path (110) into which liquid flows, including injecting a first liquid (10) using an injection tool (700), from a first injection port (121) of a first well (120) to which an identification section (180) is given, provided in the specimen processing chip (100), feeding the first liquid (10) injected through the first injection port (121) from the first liquid feed port (122) of the first well (120) having a smaller diameter than the first injection port (121) to the flow path (110) by a liquid feeder (500), feeding a second liquid (20) from the liquid feeder (500) through a second injection port (131) of a second well (130) to which the identification section (180) is not given, provided in the specimen processing chip (100), feeding the second liquid (20) fed to the second well (130) from the second liquid feed port (132) of the second well (130) having a smaller diameter than the second injection port (131) to the flow path (110), and forming a fluid containing the first liquid (10) fed from the first liquid feed port (122) and the second liquid (20) fed through the second liquid feed port (132), in the flow path (110).

### BRIEF DESCRIPTION OF THE DRAWINGS

FIG. 1 is a diagram for illustrating an outline of a specimen processing chip;

FIG. 2 is a diagram showing an example of injecting a first liquid into a well;

FIG. 3 is a diagram showing a configuration example of a specimen processing chip;

FIG. 4 is a diagram showing an example of a configuration in which a plurality of types of second liquids is fed to a common injection port;

FIG. 5 is a diagram showing an example of a well constituted of a cylindrical structure;

FIG. 6 is a diagram showing an example of a well constituted of a recessed portion;

FIG. 7 is a diagram showing an example in which a second opening portion opens on the surface of a main body part;

FIG. 8A is a diagram before connection (A), and FIG. 8B is a diagram after connection (B), in a first connection structure example of an opening portion and a connector;

FIG. 9A is a diagram before connection (A), and FIG. 9B is a diagram after connection (B), in a second connection structure example of an opening portion and a connector;

FIG. 10A is a diagram before connection (A), and FIG. 10B is a diagram after connection (B), in a third connection structure example of an opening portion and a connector;

FIGS. 11A to 11C are diagrams showing examples (A) to (C) of sizes of opening portions;

FIG. 12A is a diagram showing a printed mark (A), FIG. 12B is a diagram showing an engraved mark (B), FIG. 12C is a diagram showing a label mark (C), and FIG. 12D is a diagram showing a mark (D) provided on the surface of the well, that are examples of identification sections;

FIG. 13A is a diagram showing identification by outer diameter (A), FIG. 13B is a diagram showing identification by planar shape (B), and FIG. 13C is a diagram showing identification by height (C), that are examples of identification sections;

FIG. 14A is a diagram showing a first example (A) of a colored part, and FIG. 14B is a diagram showing a second example and a third example (B) of a colored part, that are examples of identification sections;

FIG. 15 is a perspective view showing a configuration example of a specimen processing chip;

FIG. 16 is a plan view showing a configuration example of a substrate of a specimen processing chip;

FIG. 17 is a schematic longitudinal sectional view showing an arrangement example of fluid modules on a substrate;

FIG. 18A is a plan view showing a first arrangement example (A), and FIG. 18B is a plan view showing a second arrangement example (B) of a flow path in a specimen processing chip;

FIG. 19 is a plan view showing a third arrangement example (C) of a flow path in a specimen processing chip;

FIG. 20 is a plan view showing an example of an identification section for collectively identifying a plurality of wells;

FIG. 21A is a diagram showing an example (A) of injecting a plurality of types of samples into a plurality of wells, and FIG. 21B is a diagram showing an example (B) of injecting a plurality of types of itemized reagents into a plurality of wells;

FIG. 22 is a diagram showing an example in which a plurality of wells is arranged at a predetermined pitch;

FIG. 23 is a diagram showing an example of collectively injecting a liquid into a plurality of wells of a constant pitch;

FIG. 24 is a diagram showing an arrangement example of wells and injection ports;

FIG. 25 is an example of identifying a unit flow path structure for specimen processing and a unit flow path structure for control;

FIG. 26 is a diagram showing an example of prepacking a third liquid in a well;

FIG. 27 is a diagram showing an example of opening a pre-packed well;

FIG. 28 is a perspective view showing a configuration example of a specimen processing chip;

FIG. 29A is a schematic diagram of a plan view (A), and FIG. 29B is a schematic diagram of a side view (B) in a state where a chip holder is opened;

FIG. 30A is a schematic diagram of a plan view (A), and FIG. 30B is a schematic diagram of a side view (B) in a state where a chip holder is closed;

FIG. 31 is a diagram for illustrating an outline of a liquid feeder;

FIG. 32 is a diagram showing a configuration example of a second liquid feeding mechanism;

FIG. 33 is a diagram showing a first example of an identification mechanism including a light emitting part;

FIG. 34 is a diagram showing a second example of an identification mechanism including a light emitting part;

FIG. 35 is a plan view of FIG. 34;

FIG. 36 is a diagram showing a first example of an identification mechanism including a display section;

FIG. 37 is a diagram showing a second example of an identification mechanism including a display section;

FIG. 38 is a block diagram showing a configuration example of a liquid feeder;

FIG. 39 is a perspective view showing a configuration example of a liquid feeder;

FIG. 40 is a cross-sectional view showing an example of an identification mechanism including an opening window portion of a lid;

FIG. 41 is a perspective view of a liquid feeder according to the configuration example of FIG. 40;

FIG. 42 is a diagram showing a configuration example of a liquid feeder that feeds a liquid to a specimen processing chip having a plurality of channels;

FIG. 43 is a longitudinal sectional view showing an example of a configuration that connects a liquid feeder and a specimen processing chip;

FIG. 44 is a diagram showing an example of forming an emulsion state by a specimen processing chip;

FIG. 45 is a plan view showing a first configuration example of a flow path for forming an emulsion state;

FIG. 46 is a plan view showing a second configuration example of a flow path for forming an emulsion state;

FIG. 47 is a diagram showing an example in which PCR is performed by a specimen processing chip;

FIG. 48 is a diagram showing an example in which demulsification is performed by a specimen processing chip;

FIG. 49 is a flow chart showing an example of an emulsion PCR assay;

FIG. 50 is a diagram for illustrating progress of the reaction in an emulsion PCR assay;

FIG. 51 is a diagram showing a configuration example of a specimen processing chip used in an emulsion PCR assay;

FIG. 52 is a diagram showing a configuration example of a flow path for performing Pre-PCR;

FIG. 53 is a diagram showing a configuration example of a flow path for forming an emulsion;

FIG. 54 is a diagram showing a configuration example of a flow path for performing PCR;

FIG. 55 is a diagram showing a configuration example of a flow path for performing emulsion breaking;

FIG. 56 is a diagram showing a configuration example of a flow path for performing a washing step (primary washing);

FIG. 57 is a diagram showing an example of operation of washing and concentrating magnetic particles in a flow path;

FIG. 58 is a diagram showing a configuration example of a specimen processing chip used for single cell analysis;

FIG. 59 is a diagram showing a configuration example of a specimen processing chip used for immunoassay;

FIG. 60 is a diagram for illustrating progress of the reaction in immunoassay;

FIG. 61 is a diagram showing a configuration example of a specimen processing chip used in a PCR assay; and

FIG. 62 is a diagram showing a configuration for feeding a liquid to a specimen processing chip in a conventional art.

### DETAILED DESCRIPTION OF THE PREFERRED EMBODIMENTS

Hereinafter, embodiments will be described with reference to the drawings.

[Outline of Specimen Processing Chip]

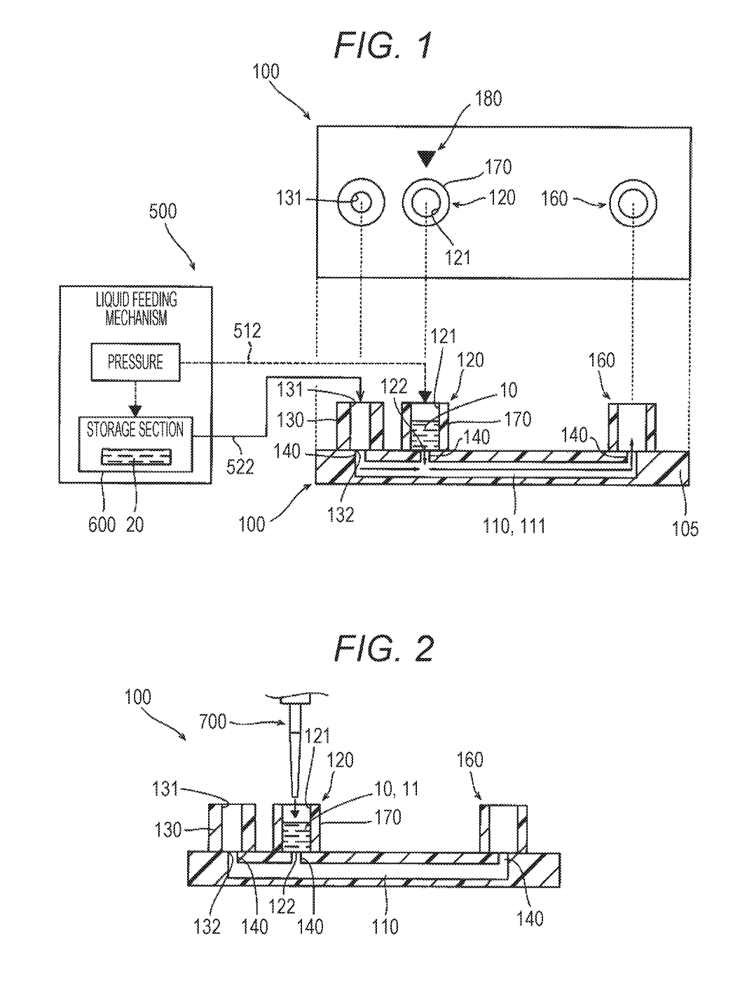

With reference to FIG. 1, an outline of a specimen processing chip according to this embodiment will be described.

A specimen processing chip 100 is a cartridge type specimen processing chip configured to be capable of receiving a specimen containing a target component. The cartridge type specimen processing chip 100 is installed in a liquid feeder 500 having a liquid feeding mechanism. Further, the specimen processing chip 100 is a microfluidic chip having a fine flow path for performing a desired processing step. The flow path is, for example, a microflow path having sectional dimensions (width, height, inner diameter) of 0.1 μm to 1000 μm.

As shown in FIG. 1, the specimen processing chip 100 is provided with a flow path 110, a first well 120 having a first injection port 121, and a second well 130 having a second injection port 131.

The flow path 110 is provided in the specimen processing chip 100, and is configured to form a flow of liquid through a predetermined path. The flow path 110 may have any structure as long as a liquid can be allowed to flow. The flow path 110 has a shape corresponding to the processing performed in the flow path. The flow path 110 is formed to have a flow path width, a flow path height, a flow path depth, a flow path length and a capacity according to the processing performed in the flow path. The flow path 110 is constituted by, for example, an elongated tubular passage or channel. The channel can be of a shape such as linear, curved, or zigzag. The flow path 110 may have a shape in which flow path dimensions such as flow path width and height changes, a shape in which a part or the whole of a flow path flatly expands, a chamber shape capable of storing an inflowing liquid, or the like.

The well is a structure configured to be capable of storing and holding a liquid inside. The well is formed in a structure having a predetermined volume for holding the liquid. The well communicates with the flow path 110, and the liquid held inside can move to the flow path 110. The well has an opening portion for injecting a liquid from the outside. The well may be in a protruding shape or a recessed shape.

The first well 120 has a first injection port 121 into which the first liquid 10 is injected by the operator, and a first liquid feed port 122 for feeding the first liquid 10 injected from the first injection port 121 to the flow path 110, that is smaller in diameter than the first injection port 121. The first well 120 holds the first liquid 10 injected from the first injection port 121 by the operator. The first well 120 is connected to the flow path 110 in the specimen processing chip 100 by the first liquid feed port 122. The first liquid 10 can move from the first liquid feed port 122 into the flow path 110 through the connection portion 140 between the first well 120 and the flow path 110. The first well 120 may be provided on the surface of the specimen processing chip 100 or may be provided so as to be embedded in the inside of the specimen processing chip 100.

The first well 120 has a first injection port 121 for injecting a liquid from the outside. The internal space of the first well 120 for holding the first liquid 10 is exposed to the outside of the specimen processing chip 100 through the first injection port 121. The first well 120 is configured to hold the first liquid 10 injected from the first injection port 121.

As shown in FIG. 2, prior to feeding the liquid, the first liquid 10 is injected into the first well 120 having the first injection port 121 through the first injection port 121 by the injection tool 700. The injection tool 700 is, for example, a pipettor, a syringe, a dispenser device or the like. Thereby, the worker can inject the first liquid 10 into the first well 120 in the same manner as injection of liquid into a general well plate or the like.

The first liquid 10 held in the first well 120 is fed from the first well 120 to the flow path 110 by the liquid feeder 500. The liquid feeding method is not particularly limited. Liquid feeding is realized by, for example, movement of liquid by pressure, movement of liquid by capillary phenomenon, movement of liquid by centrifugal force, and the like.

In the example of FIG. 1, pressure is applied to the first well 120 into which the first liquid 10 is injected by the injection tool 700 (see FIG. 2), whereby the first liquid 10 is fed from the first liquid feed port 122 of the first well 120 to the flow path 110. In the example of FIG. 1, pressure is applied to the first well 120 from the liquid feeder 500 outside the specimen processing chip 100 via a pressure path 512. The pressure for moving the first liquid 10 may be hydraulic pressure, gas pressure or air pressure.

The second well 130 has a second injection port 131 into which the second liquid 20 fed from the liquid feeder 500 is injected, and a second liquid feed port 132 for feeding the second liquid 20 injected from the second injection port 131 to the flow path 110, that is smaller in diameter than the second injection port 131.

The second injection port 131 is configured to receive the second liquid 20 fed from the storage section 600 installed in the liquid feeder 500. The second injection port 131 is a port for injecting the second liquid 20 from the liquid feeder 500 side into the specimen processing chip 100. The second injection port 131 opens to the surface of the specimen processing chip 100 and is connected to the flow path 110 through the second liquid feed port 132. The second injection port 131 is, for example, provided on the same surface as the surface on which the first well 120 is provided. The second liquid 20 is injected from the liquid feeder 500 side outside the specimen processing chip 100 through the second injection port 131, and can be moved from the second liquid feed port 132 into the flow path 110 through the connection portion 140. The second injection port 131 can be provided as an opening formed directly on the surface of the specimen processing chip 100. As shown in FIG. 1, a cylindrical structure suitable for connection with the external liquid feeder 500 side is provided on the surface of the specimen processing chip 100, and the second injection port 131 may be formed in a form opening to the tip of the cylindrical structure.

The second liquid 20 is not held on the specimen processing chip 100 side and is stored in the storage section 600 on the liquid feeder 500 side. The method for feeding the second liquid 20 is not particularly limited, and examples thereof include movement of liquid by pressure, movement of liquid by capillary phenomenon, movement of liquid by centrifugal force, and the like. In FIG. 1, the second liquid 20 in the storage section 600 is moved to the specimen processing chip 100 side by the pressure applied to the storage section 600 installed on the liquid feeder 500 side, and is fed into the flow path 110 through the second liquid feed port 132. The pressure is supplied from the liquid feeder 500 to the storage section 600. The pressure for moving the second liquid 20 may be hydraulic pressure, gas pressure, or pneumatic pressure. The second liquid 20 is pushed out from the inside of the storage section 600 and is supplied through a liquid feed pipe 522 connecting the liquid feeder 500 and the second injection port 131.

The first liquid 10 fed from the first well 120 and the second liquid 20 fed through the second well 130 flow into the flow path 110. The first liquid 10 and the second liquid 20 join and flow in the same flow path 110. As a result, a fluid including the first liquid 10 fed from the first well 120 and the second liquid 20 fed from the second well 130 is formed in the flow path 110. A part or the whole of the specimen processing in the specimen processing chip 100 is performed in accordance with the feeding of the first liquid 10 and the second liquid 20. Specimen processing includes, for example, a step of mixing a specimen and a reagent, a step of reacting a specimen with a reagent, a step of forming a fluid in the emulsion state, a step of demulsifying the emulsion, a step of separating unnecessary components contained in the specimen from the specimen and washing them, and the like.

As described above, the first injection port 121 for injecting the first liquid 10 and the second injection port 131 to which the second liquid 20 is fed are provided in the specimen processing chip 100 so as to be exposed to the outside. One or more first wells 120 having the first injection port 121 are provided in the specimen processing chip 100. One or more second injection ports 131 are also provided in the specimen processing chip 100. Therefore, a plurality of regions for receiving the liquid such as the first injection port 121 and the second injection port 131 is formed in the specimen processing chip 100. In the present embodiment, as shown in FIG. 2, the specimen processing chip 100 is provided with an identification section 180 for distinguishing between the first injection port 121 and the second injection port 131.

When injecting the first liquid 10, the operator can identify the first injection port 121 into which the first liquid 10 is to be injected, from other structures such as the second injection port 131 of the specimen processing chip 100, using the identification section 180 as a clue. In the example of FIG. 1, the operator can distinguish between the second injection port 131 and the first injection port 121 into which the first liquid 10 is to be injected, by the identification section 180.

As described above, when the first injection port 121 and the second injection port 131 are larger than the first liquid feed port 122 and the second liquid feed port 132, an erroneous insertion of the injection place by the operator easily occurs. However, in the specimen processing chip 100 of the present embodiment, according to the above configuration, the injection position of the first liquid 10 can be distinguishably recognized from other second injection port 131, by the identification section 180 for identifying the first injection port 121 into which the first liquid 10 is to be injected. Therefore, it is possible to suppress an error in the liquid injection position by the operator. As a result, when injecting the liquid into the specimen processing chip, it is possible to suppress an error in the liquid injection position by the operator while suppressing complication of operations.

(Liquid Feeding Method)

The liquid feeding method of the present embodiment will be described. The liquid feeding method of the present embodiment is a liquid feeding method for feeding liquid to a specimen processing chip 100 having a flow path 110 into which liquid flows. The liquid feeding method is a liquid feeding method for feeding liquid to a specimen processing chip 100 having a flow path 110 into which liquid flows, including (A) injecting a first liquid 10 using an injection tool 700, from a first injection port 121 of a first well 120 to which an identification section 180 is given, provided in the specimen processing chip 100 (see FIG. 2), (B) feeding the first liquid 10 injected through the first injection port 121 from the first liquid feed port 122 of the first well 120 having a smaller diameter than the first injection port 121 to the flow path 110 by a liquid feeder 500, (C) feeding a second liquid 20 from the liquid feeder 500 through a second injection port 131 of a second well 130 to which the identification section 180 is not given, provided in the specimen processing chip 100, (D) feeding the second liquid 20 fed to the second well 130 from the second liquid feed port 132 of the second well 130 having a smaller diameter than the second injection port 131 to the flow path 110, and forming a fluid containing the first liquid 10 fed from the first liquid feed port 122 and the second liquid 20 fed through the second liquid feed port 132, in the flow path 110.

(A) Injection of the first liquid 10 into the first injection port 121 is performed prior to (B) feeding of the first liquid 10 to the flow path 110. Either (B) feeding of the first liquid 10 to the flow path 110 or (C) feeding of the second liquid 20 to the second injection port 131 may be performed first. The order of feeding liquids is set according to the content of specimen processing. (D) Formation of a fluid containing the first liquid 10 and the second liquid 20 is performed as a result of (B) the feeding of the first liquid 10 to the flow path 110 and (C) the feeding liquid of the second liquid 20 to the second injection port 131.

When the first injection port 121 and the second injection port 131 are larger than the first liquid feed port 122 and the second liquid feed port 132, an erroneous insertion of the injection place by the operator easily occurs. However, in the liquid feeding method of a specimen processing chip according to the present embodiment, according to the above configuration, the injection position of the first liquid 10 can be distinguishably recognized from other second injection port 131, by the identification section 180. Therefore, it is possible to suppress an error in the liquid injection position by the operator. As a result, when injecting the liquid into the specimen processing chip, it is possible to suppress an error in the liquid injection position by the operator while suppressing complication of operations.

### Second Embodiment

A second embodiment that is different from the above embodiment will be described. The specimen processing chip 100 is a specimen processing chip 100 installed in the liquid feeder 500 and includes a flow path 110 into which the first liquid 10 and the second liquid 20 flow, a first well 120, a second well 130, and an identification section 180 for distinguishing between the first injection port 121 and the second injection port 131. The first well 120 has the first injection port 121 into which the first liquid 10 is injected by an operator. The second well 130 has the first well 120 and the second injection port 131 into which the second liquid 20 fed from the liquid feeder 500 is injected. The first injection port 121 and the second injection port 131 have substantially the same diameter (see FIGS. 6 and 28). In other words, the opening diameters of the first well 120 and the second well 130 are substantially equal. In this embodiment, the first injection port 121 and the second injection port 131 may be the same as or smaller than the first liquid feed port 122 and the second liquid feed port 132.

When the diameters of the first injection port 121 and the second injection port 131 are substantially the same (see FIGS. 6 and 28), an erroneous insertion of the injection place by the operator easily occurs. However, in the specimen processing chip 100 of the second embodiment, according to the above configuration, the injection position of the first liquid 10 can be distinguishably recognized from other second injection port 131, by the identification section 180 for identifying the first injection port 121 into which the first liquid 10 is to be injected. Therefore, it is possible to suppress an error in the liquid injection position by the operator. As a result, when injecting the liquid into the specimen processing chip, it is possible to suppress an error in the liquid injection position by the operator while suppressing complication of operations.

### Third Embodiment

A third embodiment that is different from the above embodiment will be described. The specimen processing chip 100 is a specimen processing chip 100 installed in the liquid feeder 500 and includes a flow path 110 into which the first liquid 10 and the second liquid 20 flow, a first well 120, a second well 130, and an identification section 180 for distinguishing between the first injection port 121 and the second injection port 131. The first well 120 has the first injection port 121 having a diameter (see diameter d11 in FIG. 28) of 2 mm or more and 15 mm or less, and the first liquid 10 is injected from the first injection port 121 thereinto by the operator. The second well 130 has the second injection port 131 having a diameter (see diameter d13 in FIG. 28) of 2 mm or more and 15 mm or less, and the second liquid 20 fed from the liquid feeder 500 is injected thereinto. In this embodiment, the first injection port 121 and the second injection port 131 may be the same as or smaller than the first liquid feed port 122 and the second liquid feed port 132. The diameters of the first injection port 121 and the second injection port 131 may be different within a range of 2 mm or more and 15 mm or less.

When the diameter of the first injection port 121 and the diameter of the second injection port 131 are substantially the same, both at 2 mm or more and 15 mm or less, an erroneous insertion of the injection place by the operator easily occurs. However, in the specimen processing chip 100 of the third embodiment, according to the above configuration, the injection position of the first liquid 10 can be distinguishably recognized from other second injection port 131, by the identification section 180 for identifying the first injection port 121 into which the first liquid 10 is to be injected. Therefore, it is possible to suppress an error in the liquid injection position by the operator. As a result, when injecting the liquid into the specimen processing chip, it is possible to suppress an error in the liquid injection position by the operator while suppressing complication of operations.

### Fourth Embodiment

A fourth embodiment that is different from the above embodiment will be described. The specimen processing chip 100 is a specimen processing chip 100 installed in the liquid feeder 500 and includes a flow path 110 into which the first liquid 10 and the second liquid 20 flow, a first well 120, a second well 130, and an identification section 180 for distinguishing between the first injection port 121 and the second injection port 131. The first well 120 has the first injection port 121 into which the first liquid 10 is injected by an operator. The second well 130 has the second injection port 131 into which the second liquid 20 fed from the liquid feeder 500 is injected. The positions of the first injection port 121 and the second injection port 131 in the thickness direction of the specimen processing chip 100 substantially coincide (see FIG. 1). In this embodiment, the first injection port 121 and the second injection port 131 may be the same as or smaller than the first liquid feed port 122 and the second liquid feed port 132. The diameters of the first injection port 121 and the second injection port 131 may be outside the range of 2 mm or more and 15 mm or less.

When the positions of the first injection port 121 and the second injection port 131 in the thickness direction of the specimen processing chip 100 substantially coincide, an erroneous insertion of the injection place by the operator easily occurs. However, in the specimen processing chip 100 of the fourth embodiment, according to the above configuration, the injection position of the first liquid 10 can be distinguishably recognized from other second injection port 131, by the identification section 180 for identifying the first injection port 121 into which the first liquid 10 is to be injected. Therefore, it is possible to suppress an error in the liquid injection position by the operator. As a result, when injecting the liquid into the specimen processing chip, it is possible to suppress an error in the liquid injection position by the operator while suppressing complication of operations.

Next, a configuration example of each part of the specimen processing chip 100 will be described in detail.

(First Liquid)

The first liquid 10 to be held in the first well 120 is not particularly limited as long as it is a liquid used for specimen processing in the specimen processing chip 100.

For example, in the example of FIG. 2, the first well 120 is configured to hold the first liquid 10 containing a living body-derived specimen 11. Thereby, the living body-derived specimen 11 can be fed directly to a flow path 110 from a first well 120 provided in a specimen processing chip 100, without passing through a liquid feed pipe or the like of a liquid feeder 500. As a result, contamination of the specimen 11 can be prevented from occurring, even when liquid feeding processing by the same liquid feeder 500 is repeatedly performed on a plurality of different specimen processing chips 100. Also, when the operator injects the first liquid 10 containing the specimen into the first well 120, an error in the liquid injection position can be suppressed by the identification section 180, thus an injection error of the specimen can be effectively suppressed.

The living body-derived specimen 11 is, for example, a liquid such as body fluid or blood (whole blood, serum or plasma) collected from a patient, or a liquid obtained by subjecting the collected body fluid or blood to a predetermined preprocessing. The specimen includes, for example, nucleic acids such as DNA (deoxyribonucleic acid), cells and intracellular substances, antigens or antibodies, proteins, peptides and the like, as target components of specimen processing. For example, when the target component is a nucleic acid, an extract liquid obtained by extracting the nucleic acid by a predetermined preprocessing from blood or the like is used as the living body-derived specimen 11.

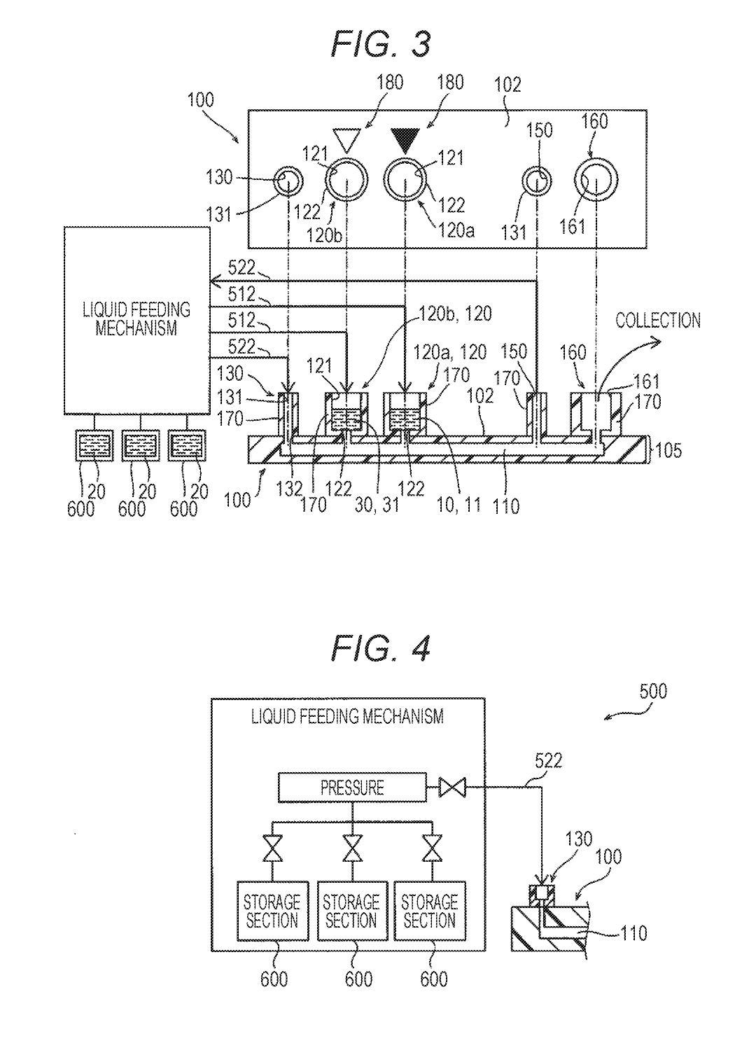

The specimen processing chip 100 may include a plurality of first wells 120. In the example of FIG. 3, two first wells 120 are provided. When a plurality of first wells 120 is provided, the identification section 180 is provided to identify the first injection ports 121 of the plurality of the first wells 120 from each other. Thereby, even when there is a plurality of first wells 120 into which the first liquid 10 is to be injected, the operator can distinguish each of the first injection ports 121 from each other while identifying the first injection port 121 from other structures such as the second injection port 131 by the identification section 180. As a result, even in a situation where there is a plurality of first wells 120 thus it is easy to make a mistake, it is possible to suppress a mistake of the liquid to inject into the first injection port 121. A specific configuration example of the identification section 180 will be described later.

When a plurality of first wells 120 is provided, each of the first wells 120 can hold a different kind of liquid. The liquid held in each of the first wells 120 is mixed in the flow path 110 by liquid feeding and is subjected to a predetermined specimen processing. In the example of FIG. 3, the plurality of the first wells 120 includes a first well 120a for holding a first liquid 10 and a first well 120b for holding a third liquid 30 containing a component 31 corresponding to the inspection item of a specimen inspection using the specimen processing chip 100. Thereby, the component 31 corresponding to the inspection item of a specimen inspection can be fed directly to the flow path 110 from the first well 120 provided in the specimen processing chip 100, without passing through a liquid feed pipe or the like of the liquid feeder 500. As a result, contamination of the component 31 corresponding to the inspection item can be prevented from occurring even when liquid feeding processing by the same liquid feeder 500 is repeatedly performed on a plurality of specimen processing chips 100 that performs a specimen inspection of different inspection items. Also, when the operator injects the third liquid 30 containing the component 31 corresponding to the inspection item into the first well 120, an error in the liquid injection position can be suppressed by the identification section 180, thus an injection error of the component 31 corresponding to the inspection item can be effectively suppressed.

The component 31 corresponding to the inspection item of a specimen inspection is determined according to the target component contained in the specimen 11 and the content of specimen processing. The component 31 corresponding to the inspection item of a specimen inspection includes, for example, a component that specifically reacts with the target component contained in the specimen 11. For example, when the target component contained in the specimen 11 is DNA, the component 31 corresponding to the inspection item of a specimen inspection includes a polymerase for PCR amplification, a primer, and the like. When the target component contained in the specimen 11 is an antigen or an antibody, the component 31 corresponding to the inspection item of a specimen inspection includes an antibody or an antigen that specifically binds to the antigen or the antibody as the target component, or the like. In addition, the component 31 corresponding to the inspection item of a specimen inspection may include, for example, a carrier that carries a target component contained in the specimen 11, a substance that binds the carrier and the target component, or the like.

(Second Liquid)

The liquid used as the second liquid 20 is not particularly limited as long as it is a liquid used for specimen processing in the specimen processing chip 100. When using a liquid with the larger amount supplied to the flow path 110 as compared to the first liquid 10, commonly used for repetitively performing the liquid feeding processing to a plurality of specimen processing chips 100, it is preferable to supply it as the second liquid 20 from the storage section 600.

For example, in the step of mixing a specimen and a reagent or the step of reacting a specimen with a reagent, a liquid containing the specimen is used as the first liquid 10 and a reagent not containing the specimen is used as the second liquid 20. In the step of forming a fluid in the emulsion state, a liquid medium in which droplets are dispersed is used as the second liquid 20. In the step of demulsifying the emulsion, a reagent for demulsifying the emulsion is used as the second liquid 20. In the step of separating unnecessary components contained in the specimen from the specimen and washing them, a washing liquid or the like is used as the second liquid 20.

A plurality of types of second liquids 20 may be supplied to the specimen processing chip 100. In the example shown in FIG. 4, the second injection port 131 is configured to receive each of the plurality of types of the second liquids 20 stored in the plurality of storage sections 600 of the liquid feeder 500. The liquid feeder 500 feeds each of the plurality of types of the second liquids 20 stored in the plurality of storage sections 600 to the flow path 110 through the common second injection port 131. Thereby, since the second injection port 131 for feeding the plurality of types of the second liquids 20 can be used in common, thus it is not necessary to individually provide the second injection port 131 for feeding each of the plurality of types of the second liquids 20. As a result, since the number of the second injection ports 131 can be suppressed, it is possible to prevent the operator from mistaking the second injection port 131 as the first injection port 121. The plurality of types of the second liquids 20 may be mixed in the flow path 110, or each of the second liquids 20 may be fed at different timings for different purposes.

(Collection Holding Section)

In the example of FIG. 3, the specimen processing chip 100 includes a collection holding section 160 for holding a fluid containing the first liquid 10 and the second liquid 20 passed through the flow path 110. The fluid containing the first liquid 10 and the second liquid 20 moved into the flow path 110 is moved from the flow path 110 into the collection holding section 160. In the example of FIG. 3, the collection holding section 160 has a predetermined volume similar to that of the first well 120. The collection holding section 160 has an opening 161 for taking out the collected liquid to the outside. In the configuration in which the collection holding section 160 is provided, the identification section 180 is provided to identify between the first well 120 into which the first liquid 10 is to be injected and the collection holding section 160. In FIG. 3, depending on the presence or absence of the identification section 180, the first well 120 to which an identification section 180 is given can be identified from the collection holding section 160 to which an identification section 180 is not given.

Thereby, the fluid that has passed through the flow path 110 and has undergone a specimen processing by the specimen processing chip 100 is held in the collection holding section 160, and can be easily taken out from the opening 161 by an injection tool 700 such as a pipettor. On the other hand, since the collection holding section 160 is provided, the operator easily mistakes the collection holding section 160 and the first well 120. However, by including the identification section 180, the first injection port 121 can be easily identified, and as a result, it is possible to suppress an error in the liquid injection position by the operator.

(Discharge Port)

In the example of FIG. 3, the specimen processing chip 100 includes a discharge port 150 for discharging drainage from the flow path 110. The drainage generated along with the specimen processing is discharged to the outside of the specimen processing chip 100 from the discharge port 150. For example, in a case where a component to be processed in a specimen is carried on a carrier and then a washing liquid is fed into the flow path 110 to wash out unnecessary substances, the washing liquid is discharged from the discharge port 150. The discharge port 150 is connected to, for example, the liquid feeder 500, and the drainage is collected by the liquid feeder 500. In the configuration in which the discharge port 150 is provided, the identification section 180 is provided to identify between the first well 120 into which the first liquid 10 is to be injected and the discharge port 150. In FIG. 3, depending on the presence or absence of the identification section 180, the first injection port 121 to which an identification section 180 is given can be identified from the discharge port 150 to which an identification section 180 is not given.

Thereby, the drainage generated along with the specimen processing can be discharged to the outside through the discharge port 150. On the other hand, since the discharge port 150 is provided, the operator easily mistakes the discharge port 150 and the first injection port 121. However, by including the identification section 180, the first injection port 121 can be easily identified, and as a result, it is possible to suppress an error in the liquid injection position by the operator.

(Structure Example of Each Part of Specimen Processing Chip)

In the specimen processing chip 100, for example, since the structure of the connection portion with the liquid feeder 500 is unified, the configurations of each part constituting the first injection port 121, the second injection port 131 and the like may be similar in shape.

For example, in the example of FIG. 3, the specimen processing chip 100 is provided with a main body part 105 where a flow path 110 is formed. Each of the first injection port 121 and the second injection port 131 is formed in an upper end portion of a cylindrical structure 170 formed so as to protrude from the surface of the main body part 105.

That is, the first well 120 is formed so as to protrude from the surface of the main body part 105, and is constituted of a cylindrical structure where the first injection port 121 is formed at an upper end thereof, and the second well 130 is formed so as to protrude from the surface of the main body part 105, and is constituted of a cylindrical structure where the second injection port 131 is formed at an upper end thereof. Thereby, the first well 120 and the second well 130 are protruded from the surface of the main body part 105, thus can be easily connected to the liquid feeder 500, respectively. In addition, since the upper end face of the protruding cylindrical structure 170 is easily brought into close contact with a seal member 401 when connecting to the liquid feeder 500, a high degree of hermetically closing can be easily obtained at the connection portion. When the first well 120 and the second well 130 are similarly constituted of the cylindrical structure 170, it becomes difficult to identify them, so that the identification by the identification section 180 is effective for suppressing an injection error.

In the example of FIG. 3, the first injection port 121 and the second injection port 131 are provided side by side adjacent to the surface of the specimen processing chip 100. Thereby, since the first injection port 121 and the second injection port 131 can be positioned close to each other, it is possible to easily connect each of the first injection port 121 and the second injection port 131 to the liquid feeder 500. On the other hand, since the first injection port 121 and the second injection port 131 are adjacent to each other, it is difficult for the operator to distinguish from each other. However, by including the identification section 180, the first injection port 121 can be easily identified, and as a result, it is possible to suppress an error in the liquid injection position by the operator. In the example of FIG. 3, the discharge port 150 is provided in the cylindrical structure 170 similar to the second injection port 131. The collection holding section 160 is constituted of a cylindrical structure 170 similar to that of the first well 120.

In the example of FIG. 3, the positions of each of the first injection ports 121 of the plurality of the first wells 120 in the thickness direction of the specimen processing chip 100 substantially coincide. In the example of FIG. 3, since the first well 120 is constituted of the cylindrical structure 170, the protruding heights of the upper end faces of the cylindrical structures 170 from the main body part 105 are equal. Therefore, the positions of the plurality of first injection ports 121 in the thickness direction substantially coincide. Thereby, since the positions of the plurality of first injection ports 121 in the thickness direction are aligned, it is possible to easily connect the liquid feeder 500 for liquid feeding to the plurality of first injection ports 121. On the other hand, since the heights of the first injection ports 121 coincide each other, it is difficult for the operator to identify. However, by including the identification section 180, each of the first injection ports 121 can be easily distinguished, and as a result, it is possible to suppress an error in the liquid injection position by the operator.

In the example of FIG. 3, the plurality of the first wells 120 has outer shapes substantially coincident or shapes similar to each other in a plan view. In the example of FIG. 3, each of the first wells 120 has a circular outer shape, and the outer diameter is formed to be substantially the same. Therefore, the outer shapes are substantially coincident with each other. Each of the first wells 120 may have the same circular shape, for example, with different outer diameters, in which case each of the first wells 120 has similar shape.

Thereby, since the planar shapes of the plurality of the first wells 120 are substantially coincident or similar, it is possible to easily connect the liquid feeder 500 for liquid feeding to the plurality of the first wells 120. That is, it is possible to unify the shape of a connector for connection to the liquid feeder 500 and the like. On the other hand, since the first wells 120 have planar shapes similar to each other, it is difficult for the operator to distinguish the first injection ports 121. Meanwhile, the specimen processing chip 100 includes the identification section 180, whereby each of the first injection port 121 can be easily distinguished, and as a result, it is possible to suppress an error in the liquid injection position by the operator.

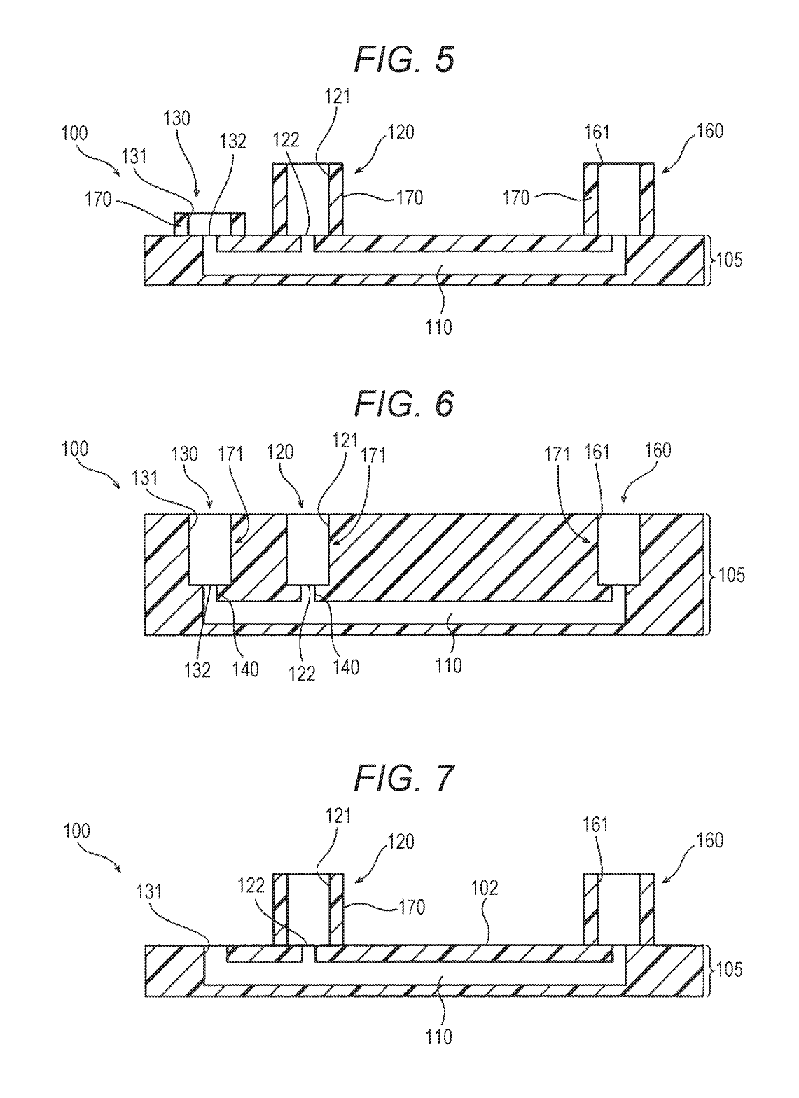

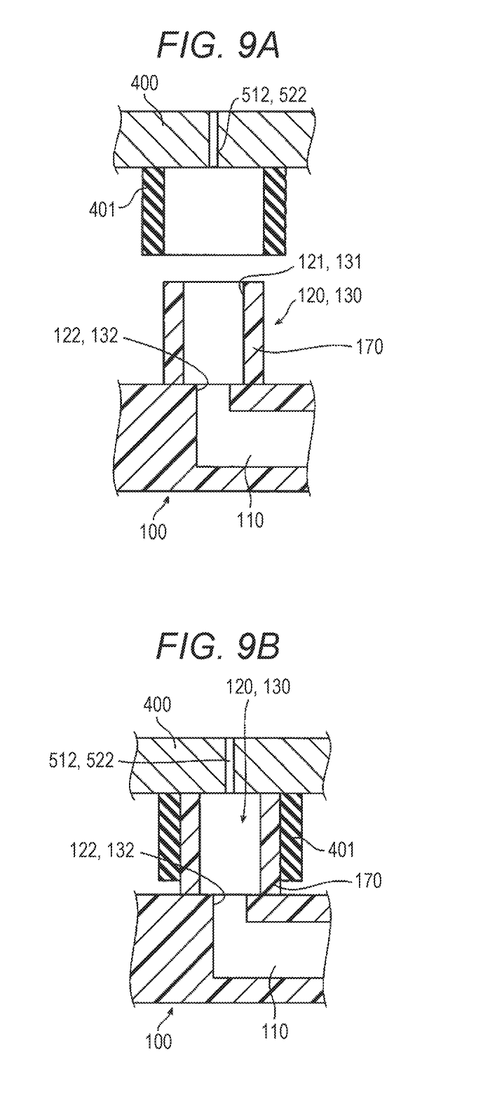

In the example of FIG. 5, the specimen processing chip 100 is provided with a main body part 105 where a flow path 110 is formed. Each of the first well 120 and the second well 130 is formed so as to protrude from the surface of the main body part 105, and is constituted of a cylindrical structure 170 where an opening portion is formed at an upper end thereof. The first well 120 is constituted of a cylindrical structure 170 where the first injection port 121 is formed at an upper end thereof. The second well 130 is constituted of a cylindrical structure 170 where the second injection port 131 is formed at an upper end thereof. When the first injection port 121 and the second injection port 131 are connected to the liquid feeder 500, the connector 400 (see FIG. 9) is arranged so as to cover the upper end portion of the cylindrical structure 170, and a part between the upper end portion of the cylindrical structure 170 and the connector 400 is sealed by a seal member 401. The first well 120 and the second well 130 may have different heights.

In the example of FIG. 6, the first well 120 and the second well 130 both have an opening portion formed on the surface of the main body part 105 and are constituted by a recessed portion 171 recessed inside the main body part 105. The first well 120 and the second well 130 may be constituted by such recessed portion 171. When the first well 120 and the second well 130 are similarly constituted by the recessed portion 171, it becomes difficult to identify them, so that the identification of the first injection port 121 by the identification section 180 is particularly effective for suppressing an injection error.

In the example of FIG. 7, the second injection port 131 is formed on the surface of the main body part 105 where the flow path 110 is formed.

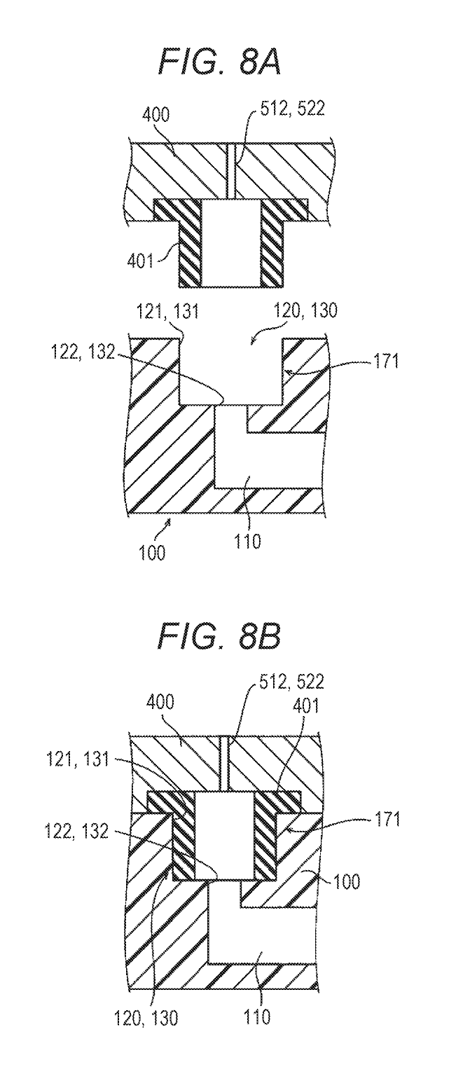

FIGS. 8 to 10 show examples of configurations for connecting the first injection port 121 or the second injection port 131 to the liquid feeder 500. The first injection port 121 or the second injection port 131 is connected to the liquid feeder 500 via the connector 400. The connector 400 has a seal member 401 for sealing a connection portion with the opening portion. The seal member 401 is a member such as an O ring or a gasket, and is made of a flexible material. The connector 400 is provided with a pressure path 512 or liquid feed pipe 526 of the liquid feeder 500 (see FIG. 3) so as to open at the position on the inner peripheral side of the seal member 401.

FIG. 8 shows an example of connection with the connector 400 when the first well 120 and/or the second well 130 is constituted by the recessed portion 171. In FIG. 8A, the connector 400 has an annular seal member 401 formed so as to fit on the inner peripheral surface of the recessed portion 171. When connecting the connector 400, as shown in FIG. 8B, the outer peripheral surface of the annular seal member 401 is fitted into the recessed portion 171 so as to come into close contact with the inner peripheral surface of the recessed portion 171. Thereby, the connection portion between the first injection port 121 or the second injection port 131 and the connector 400 is hermetically closed.

FIG. 9 shows an example of connection with the connector 400 when the first well 120 and/or the second well 130 is constituted of the cylindrical structure 170. In FIG. 9A, the connector 400 has an annular seal member 401 formed so as to fit on the outer peripheral surface of the cylindrical structure 170. When connecting the connector 400, as shown in FIG. 9B, the cylindrical structure 170 is fitted into the inner peripheral side of the seal member 401 so that the inner peripheral surface of the annular seal member 401 comes into close contact with the outer peripheral surface of the cylindrical structure 170. Thereby, the connection portion between the first injection port 121 or the second injection port 131 and the connector 400 is hermetically closed. By fitting the outer peripheral surface of the cylindrical structure 170 into the seal member 401, it is possible to increase the degree of hermetically closing of the connection portion.

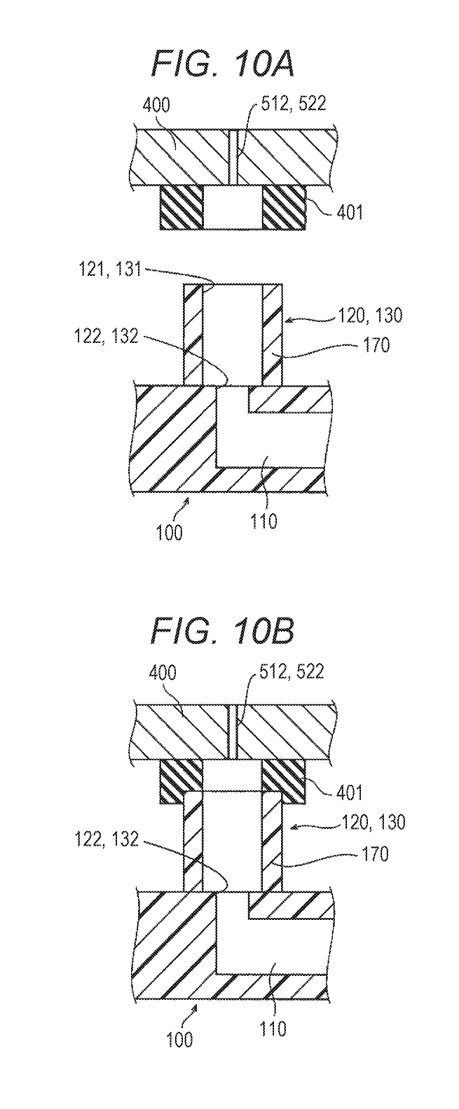

FIG. 10 shows another example of connection with the connector 400 when the first well 120 and/or the second well 130 is constituted of the cylindrical structure 170. In FIG. 10A, the connector 400 has an annular seal member 401 formed so as to come into contact with the upper end face of the cylindrical structure 170. The seal member 401 has a thickness equal to or larger than the wall thickness of the peripheral wall portion of the cylindrical structure 170. When the connector 400 is brought close to the cylindrical structure 170 to connect it, the lower end face of the annular seal member 401 comes into contact with the upper end face of the cylindrical structure 170. Thereby, the upper end face of the cylindrical structure 170 and the lower end face of the seal member 401 come into close contact with each other, and the connection portion is hermetically closed. Since a high pressure is applied to the outer peripheral edge portion of the upper end face of the cylindrical structure 170, it is possible to increase the degree of hermetically closing of the connection portion.

In the example of FIG. 10, preferably, the seal member 401 is formed by an elastic body. When the seal member 401 is an elastic body, by bringing the connector 400 close to the cylindrical structure 170, as shown in FIG. 10B, the seal member 401 is deformed so that the upper end face of the cylindrical structure 170 is sunk in the lower end face of the seal member 401 to come into close contact with the seal member 401. Thereby, it is possible to increase the degree of hermetically closing of the connection portion.

(Injection Port)

Regarding the first injection port 121 and the second injection port 131, the opening shape and the opening area are not particularly limited, but at least the first injection port 121 is formed in such a shape that the operator can inject the first liquid 10 using the injection tool 700. That is, the first injection port 121 is formed larger than the outer shape of the tip of the injection tool 700, and the tip of the injection tool 700 can be inserted thereinto.

Since the second liquid 20 is fed from the liquid feeder 500, the second injection port 131 is not necessarily large enough to inject liquid using the injection tool 700. However, in the present embodiment in which the first injection port 121 and the second injection port 131 are distinguished from each other by the identification section 180, it is particularly effective when the second injection port 131 has a size similar to that of the first injection port 121.

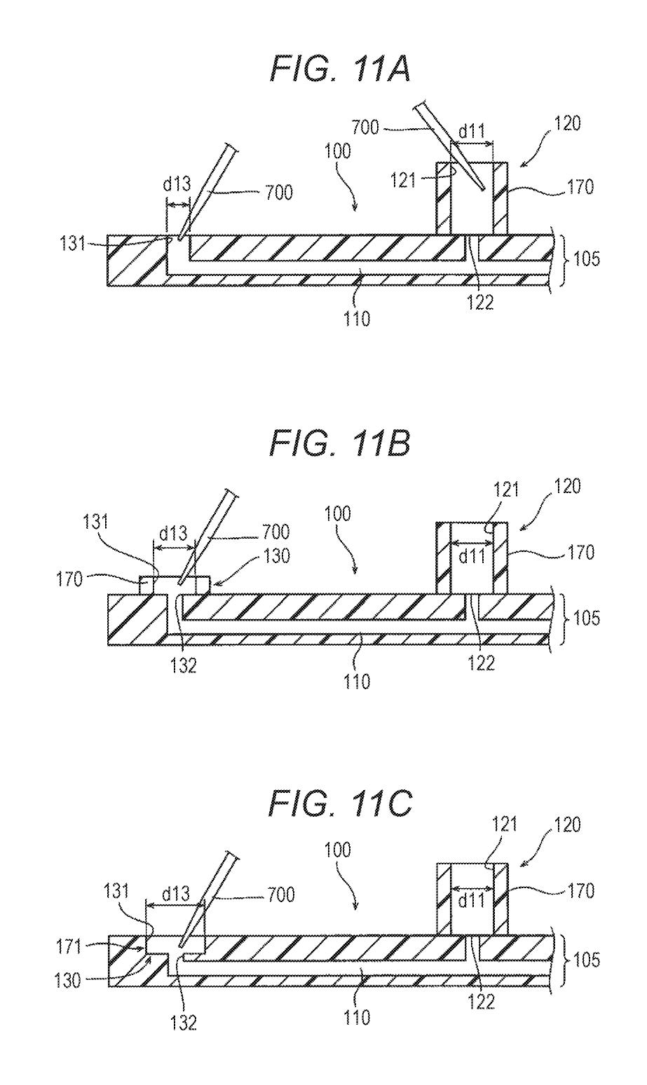

FIG. 11 shows an example of the size of the opening portion. The first injection port 121 has a diameter (inner diameter) d11, and the second injection port 131 has a diameter (inner diameter) d13. In the example of FIG. 11, the first injection port 121 and the second injection port 131 both have an opening shape into which the tip of the injection tool 700 having a dispensing amount corresponding to the capacity of the first well 120 can be inserted. Thereby, liquid can be injected into both the first injection port 121 and the second injection port 131 by using the injection tool 700, so that injection error is likely to occur. Therefore, identification of the first injection port 121 by the identification section 180 is particularly effective for suppressing an injection error.

Specifically, FIG. 11A shows an example in which the second injection port 131 opens on the surface of the main body part 105. The second injection port 131 has an inner diameter d13 smaller than the inner diameter d11 of the first injection port 121, but the second injection port 131 has a size capable of inserting the tip of the injection tool 700 thereinto. FIG. 11B shows an example in which the second injection port 131 is formed in the second well 130 comprising the cylindrical structure 170. The second injection port 131 has an inner diameter d13 substantially equal to the inner diameter d11 of the first injection port 121, and the second injection port 131 has a size capable of inserting the tip of the injection tool 700 thereinto. FIG. 11C shows an example in which the second injection port 131 is formed in the second well 130 comprising a recessed portion 171. The second injection port 131 has an inner diameter d13 substantially equal to the inner diameter d11 of the first injection port 121, and the second injection port 131 has a size capable of inserting the tip of the injection tool 700 thereinto.

In each example of FIG. 11, the operator may erroneously inject the first liquid 10 into the second injection port 131. It is particularly effective since, in such specimen processing chip 100, an injection error by identification of the first injection port 121 can be suppressed by the identification section 180. On the other hand, when the second injection port 131 has a small inner diameter such that it is difficult for the tip of the injection tool 700 to be inserted, the operator understands at a glance that the second injection port 131 is not an opening portion into which the first liquid 10 is to be injected. Therefore, with respect to the specimen processing chip in which there is no opening portion having a size large enough to insert the tip of the injection tool 700, there is no need to provide the identification section 180 in addition to the first injection port 121.

For example, the first injection port 121 and the second injection port 131 both have a diameter (d11, d13) of 2 mm or more and 15 mm or less, as an example of a size capable of inserting the tip of the injection tool 700 thereinto. The capacities of the first well 120 and the second well 130 are, for example, 30 μL or more and 2 mL or less. When the opening diameter is 2 mm or more and 15 mm or less, the first liquid 10 can be injected not only into the first injection port 121 but also into the second injection port 131 using an injection tool 700 such as a general pipettor, so that the operator may mistake the injection position. Therefore, at the time of injection, it is possible to effectively prevent the first liquid 10 from being erroneously injected into the second injection port 131 by the identification section 180. An opening portion having an opening diameter larger than 15 mm is not preferable because it is too large as a structure of the specimen processing chip 100. Preferably, the first injection port 121 and the second injection port 131 both have a diameter (inner diameter) of 5 mm or more and 10 mm or less. The capacities of the first well 120 and the second well 130 are preferably 200 μL or more and 800 mL or less. Thereby, a liquid holding capacity suitable for a microfluidic chip for performing specimen processing using a minute amount of specimen is obtained. More preferably, the first injection port 121 and the second injection port 131 both have a diameter (inner diameter) of 5 mm or more and 8 mm or less. The capacities of the first well 120 and the second well 130 are preferably 200 μL or more and 500 mL or less. In this case, as will be described later, the first injection port 121 and the second injection port 131 can be easily arranged even at intervals of 9 mm pitch conforming to the standard specification of the 96-well microplate. For example, the first injection port 121 and the second injection port 131 both have an opening area larger than the cross-sectional area of the channel 111 for performing the specimen processing in the flow path 110.

(Identification Section)

The identification section 180 may be any type as long as it can identify the first well 120 to be injected from the second injection port 131 or the like. The identification section 180 is configured to visually identify the first well 120 to be injected.

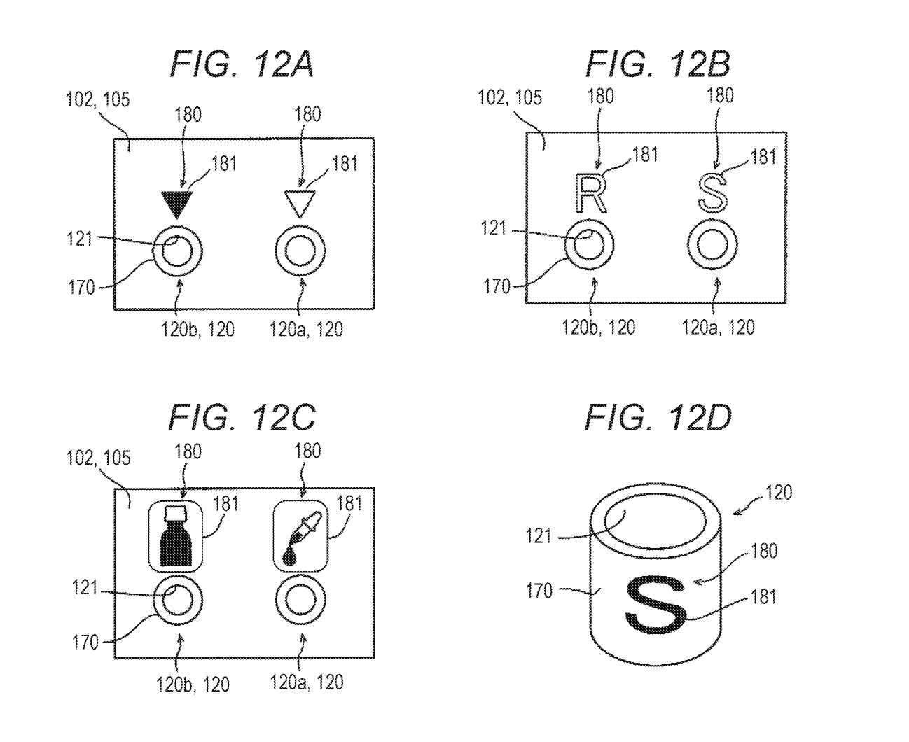

In FIGS. 12A to 12D, the identification section 180 includes an identification mark 181 provided on a surface 102 of the specimen processing chip 100. The surface 102 of the specimen processing chip 100 shall include the surfaces of all structures constituting the specimen processing chip 100. That is, the surface 102 of the specimen processing chip 100 includes the surface of the main body part 105. When the first well 120 is constituted of the cylindrical structure 170, the surface 102 of the specimen processing chip 100 includes the surface of the cylindrical structure 170. That is, the surface 102 of the specimen processing chip 100 includes all surfaces exposed to the outside in the specimen processing chip 100.

For example, the identification section 180 is provided on the same surface as the surface on which the first well 120 is formed, among the main body part 105. Thereby, the operator can easily distinguish the first injection port 121 simply by visually recognizing the identification mark 181 from the outside. When the operator injects the first liquid 10 into the first well 120 using the injection tool 700, the specimen processing chip 100 is looked down from the first injection port 121 side of the first well 120, thus the identification mark 181 provided on the surface 102 is easy for the operator to visually recognize.

The identification section 180 of the surface 102 of the specimen processing chip 100 is provided by, for example, printing, engraving, seal sticking, or the like. That is, the identification mark 181 includes at least any one of a printed mark, an engraved mark and a label mark. Thereby, it is not necessary to provide a special structure for identification in the specimen processing chip 100, and the identification section 180 can be easily provided. For example, the identification mark 181 may include either a graphic such as a letter, a symbol, a figure or a pictogram or a mark such as an arrow.

In the example of FIG. 12A, the identification mark 181 is a mark printed on the surface 102 of the specimen processing chip 100. In FIG. 12A, the identification mark 181 is a mark (triangle mark) indicating the first injection port 121 to be injected. When a plurality of the first wells 120 having the first injection ports 121 are provided, different identification sections 180 can be provided so as to identify the plurality of the first injection ports 121 from each other. In FIG. 12A, the colors of the identification marks 181 are different. The shapes of the marks may be different, such as a triangle, a square, or a circle.

In the example of FIG. 12B, the identification mark 181 is a mark engraved in a projection shape or a groove shape on the surface 102 of the specimen processing chip 100. In the example of FIG. 12B, the identification mark 181 is a letter indicating the liquid to be injected. When a plurality of the first wells 120 is provided, a letter indicating the first liquid 10 to be injected into each of the first injection ports 121 can be provided. In the example of FIG. 12B, an identification mark 181 of an initial letter “S” indicating that the first liquid 10 to be injected into a first well 120a is a sample containing a specimen is attached. An identification mark 181 of an initial letter “R” indicating that a third liquid 30 to be injected into a first well 120b is a reagent containing a component for each inspection item is attached.

In the example of FIG. 12C, the identification mark 181 is a label mark attached to the surface 102 of the specimen processing chip 100. In FIG. 12C, the identification mark 181 is a pictogram (graphic) indicating the liquid to be injected. When a plurality of the first wells 120 is provided, a graphic indicating the first liquid 10 to be injected into the first injection port 121 of each first well 120 can be provided. In the example of FIG. 12C, an identification mark 181 of a pictogram indicating that the first liquid 10 to be injected into the first well 120a is a sample containing a specimen is attached. An identification mark 181 of a pictogram (reagent bottle) indicating that the third liquid 30 to be injected into the first well 120b is an itemized reagent is attached.

FIGS. 12A to 12C show examples in which the identification mark 181 is provided on the surface of the main body part 105 on which the first well 120 is provided. However, in the example of FIG. 12D, the identification mark 181 is provided on the surface of the cylindrical structure 170 constituting the first well 120. The identification mark 181 is provided on the outer peripheral surface of the cylindrical structure 170.

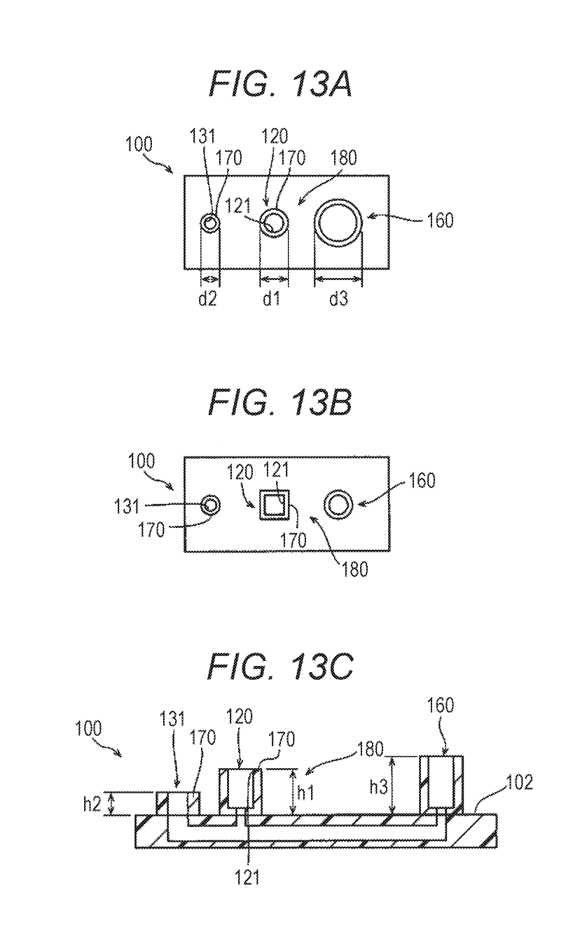

FIGS. 13A to 13C show examples in which the identification section 180 is constituted due to the structural difference of the first well 120. That is, the identification section 180 includes the cylindrical structure 170 constituting the first well 120. The identification section 180 is configured so that the first injection port 121 into which the first liquid 10 is to be injected can be identified, based on at least any one of an outer diameter d1 of the cylindrical structure 170, the planar shape and a height h1. Thereby, the operator can identify the first injection port 121, based on the structural difference between the first injection port 121 and other structures such as the second injection port 131.

In FIG. 13A, the outer diameter d1 of the cylindrical structure 170 of the first well 120 is different from an outer diameter d2 of the second well 130 and an outer diameter d3 of the collection holding section 160, so that the identification section 180 that identifies the first injection port 121 from the second injection port 131 and the collection holding section 160 is constituted. In FIG. 13A, the relationship d2<d1<d3 is satisfied.

In FIG. 13B, the planar shape of the cylindrical structure 170 of the first well 120 is different from the planar shape of the second injection port 131 and the planar shape of the collection holding section 160, so that the identification section 180 that identifies the first injection port 121 from the second injection port 131 and the collection holding section 160 is constituted. In FIG. 13B, the cylindrical structure 170 of the first well 120 has a rectangular shape, whereas the planar shapes of the second injection port 131 and the collection holding section 160 are circular.

In FIG. 13C, the height h1 of the cylindrical structure 170 of the first well 120 is different from a height h2 of the second injection port 131 and a height h3 of the collection holding section 160, so that the identification section 180 that identifies the first injection port 121 from the second injection port 131 and the collection holding section 160 is constituted. The height of the cylindrical structure 170 is the length from the surface of the main body part 105 to the upper end face of the cylindrical structure 170. In FIG. 13 (C), the relationship h2<h1<h3 is satisfied.

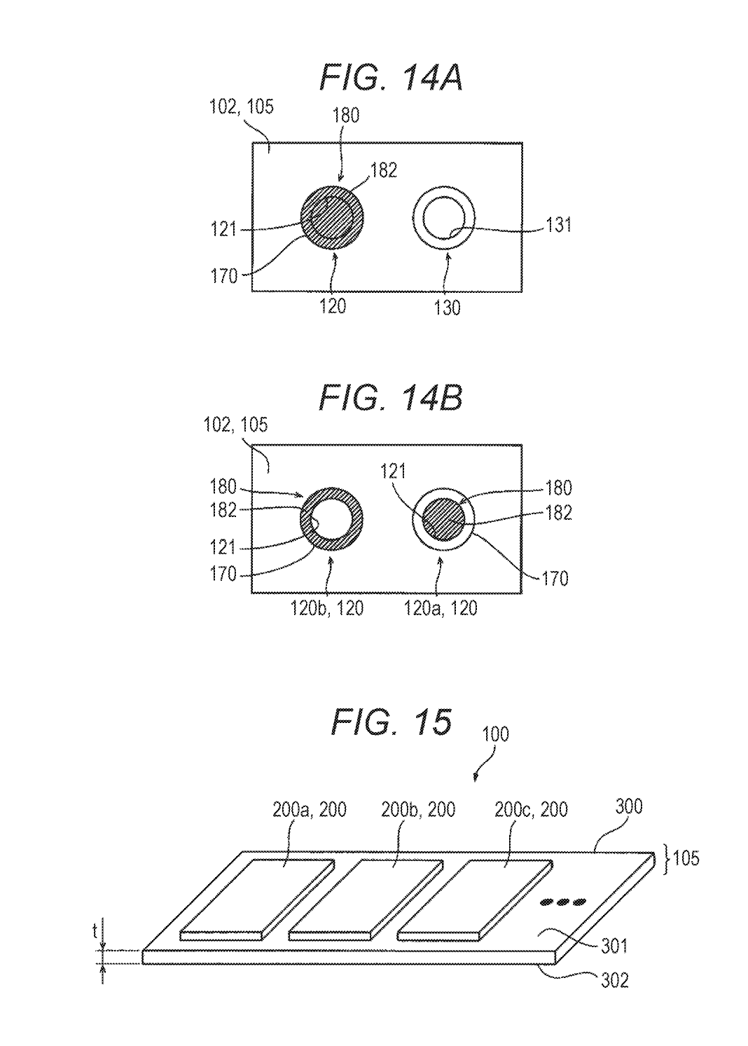

In FIGS. 14A and 14B, examples in which the identification section 180 is constituted with the colors attached to the specimen processing chip 100 are shown. That is, the identification section 180 includes a colored part 182 provided in the specimen processing chip 100. Thereby, the operator can identify the first injection port 121 based on difference in color attached to the specimen processing chip 100. The difference in color is easy to see and can readily realize a color scheme that can be identified at a glance from other structures, so that it is possible to provide an identification section 180 that is easily identified by the operator.

The colored part 182 constituting the identification section 180 has a color different from other structures at least such as a portion constituting the second injection port 131 and the collection holding section 160. The difference in color may be different to a degree that the first well 120 having the first injection port 121 can be distinguished from other structures. For example, in the specimen processing chip 100, only the identification section 180 may include the colored part 182 colored in a predetermined color, and portions other than the identification section 180 may be colorless. The color of the colored part 182 is arbitrary such as red, blue, yellow and green. The specimen processing chip 100 may be made of a transparent material, and it is possible to visually recognize the colored part 182 even it is transparent.

In FIG. 14, the colored part 182 is indicated by hatching. FIG. 14A shows an example in which the entire first well 120 is a colored part 182. In the first well 120b on the left side of FIG. 14B, an example in which only the peripheral wall portion of the cylindrical structure 170 is the colored part 182 and the bottom of the first well 120b inside the cylindrical structure 170 is not colored is shown. In the first well 120a on the right side of FIG. 14B, an example in which only the bottom portion of the first well 120a is the colored part 182 and the peripheral wall portion of the cylindrical structure 170 is not colored is shown.

The colored part 182 may be formed by applying a dye to the surface of the cylindrical structure 170 or the like or may be formed by mixing a dye into the material constituting the cylindrical structure 170 and molding the cylindrical structure 170. In addition to this, the colored part 182 may be provided in a range including the first well 120 having the first injection port 121 in the main body part 105. Among the specimen processing chip 100, the first well 120 may be made identifiable by providing the colored part 182 in a portion other than the first well 120 and not providing the colored part 182 in the first well 120.

The identification sections 180 shown in FIGS. 12 to 14 are an example, and a plurality of identification sections 180 shown in FIGS. 12 to 14 may be combined.

(Configuration Example of Specimen Processing Chip)

FIG. 15 shows a configuration example of the specimen processing chip 100 of the present embodiment. The specimen processing chip 100 includes a plurality of fluid modules 200 and a substrate 300. In the fluid module 200, a flow path 110 is formed. One or more fluid modules 200 are installed on the substrate 300. In the example of FIG. 15, assays corresponding to combinations of a plurality of types of fluid modules are performed by sequentially flowing a specimen, a reagent or the like containing a target component through the fluid modules 200a, 200b, and 200c. Each of the fluid modules 200a, 200b and 200c is a different type of fluid module. That is, in each of the fluid modules 200a, 200b and 200c, the specimen processing step performed by liquid feeding is different. By changing the combination of the fluid modules 200 installed on the substrate 300, various assays corresponding to the combination can be performed. There is no limitation on the number of fluid modules 200 installed on the substrate 300. The shape of the fluid module 200 may be different for each type.

A main body part 105 having a flow path 110 are constituted by the fluid module 200 and the substrate 300. The main body part 105 having the flow path 110 therein may be formed integrally with a single material. When the first well 120 is constituted of the cylindrical structure 170, a cylindrical structure 170 is further provided on the surface of the main body part 105.

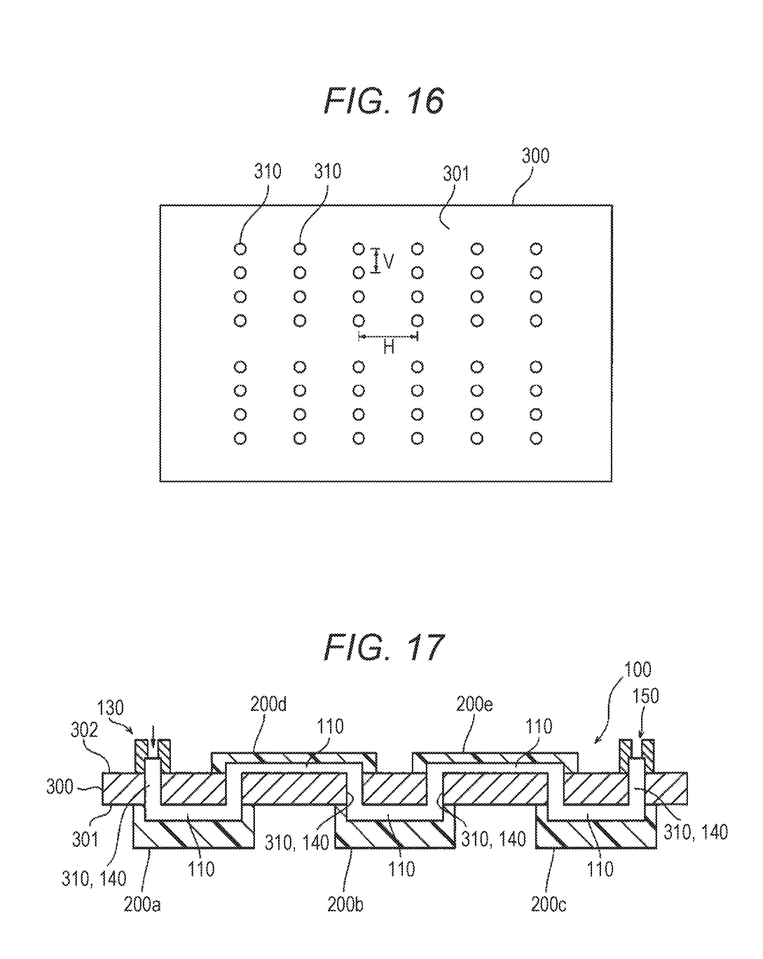

FIG. 16 shows a configuration example of the substrate 300. The substrate 300 has a plurality of substrate flow paths 310. The substrate 300 has a flat plate shape and has a first surface 301 and a second surface 302 (see FIG. 15) that are main surfaces. The second surface 302 is a surface opposite to the first surface 301. In FIG. 15, the upper surface of the substrate 300 in the drawing is the first surface 301, but the first surface 301 may be the lower surface.

A thickness t of the substrate 300 is, for example, 1 mm or more and 5 mm or less. Thereby, the substrate 300 can be formed to have a sufficiently large thickness as compared with the flow path height (on the order of about 10 μm to 500 μm) of the flow path 110 formed in the fluid module 200. As a result, sufficient pressure resistance performance can be easily secured to the substrate 300.

The substrate flow paths 310 are arranged, for example, at a predetermined pitch. In the example of FIG. 16, each of the substrate flow paths 310 is arranged at a pitch V in the longitudinal direction and a pitch H in the lateral direction. In this case, the fluid module 200 can be disposed on the substrate 300 at an arbitrary position on a pitch basis so that the flow path 110 can be connected to an arbitrary substrate flow path 310. Therefore, even when changing the combination of the fluid modules 200, arbitrary combination and arbitrary arrangement of the fluid modules 200 can be easily realized on the substrate 300.

The substrate flow path 310 is, for example, a through hole penetrating the substrate 300 in the thickness direction. The substrate flow path 310 is connected to the flow path 110 of the fluid module 200, and is also constituted as a connection portion with the first well 120 for supplying the first liquid 10 into the specimen processing chip 100 and a connection portion with the second injection port 131 for supplying the second liquid 20 into the specimen processing chip 100. For example, a fluid module 200 having a flow path 110 is installed on one of the first face 301 and the second face 302, and a first well 120 having a first injection port 121 and a second injection port 131 are provided on the other of the first face 301 and the second face 302. The substrate flow path 310 is provided to connect the flow path 110 of the fluid module 200 and the first well 120 and the second injection port 131.

The substrate 300 is formed of glass, a resin material, or the like. The fluid module 200 is formed of, for example, a resin material. Each fluid module 200 is connected to, for example, the substrate 300 by solid phase bonding. In the solid phase bonding, for example, a method in which the bonding surface is plasma-treated to form OH groups and the bonding surfaces are bonded by hydrogen bond, a method such as vacuum pressure bonding or the like can be adopted. The fluid module 200 may be connected to the substrate 300 by an adhesive or the like.

As an example, the substrate 300 is made of, for example, polycarbonate (PC). The fluid module 200 is made of, for example, polydimethylsiloxane (PDMS). As the material, for example, a cycloolefin polymer (COP), a cycloolefin copolymer (COC) or the like may be used.

In the configuration example of FIG. 17, the specimen processing chip 100 includes the fluid modules 200a, 200b and 200c arranged on the first surface 301 of the substrate 300 and the fluid modules 200d and 200e arranged on the second surface 302. Each fluid module 200 is connected via a substrate flow path 310 of the substrate 300. As described above, the specimen processing chip 100 may have the fluid module 200 on each of the first surface 301 and the second surface 302.

(Unit Flow Path Structure)

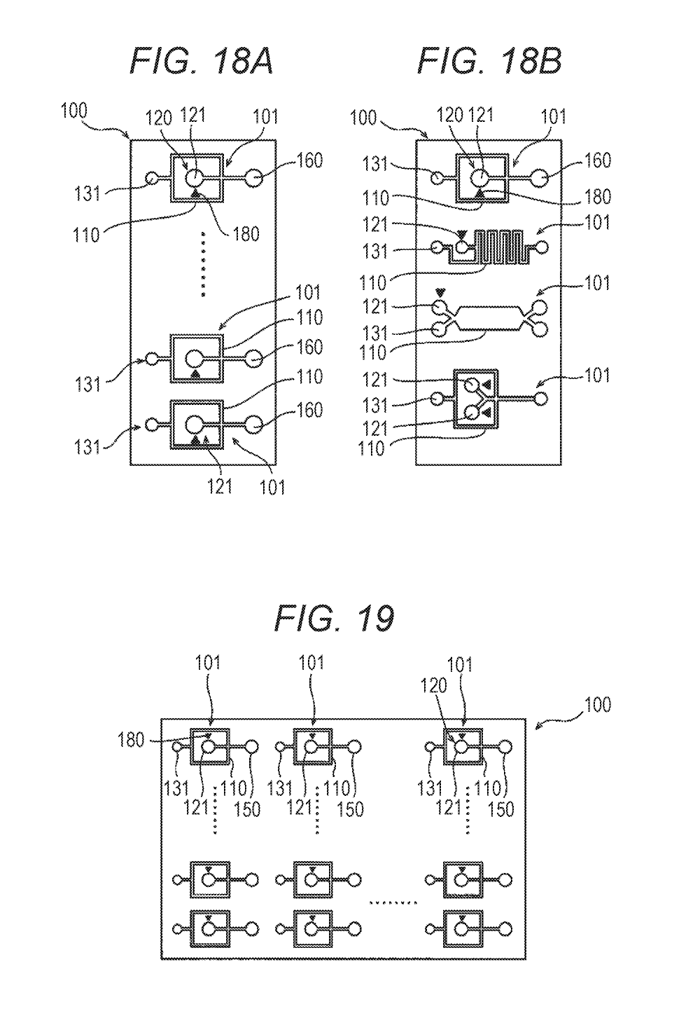

As shown in FIG. 18, in the specimen processing chip 100, a plurality of unit flow path structures 101 as a unit structure for performing a predetermined processing step may be arranged in parallel. Each unit flow path structure 101 includes at least a first well 120 having a first injection port 121, a second injection port 131, and a flow path 110. In each unit flow path structure 101, a plurality of first wells 120 may be provided, or a discharge port 150 and a collection holding section 160 may be provided.

In FIG. 18A, substantially equivalent unit flow path structures 101 are formed side by side in the specimen processing chip 100. The individual unit flow path structures 101 may be formed by separate fluid modules 200, or a plurality of unit flow path structures 101 may be arranged side by side in a common fluid module 200. Substantially equivalent unit flow path structures 101 are provided with flow paths 110 having the same shape or the same function. Substantially equivalent unit flow path structures 101 perform the same type of specimen processing by feeding the first liquid 10 and the second liquid 20.

In FIG. 18B, different types of unit flow path structures 101 are formed side by side in the specimen processing chip 100. The individual unit flow path structures 101 may be formed by separate fluid modules 200, or a plurality of unit flow path structures 101 may be arranged side by side in a common fluid module 200. Different types of unit flow path structures 101 are provided with flow paths 110 having different shapes or different functions. Different types of unit flow path structures 101 perform different kinds of specimen processing by feeding the first liquid 10 and the second liquid 20.

In the specimen processing chip 100, the plurality of unit flow path structures 101 may be arranged linearly as shown in FIG. 18, or the plurality of unit flow path structures 101 may be vertically and horizontally arranged in a matrix as shown in FIG. 19. When the specimen processing chip 100 includes a plurality of unit flow path structures 101, it is possible to perform a plurality of specimen processing in parallel by one specimen processing chip 100 by a plurality of unit flow path structures 101.

In the case where the specimen processing chip 100 has a plurality of unit flow path structures 101, as shown in FIGS. 18 and 19, a plurality of second injection ports 131 and a plurality of first wells 120 are provided in the specimen processing chip 100, so that the operator easily mistakes the injection position. Therefore, when the specimen processing chip 100 has a plurality of unit flow path structures 101, the identification section 180 is configured to identify the first injection ports 121 into which the first liquid 10 is to be injected in each of the plurality of unit flow path structures 101. Thereby, since each of the first injection ports 121 can be recognized by the identification section 180, it is possible to suppress an injection error of the liquid.

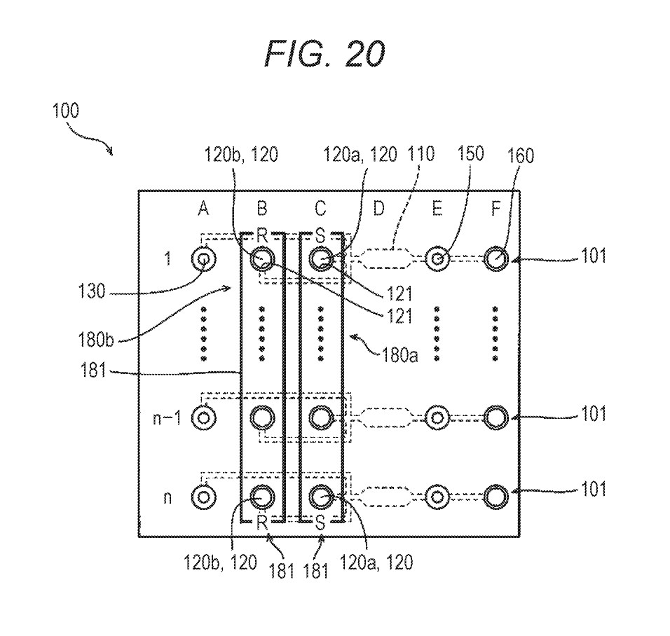

The identification section 180 can be individually provided for each of the first wells 120 included in the plurality of unit flow path structures 101, in the form as shown in FIGS. 12 to 14. In addition to this, in the example of FIG. 20, the identification section 180 is provided across a plurality of unit flow path structures 101 so as to collectively identify the first wells 120 of the plurality of unit flow path structures 101. Thereby, it is possible to collectively grasp the plurality of unit flow path structure 101 into which position the first liquid 10 is to be injected, in the specimen processing chip 100 having a complicated structure by providing the plurality of unit flow path structures 101. In addition, since the identification sections 180 are provided across the plurality of unit flow path structures 101, the identification section 180 can be easily enlarged and easily identified. This makes it possible to effectively suppress an injection error of the liquid.

In FIG. 20, the identification section 180 is a frame-like identification mark 181 extending along the arrangement direction of the unit flow path structures 101. Specifically, the identification section 180 is constituted as a frame-like identification mark 181 extending along the arrangement direction of the unit flow path structures 101, so as to surround each of the first wells 120 of the linearly arranged N unit flow path structures 101. By surrounding and partitioning the plurality of the first wells 120 by the frame-like identification marks 181, it is possible to identify the first well 120 from other structures extremely easily.

In FIG. 20, each unit flow path structure 101 is provided with a plurality of first wells 120. That is, the first well 120 includes a first well 120a for holding a first liquid 10 containing a living body-derived specimen and a first well 120b that holds a third liquid 30 containing a component corresponding to the inspection item of a specimen inspection. Therefore, the identification section 180 includes an identification section 180a to which the letter “S” indicating the specimen contained in the first liquid 10 is provided, and an identification section 180b to which the letter “R” indicating the itemized reagent comprising the third liquid 30. Thereby, the first well 120a that holds the first liquid 10 of each unit flow path structure 101 and the first well 120b that holds the third liquid 30 can be collectively identified from each other.

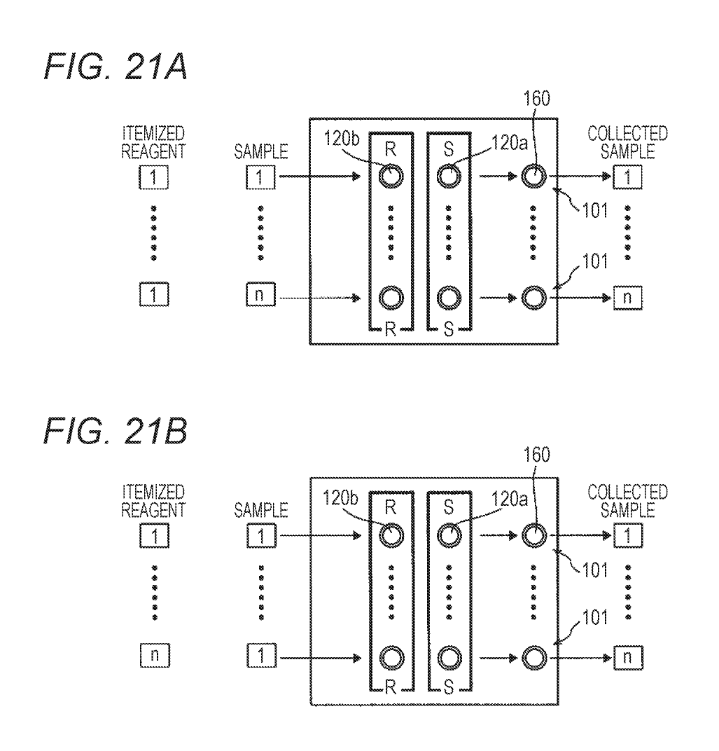

The specimen processing chip 100 having the n unit flow path structures 101 shown in FIG. 20 can be used in various modes. For example, FIG. 21A shows an example in which specimen processing of the same inspection item is performed in parallel for a plurality of samples. In FIG. 21A, a first liquid 10 containing a specimen of respectively different sample numbers 1 to n is injected into each of n first wells 120a. For example, the first liquid 10 containing a specimen collected from n subjects is injected into the first well 120a, respectively. Then, a third liquid 30 containing a component of the same inspection item of reagent number 1 is injected into n first wells 120b, respectively. After feeding the liquid by the liquid feeder 500, the n collection holding sections 160 respectively store the samples of n persons who have undergone the same specimen processing corresponding to the inspection item. In this manner, the specimen processing of the same inspection item can be concurrently performed by the specimen processing chip 100 for the specimens of n persons.

FIG. 21B shows an example in which specimen processing of a plurality of inspection items is performed in parallel on the same sample. In FIG. 21B, the first liquid 10 containing the same specimen of sample number 1 is injected into each of n first wells 120a. Then, a third liquid 30 containing a component of different inspection items of reagent numbers 1 to n is injected into n first wells 120b, respectively. After feeding the liquid by the liquid feeder 500, n collection holding sections 160 respectively store the samples subjected to specimen processing corresponding to n types of inspection items for the same specimen. In this manner, the specimen processing of n types of inspection items can be performed in parallel by the single specimen processing chip 100 for a specimen of one person.

(Arrangement Interval of Wells)

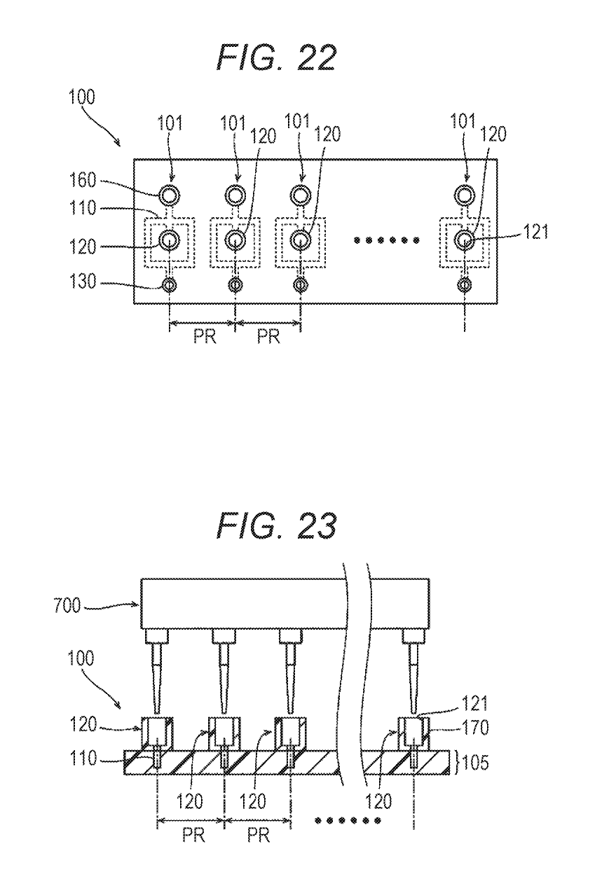

When a plurality of first wells 120 is provided, it is preferable that the plurality of the first wells 120 is arranged at the same pitch PR. In FIG. 22, a plurality of first wells 120 is arranged at a predetermined pitch PR. Therefore, first injection ports 121 of each of the plurality of the first wells 120 are arranged at a predetermined pitch PR. Each of the plurality of the first wells 120 is arranged linearly, and the pitch PR in the arrangement direction is substantially constant. With this configuration, since the plurality of the first wells 120 is arranged regularly, as compared with the case where the plurality of the first wells 120 is arranged at an irregular interval, the injection operation of a liquid by the operator can be facilitated.

In the example of FIG. 22, the plurality of the first wells 120 is arranged at a pitch PR conforming to the standard specification that defines the pitch between wells in the microplate. A standard specification that defines the pitch between wells in the microplate is ANSFSBS 4-2004 as described above. The well-to-well pitch defined by ANSI/SBS 4-2004 is 9 mm for a 96-well microplate, 4.5 mm for a 384-well microplate, and 2.25 mm for a 1536-well microplate. In the microplate, since the wells are arranged in a matrix, there are pitch between columns and pitch between rows, and both commonly have the above dimensions.

In accordance with the pitch between wells of the microplates, injection tools such as multiple pipettors composed of pitches conforming to the standard specification are widely used. Since the plurality of the first wells 120 is arranged at the standardized pitch PR, as shown in FIG. 23, by using an injection tool 700 such as a multiple pipettor conforming to the standard specification, it is possible to inject liquid into the plurality of the first wells 120 all at once. As a result, the injection operation of a liquid by the operator can be further facilitated.

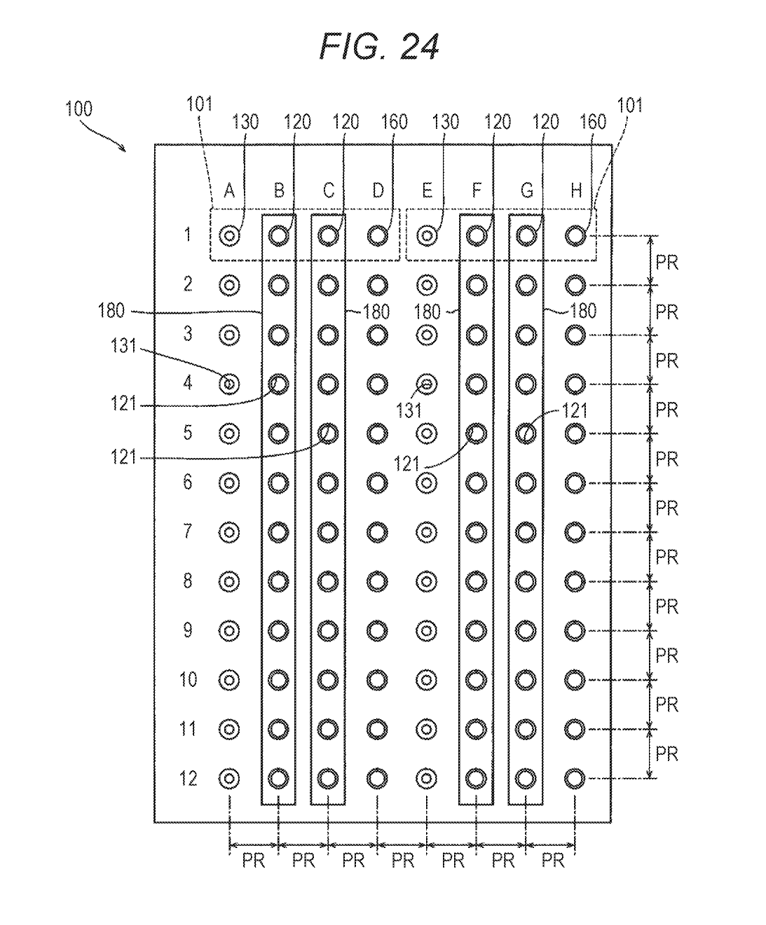

FIG. 24 shows an example of a specimen processing chip 100 in which a plurality of first wells 120 is arranged with a pitch PR conforming to the standard specification. In the specimen processing chip 100 of FIG. 24, the plurality of the first wells 120 is arranged at a pitch PR corresponding to a pitch between wells in a 96-well microplate, and is provided side by side in eight or twelve in the arrangement direction. That is, the pitch PR between each of the first injection ports 121 is 9 mm. 96-well microplates and injection tools 700 corresponding to 96-well microplates are particularly widely used. The operator can perform the injection operation of a liquid collectively, using an injection tool 700 corresponding to the standard specification of the widely used 96-well microplate, so that the efficiency of the injection operation can be improved.

FIG. 24 shows an example in which not only the first wells 120 but also a plurality of the second injection ports 131 and a plurality of the collection holding sections 160 are arranged at a pitch PR conforming to the standard specification of the 96-well microplate. FIG. 24 shows an example of arrangement of 12 rows×8 columns indicated by row numbers 1 to 12 and column numbers A to H. For example, in the columns A to D of each row, a unit flow path structure 101 having one second injection port 131, two first wells 120 and one collection holding section 160 is constituted, and in columns E to H of each row, a unit flow path structure 101 having one second injection port 131, two first wells 120 and one collection holding section 160 is constituted. The specimen processing chip 100 has two unit flow path structures 101 per row and has 24 unit flow path structures 101 in 12 rows. The pitch PR between each row and each column is common, and it is 9 mm conforming to the standard specification of the 96-well microplate. Though not shown, eight first wells 120 may be arranged in columns A to H in the lateral direction.

As described above, in the configuration in which eight or twelve first wells 120 are arranged like a 96-well microplate, the first injection port 121 and the second injection port 131 are densely provided, and it is likely to be similar in appearance, thus it is difficult for the operator to identify. Therefore, the specimen processing chip 100 of the present embodiment that can identify the first injection port 121 by the identification section 180 is particularly effective in a configuration in which a large number of the first injection ports 121 and the second injection ports 131 are provided.

In the specimen processing chip 100, a liquid containing a standard substance is injected into the first well 120, instead of the first liquid 10 containing a specimen, for a part of the plurality of unit flow path structures 101, and can be used as a unit flow path structure 101 for control. It is possible to guarantee the reliability of the processing result in the unit flow path structure 101 into which the first liquid 10 containing a specimen is injected, based on the processing result of the liquid processed in the unit flow path structure 101 into which the liquid containing a standard substance is injected.

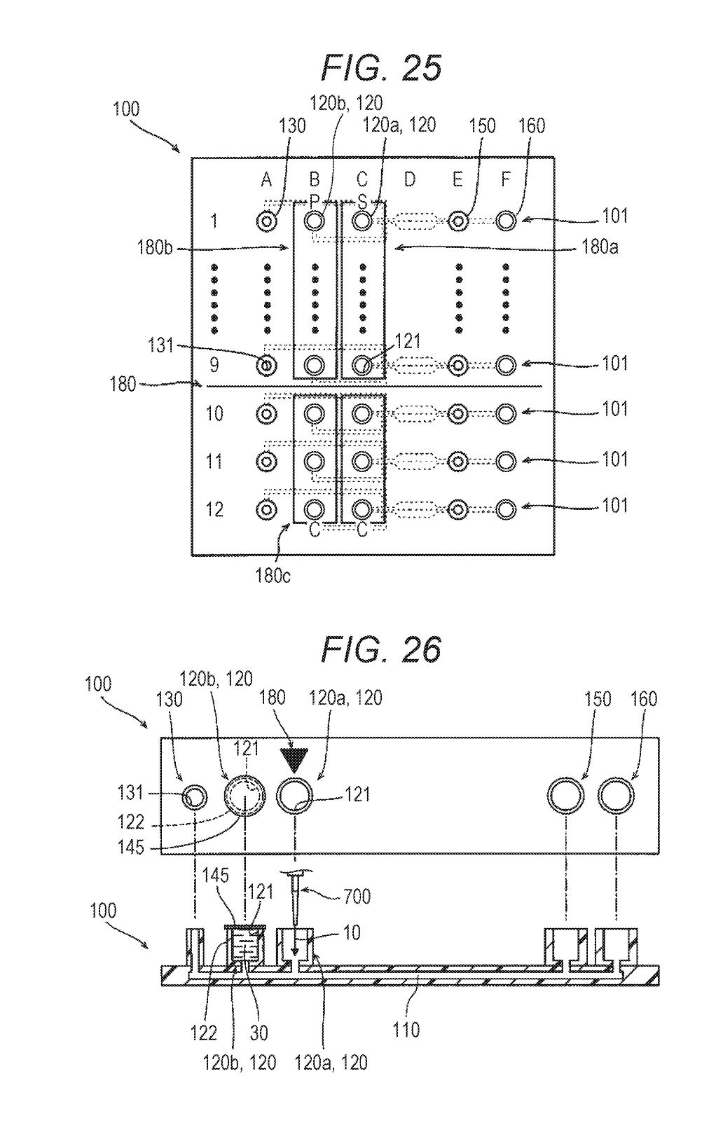

FIG. 25 shows an example of a specimen processing chip 100 provided with a unit flow path structure 101 for control. In FIG. 25, row numbers 1 to 9 are the unit flow path structures 101 for specimen processing into which the first liquid 10 containing a specimen is injected, and row numbers 10 to 12 are the unit flow path structure 101 for control into which the liquid containing a standard substance is injected. In this case, for the row numbers 1 to 9, the identification section 180 is provided on the first well 120a into which the first liquid 10 containing a specimen is injected, and the first well 120b into which a third liquid 30 containing a component corresponding to the inspection item is injected, respectively. Furthermore, in order to identify between the unit flow path structures 101 for specimen processing and the unit flow path structures 101 for control, a linear identification section 180 is provided so as to distinguish between blocks of the row numbers 1 to 9 and blocks of the row numbers 10 to 12. For the row numbers 10 to 12, the identification section 180 to which the letter “C” indicating that it is control is provided on the first well 120 into which a liquid containing a standard substance is injected. Thereby, it is possible for the operator to inject each of the first liquid 10, the third liquid 30 and the liquid containing a standard substance into the first well 120 at a predetermined position without mistake, using each identification section 180 as a clue.

(Prepack of Reagent)

As shown in FIG. 26, when a plurality of first wells 120 includes a first well 120a for holding a first liquid 10 containing a living body-derived specimen and a first well 120b for holding a third liquid 30 containing a component corresponding to the inspection item of a specimen inspection using a specimen processing chip 100, an identification section 180 is at least provided in the first well 120a for holding the first liquid 10. Thereby, the injection position of the first liquid 10 containing a specimen can be grasped by the identification section 180, and it is possible to prevent the operator from mistaking the injection position of the first liquid 10 containing a specimen.

The first well 120b for holding a third liquid 30 may be pre-packed in the specimen processing chip 100. That is, in FIG. 26, the third liquid 30 containing a component corresponding to the inspection item is previously sealed in the first well 120b for holding a third liquid 30. The first well 120b holds the third liquid 30, and at the same time, the first injection port 121 is closed by a film 145 having a sealing property, a plug member (not shown) or the like to be sealed. Thereby, it is possible to omit injection of the third liquid 30 into the first well 120b by the worker. Therefore, as it is not necessary to inject the third liquid 30, it is possible to effectively suppress the complication of the operation of injecting the liquid. Since the third liquid 30 is previously sealed in the first well 120b, it can be also easily identified from the first well 120a, and it is possible to suppress an error in the liquid injection position by the operator.

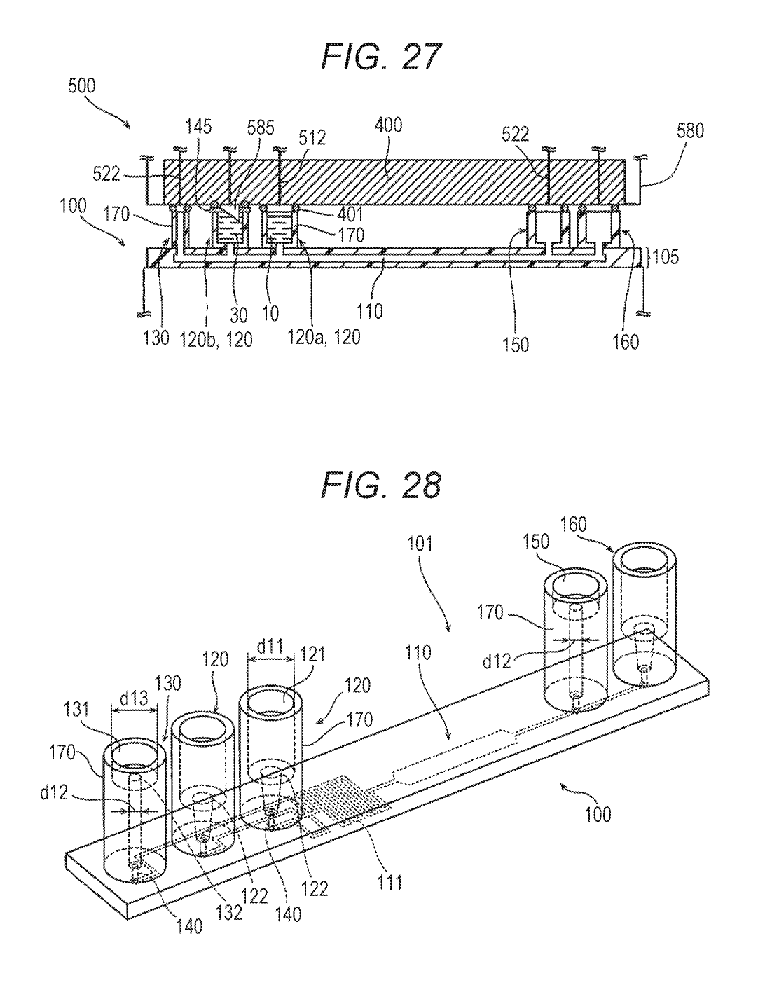

In the configuration in which the third liquid 30 is previously sealed in the first well 120b, as shown in FIG. 27, the sealing of the first well 120b is released by closing a lid 580 of the liquid feeder 500, so as to be configured to connect to the liquid feeder 500. In FIG. 27, the liquid feeder 500 is provided with a lid 580 that covers the specimen processing chip 100. The lid 580 is provided with a piercing member 585 for penetrating the film 145 sealing the first well 120b, and the piercing member 585 penetrates the film 145 as the lid 580 is closed. When the film 145 is broken, the first well 120b is connected to the pressure path 512 provided in the lid 580 so that the internal third liquid 30 can be fed to the flow path 110 side.

As a modified example, the specimen processing chip 100 may be provided with a film 145 that closes the second injection port 131. In this case, the identification section 180 includes the film 145 that closes the second injection port 131. The first injection port 121 is not closed by the identification section 180, whereby the operator can identify the first injection port 121. Also, the second injection port 131 is closed, whereby erroneous injection of the first liquid 10 can be prevented. In this case, as shown in FIG. 27, a piercing member 585 may be provided in the connector 400 connected to the second injection port 131 so that liquid can be fed through the film 145 at the time of connection. Since the second liquid 20 is fed to the second injection port 131, the inside of the second injection port 131 may be empty instead of prepacking the second liquid 20.

In the example of FIG. 27, an example in which the connector 400 of the liquid feeder 500 is configured as a manifold that can be collectively connected to the first injection port 121 and the second injection port 131 is shown. Thereby, by simply connecting the connector 400 to the specimen processing chip 100, each of the first injection port 121 and the second injection port 131 can be connected to the liquid feeder 500.

In the example of FIG. 27, the positions of the first injection port 121 and the second injection port 131 in the thickness direction of the specimen processing chip 100 substantially coincide. That is, since the first well 120 and the second well 130 are each constituted of the cylindrical structure 170, the protruding heights of the upper end faces of the cylindrical structures 170 from the main body part 105 are equal. Therefore, the positions of the first injection port 121 and the second injection port 131 in the thickness direction substantially coincide. This makes it possible to perform the connection between the first injection port 121 and the liquid feeder 500 and the connection between the second injection port 131 and the liquid feeder 500 at the same position in the thickness direction of the specimen processing chip 100. Therefore, when providing a manifold including a connector 400 for the first injection port 121 and a connector 400 for the second injection port 131 in the liquid feeder 500, a seal member 401 for sealing each connection portion can be formed in a sheet shape, and connection can be easily performed.

FIG. 28 shows a configuration example showing one of the unit flow path structures 101 of the specimen processing chip 100. In the configuration example of FIG. 28, the specimen processing chip 100 includes two first wells 120 and one collection holding section 160, one second well 130 in which the second injection port 131 is formed, and one second well 130 in which a discharge port 150 is formed. In FIG. 28, the identification section 180 is not shown. The first injection port 121 has an inner diameter d11 so as to have a predetermined volume corresponding to the amount of liquid to be stored. The first well 120 has a first injection port 121 at its upper end portion and a connection portion 140 with a flow path 110 at its lower end portion.

The second well 130 is provided with a liquid passage having an inner diameter d12 smaller than the inner diameter d11 of the first well 120. A second injection port 131 or a discharge port 150 is provided at its upper end portion of the second well 130, and its lower end portion is connected to the flow path 110. In the example of FIG. 28, the outer diameter of the second well 130 is substantially equal to the outer diameter of the first well 120. The inner diameter of the second injection port 131 or the discharge port 150 at the upper end portion of the second well 130 is enlarged so that the inner diameter d13 is larger than the inner diameter d12. The inner diameter d13 is substantially equal to the inner diameter d11 of the first injection port 121 of the first well 120.

In the example of FIG. 28, the second well 130 protrudes from the surface of the specimen processing chip 100, and the distance from the second injection port 131 to the second liquid feed port 132 is shorter than the height of the second well 130. That is, the second liquid feed port 132 is provided at an intermediate position in the height direction of the second well 130 (that is, any position between the upper end and the lower end). Thereby, even when the liquid feeder 500 injects with the second injection port 131 hermetically closed, in the case of feeding the liquid injected into the second well 130, the amount of air in the second well 130 can be reduced, and the liquid can be fed with high accuracy.

In the example of FIG. 28, the diameters (inner diameters d11, d13) of the first injection port 121 and the second injection port 131 are substantially the same, and the distance from the second injection port 131 to the second liquid feed port 132 is shorter than the distance from the first injection port 121 to the first liquid feed port 122. The distance from the injection port to the liquid feed port corresponds to the depth of the well. Therefore, the first well 120 is deeper than the second well 130. Since the diameters of the first injection port 121 and the second injection port 131 are substantially the same, the volume of the first well 120 is larger than that of the second well 130. When the operator injects the liquid into the first well 120 without hermetically closing the first injection port 121, and the liquid feeder 500 injects with the second injection port 131 hermetically closed, the first well 120 can reduce the amount of air in the first well 120 by the amount of injected liquid, whereas it is difficult to do so for the second well 130. However, with this configuration, it is possible to reduce the amount of air in the second well 130 and feed the liquid with high accuracy.

The flow path 110 includes a channel 111 for performing a specimen processing and a connection portion 140 between the first well 120 and the second well 130.

The cross-sectional area of the channel 111 (flow path 110) for performing a specimen processing is, for example, 0.01 μm² or more and 10 mm² or less. The cross-sectional area in the flow path 110 is a cross-sectional area in a cross section orthogonal to the flowing direction of the liquid in the flow path 110. In this way, when the flow path 110 having a small cross-sectional area of 0.01 μm² or more and 10 mm² or less is provided, the first injection port 121 and the second injection port 131 for feeding liquid to the flow path 110 also have a small diameter. Thus, it becomes easy to mistake each other. Therefore, identification of the first injection port 121 by the identification section 180 is effective for suppressing an injection error. Preferably, the channel 111 (flow path 110) has a cross-sectional area of 0.01 μm² or more and 1 mm² or less. Thereby, the first injection port 121 and the second injection port 131 having a small diameter suitable for feeding liquid to the flow path 110 having a cross-sectional area of 1 mm² or less can be distinguished by the identification section 180, so that it is particularly effective for suppressing an injection error. More preferably, the channel 111 (flow path 110) has a cross-sectional area of 0.01 μm² or more and 0.25 mm² or less.

The flow path 110 formed in the specimen processing chip 100 has, for example, a height of 1 μm or more and 500 μm or less and a width of 1 μm or more and 500 μm or less. In such a small flow path 110 having a height of 1 μm or more and 500 μm or less and a width of 1 μm or more and 500 μm or less, the first injection port 121 and the second injection port 131 for feeding liquid to the small flow path 110 also have a small diameter. Thus, it becomes easy to mistake each other. Therefore, identification of the first injection port 121 by the identification section 180 is effective for suppressing an injection error. Preferably, the flow path 110 has a height of 1 μm or more and 250 μm or less and a width of 1 μm or more and 250 μm or less. With this configuration, the first injection port 121 and the second injection port 131 for feeding liquid to the smaller flow path 110 having a height of 250 μm or less and a width of 250 μm or less also tends to have a small diameter, so that identification of the first injection port 121 by the identification section 180 is particularly effective for suppressing an injection error. More preferably, the flow path 110 has a height of 1 μm or more and 100 μm or less and a width of 1 μm or more and 100 μm or less.

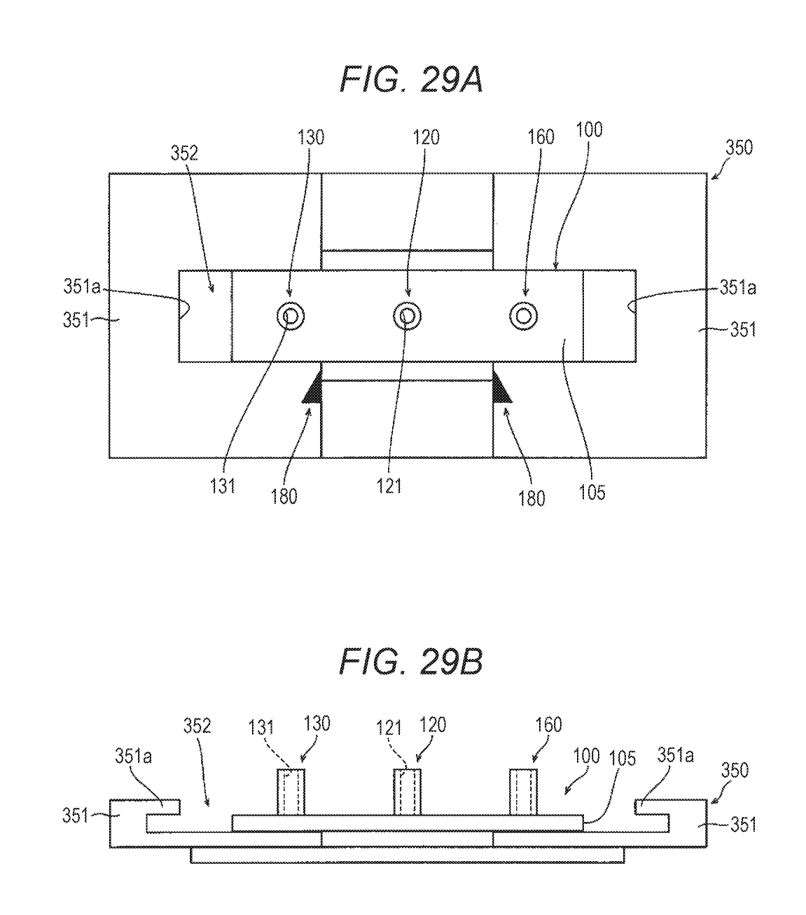

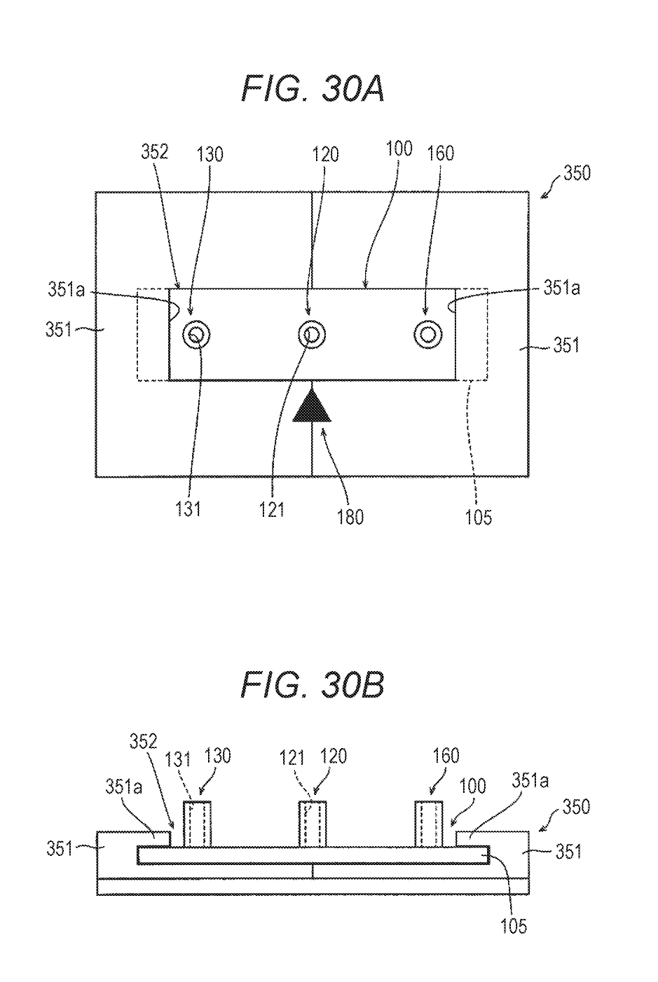

As shown in FIGS. 29 and 30, the specimen processing chip 100 may be provided with a holder or an adapter, or other accessory, used when installing the specimen processing chip 100 in the liquid feeder 500. For example, the specimen processing chip 100 may include a connector 400 for connection to the liquid feeder 500 as an accessory.

In FIG. 29, the specimen processing chip 100 is provided with a chip holder 350 for installing the specimen processing chip 100 in the liquid feeder 500 as an accessory. In the example of FIG. 29, the chip holder 350 includes a pair of engaging portions 351 divided to the left and right, and the chip holder 350 is configured so that the pair of engaging portions 351 is slidable in a direction to approach and away from each other. The specimen processing chip 100 is installed in a recessed chip installation section 352 formed at the center of the engaging portion 351 in a state where the pair of engaging portions 351 is separated from each other.

As shown in FIG. 30, when the pair of engaging portions 351 is brought close to each other in a state where the specimen processing chip 100 is installed in the chip installation section 352, the specimen processing chip 100 is fixed to the chip holder 350. That is, when the pair of engaging portions 351 is brought close to each other, the claw portions 351a of the pair of engaging portions 351 move to the upper surface side of the specimen processing chip 100 and engage with the specimen processing chip 100, so that the specimen processing chip 100 does not come off the chip installation section 352. In the engaged state, the interval between the pair of engaging portions 351 (that is, the dimensions of the chip installation section 352) almost matches the dimensions of the specimen processing chip 100, and the specimen processing chip 100 is hold in the inside of the chip holder 350 so as not to move.

In the case of providing the chip holder 350, the identification section 180 may be provided on the chip holder 350 as shown in FIG. 30. However, in this case, since the operator cannot use the identification section 180 in a state where the specimen processing chip 100 is not installed in the chip holder 350, it is necessary to inject the first liquid 10 in a state where the specimen processing chip 100 is installed in the chip holder 350. Therefore, in order to allow injection of the first liquid 10 using the identification section 180 even with the specimen processing chip 100 alone, it is preferable to provide the identification section 180 directly on the main body of the specimen processing chip 100.

[Outline of Liquid Feeder]

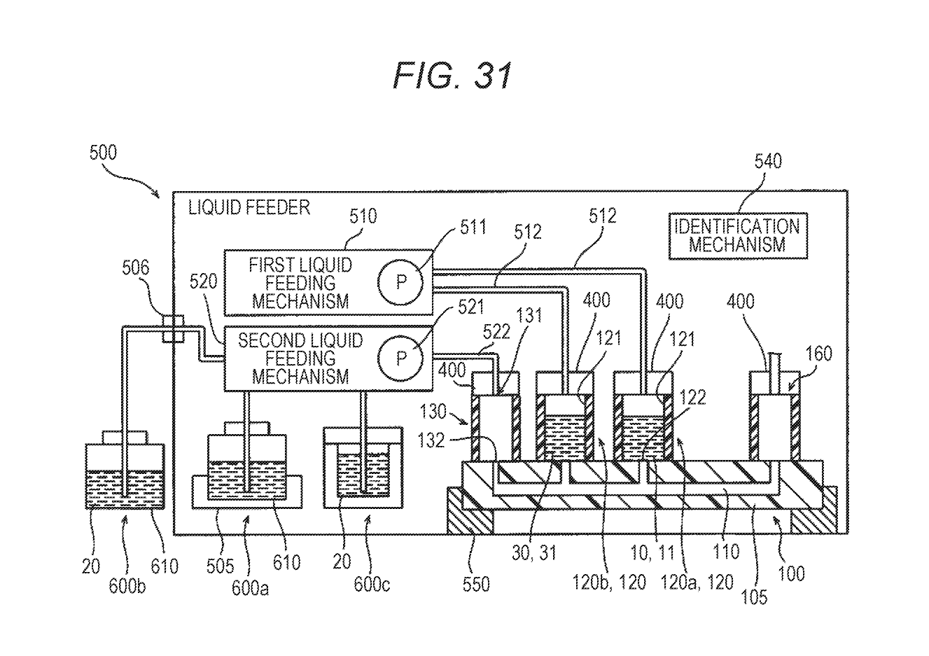

Next, with reference to FIG. 31, the outline of the liquid feeder of the present embodiment will be described.

The liquid feeder 500 is a liquid feeder for feeding liquid to a specimen processing chip 100 having a flow path 110 into which liquid flows. The content of the specimen processing is determined by the structure of the specimen processing chip 100. Therefore, according to the type of the specimen processing chip 100 to be used, the liquid feeder 500 can perform liquid feeding for performing a different type of specimen processing.

The liquid feeder 500 includes a first liquid feeding mechanism 510, a second liquid feeding mechanism 520, and an installation section 550 on which the specimen processing chip 100 is installed. The first liquid feeding mechanism 510 and the second liquid feeding mechanism 520 may be configured to include a pump serving as a pressure source, a pipe for supplying pressure, a valve for controlling liquid feeding, and the like.

The first liquid feeding mechanism 510 feeds a first liquid 10 injected into a first well 120 through a first injection port 121 formed in the first well 120 of the specimen processing chip 100 to a flow path 110 from a first liquid feed port 122 smaller than the first injection port 121, that is formed in the first well 120. The first liquid feeding mechanism 510 feeds the first liquid 10, by pressure due to air pressure or hydraulic pressure, centrifugal force generated by rotating the specimen processing chip 100, capillary phenomenon, or the like. For example, the first liquid feeding mechanism 510 applies pressure to the first well 120 into which the first liquid 10 is injected by an injection tool 700 (see FIG. 2), thereby feeding the first liquid 10 to the flow path 110. In the configuration example of FIG. 31, a connector 400 is attached to the first well 120, and the first liquid feeding mechanism 510 and the inside of the first well 120 are connected. The connector 400 seals the first injection port 121 of the first well 120. The first liquid feeding mechanism 510 supplies pressure from the first injection port 121 side of the first well 120 via the connector 400 to push the first liquid 10 to the flow path 110 side. The first liquid 10 moves into the flow path 110 through a connection portion 140 by pressure.

The second liquid feeding mechanism 520 feeds liquid to a second well 130 through a second injection port 131 formed in the second well 130 of the specimen processing chip 100, and feeds a second liquid 20 fed to the second well 130 to the flow path 110 from a second liquid feed port 132 smaller than the second injection port 131 formed in the second well 130. The second liquid feeding mechanism 520 feeds the second liquid 20, by pressure due to air pressure or hydraulic pressure, centrifugal force generated by rotating the specimen processing chip 100, capillary phenomenon, or the like. For example, the second liquid feeding mechanism 520 applies pressure to a storage section 600 that stores the second liquid 20, thereby feeding the second liquid 20 in the storage section 600 to the flow path 110 through the second injection port 131. In the configuration example of FIG. 31, a connector 400 is attached to the second injection port 131, and the second liquid feeding mechanism 520 and the second injection port 131 are connected. The connector 400 seals the second injection port 131. The second liquid feeding mechanism 520 is fluidly connected to the inside of the storage section 600. The second liquid feeding mechanism 520 supplies pressure to the inside of the storage section 600 to move the second liquid 20 in the storage section 600 to the second injection port 131. The second liquid 20 moves into the flow path 110 through the storage section 600 and the second injection port 131 by pressure.

The installation section 550 is formed in a shape corresponding to the specimen processing chip 100, and supports the specimen processing chip 100. The installation section 550 installs a processing unit used for connection to a flow path of the specimen processing chip 100, and various processing steps in the specimen processing chip 100, thus has a structure that opens at least one of the upper side and the lower side of the specimen processing chip 100. The installation section 550 can be, for example, a recessed or frame-like structure for supporting the peripheral portion of the specimen processing chip 100. When the specimen processing chip 100 includes a chip holder 350, the installation section 550 is configured to receive and support the chip holder 350 in a state where the specimen processing chip 100 is installed. However, when using the chip holder 350, it is necessary to install the specimen processing chip 100 on the chip holder 350. In the example of FIG. 31, the installation section 550 is configured to directly support a main body part 105 of the specimen processing chip 100. Thus, the operation of the operator can be simplified.

The liquid feeder 500 forms a fluid containing the first liquid 10 and the second liquid 20 in the flow path 110, by liquid feeding by the first liquid feeding mechanism 510 and the second liquid feeding mechanism 520. That is, the first liquid 10 moved from the first well 120 and the second liquid 20 moved through the second injection port 131 join and flow in the same flow path 110. A part or the whole of the specimen processing in the specimen processing chip 100 is performed in accordance with the feeding of the first liquid 10 and the second liquid 20.

The liquid feeder 500 of the specimen processing chip 100 of the present embodiment includes an identification mechanism 540 for distinguishing the first injection port 121 and the second injection port 131 in the specimen processing chip 100 installed in the installation section 550. The identification mechanism 540 allows the operator to identify into which position the first liquid 10 should be injected, in the specimen processing chip 100 installed in the installation section 550, for example, by a light emitting indicator, screen display, projection of an image or navigation light, sound, or a combination thereof. The identification mechanism 540 allows the operator to recognize the position of the first well 120 in the specimen processing chip 100.

When the first injection port 121 and the second injection port 131 are larger than the first liquid feed port 122 and the second liquid feed port 132, an erroneous insertion of the injection place by the operator easily occurs. However, in the liquid feeder 500 of the present embodiment, according to the above configuration, the injection position of the first liquid 10 can be distinguishably recognized from other second injection port 131, by the identification mechanism 540 for distinguishing the first injection port 121 from the second injection port 131. Therefore, it is possible to suppress an error in the liquid injection position by the operator. As a result, when injecting the liquid into the specimen processing chip, it is possible to suppress an error in the liquid injection position by the operator while suppressing complication of operations.

In the configuration example of FIG. 31, the first liquid feeding mechanism 510 includes a first pressure source 511 for applying pressure to the first well 120. The second liquid feeding mechanism 520 includes a second pressure source 521 for applying pressure to the storage section 600. The first liquid feeding mechanism 510 and the second liquid feeding mechanism 520 are provided with pressure sources separately and can independently apply pressure.

As the first pressure source 511 and the second pressure source 521, various types of pumps such as a pressure pump, a syringe pump, a diaphragm pump and the like can be used. The first liquid feeding mechanism 510 and the second liquid feeding mechanism 520 may have a common pressure source.

In the configuration example of FIG. 31, the first liquid feeding mechanism 510 includes a pressure path 512 that connects the first pressure source 511 and the first well 120. The second liquid feeding mechanism 520 includes a liquid feed pipe 522 that connects the storage section 600 and the second injection port 131. The first liquid feeding mechanism 510 supplies the pressure of the first pressure source 511 to the first well 120 through the pressure path 512. The second liquid feeding mechanism 520 moves the second liquid 20 from the storage section 600 to the second injection port 131 through the liquid feed pipe 522 by the pressure of the second pressure source 521.

The pressure path 512 and the liquid feed pipe 522 are constituted by pipe members. Transmission of pressure through the pressure path 512 can be performed using gas pressure, air pressure, or hydraulic pressure as a medium. For example, the first pressure source 511 feeds inert gas, air or the like to the pressure path 512 and pressurizes and supplies it into the first well 120. The first pressure source 511 may pressurize and supply a liquid medium for pressurizing the first liquid 10 into the first well 120.

As shown in FIG. 31, various configurations can be adopted for the storage section 600. The storage section 600 may be disposed inside the liquid feeder 500 or may be disposed outside. For example, the storage section 600a is a liquid container 610 that stores the second liquid 20. The liquid feeder 500 includes a container installation section 505 in which the liquid container 610 is installed. That is, the liquid feeder 500 uses a bottle of the second liquid 20 as it is and feeds liquid to the specimen processing chip 100.

In the example of FIG. 31, a storage section 600b is a liquid container 610 that stores the second liquid 20, and the liquid feeder 500 includes an external connection part 506 for connecting the external liquid container 610 and the second liquid feeding mechanism 520.

In FIG. 31, a storage section 600c is a chamber provided in the liquid feeder 500. The second liquid 20 is set in the liquid feeder 500 by being transferred from the liquid container 610 into the chamber.

The first liquid feeding mechanism 510 feeds the first liquid 10 to the flow path 110 from the first well 120 that holds the first liquid 10 containing the living body-derived specimen 11. Thereby, the living body-derived specimen 11 can be fed directly to the flow path 110 from the first well 120 provided in the specimen processing chip 100, without being taken in the feeder. As a result, contamination of the specimen 11 can be prevented from occurring, even when liquid feeding processing by the same liquid feeder 500 is repeatedly performed on a plurality of different specimen processing chips 100. Also, when the operator injects the first liquid 10 containing the specimen 11 into the first well 120, an error in the liquid injection position can be suppressed by the identification mechanism 540, thus an injection error of the specimen 11 can be effectively suppressed.

The first liquid feeding mechanism 510 feeds the first liquid 10 to the flow path 110 from a first well 120a that holds the first liquid 10 and feeds a third liquid 30 to the flow path 110 from a first well 120b that holds the third liquid 30 containing a component 31 corresponding to the inspection item of a specimen inspection using the specimen processing chip 100. Thereby, the component 31 corresponding to the inspection item of a specimen inspection can be fed directly to the flow path 110 from the first well 120 provided in the specimen processing chip 100, without passing through a liquid feed pipe or the like of the liquid feeder 500. As a result, contamination of the component 31 corresponding to the inspection item of a specimen inspection can be prevented from occurring, even when liquid feeding processing by the same liquid feeder 500 is repeatedly performed on a plurality of specimen processing chips 100. Also, when the operator injects the third liquid 30 containing the component 31 corresponding to the inspection item into the first well 120, an error in the liquid injection position can be suppressed by the identification mechanism 540, thus an injection error of the component 31 corresponding to the inspection item can be effectively suppressed.

In the configuration example of FIG. 31, the second liquid feeding mechanism 520 feeds each of the plurality of types of the second liquids 20 from a plurality of storage sections 600 connected to the common second injection port 131 to the flow path 110 through the second injection port 131. Thereby, the plurality of types of the second liquids 20 can be fed to the flow path 110 of the specimen processing chip 100 through the common second injection port 131. As a result, since the number of the second injection ports 131 can be suppressed, it is possible to prevent the operator from mistaking the second injection port 131 as the first injection port 121.

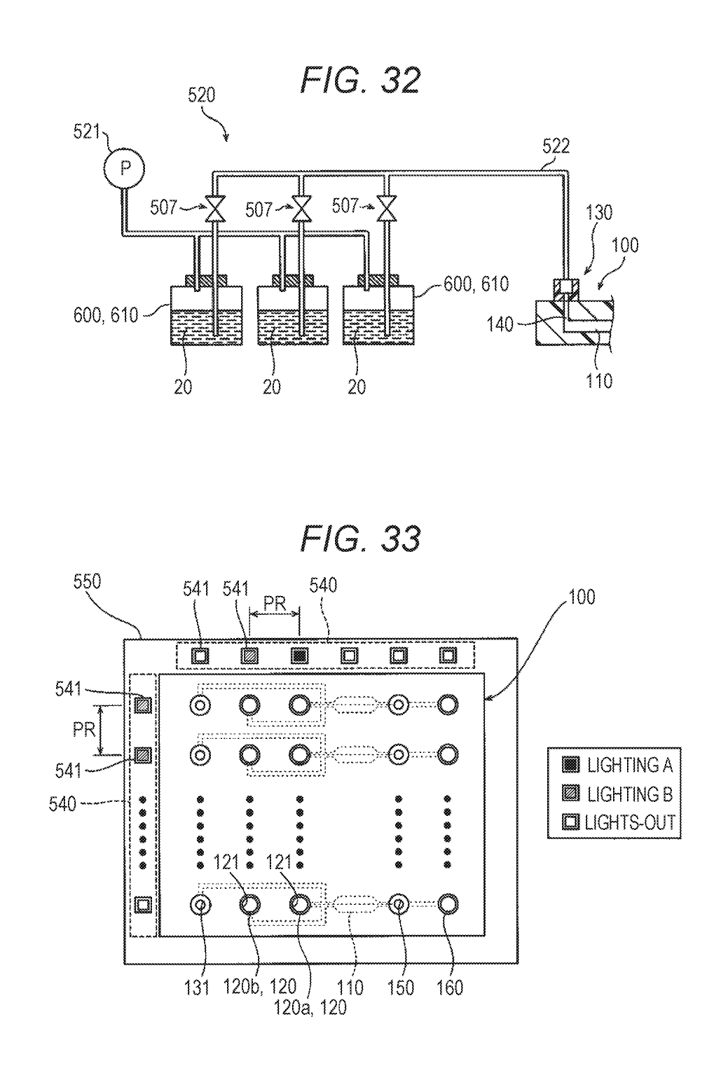

For example, as shown in FIG. 32, the second liquid feeding mechanism 520 includes a valve 507 for switching connection of each storage section 600 to the common second injection port 131, and by switching the valve 507, each of the plurality of types of the second liquids 20 is separately fed to the flow path 110 through the common second injection port 131.

(Identification Mechanism)

In the examples shown in FIGS. 33 to 35, the identification mechanism 540 includes a light emitting part 541 for indicating the position of the first injection port 121, in the specimen processing chip 100 installed in the installation section 550. That is, the identification mechanism 540 enables the operator to identify the position of the first injection port 121 by lighting the indicator. The light emitting part 541 can be constituted, for example, by a light emitting element such as an LED. The light emitting part 541 is provided corresponding to the arrangement position of the first injection port 121 in the specimen processing chip 100 so that the first injection port 121 can be distinguishably recognized from the other second injection ports 131. This allows the operator to identify the first injection port 121 of the specimen processing chip 100 installed in the installation section 550 from other structures such as the second injection port 131 using light of the light emitting part 541 as a clue. Therefore, the operator can easily distinguish the first injection port 121 simply by visually recognizing the light emitting part 541 from the outside.

In the example of FIG. 33, the light emitting part 541 is disposed at a position corresponding to the first injection port 121 around the installation section 550. A plurality of light emitting parts 541 is provided side by side in the longitudinal direction and the lateral direction along the periphery of the specimen processing chip 100. The plurality of light emitting parts 541 is provided at positions side by side with the first well 120 in the longitudinal direction and the lateral direction, respectively. That is, the light emitting parts 541 arranged in the lateral direction represent the lateral position, and the light emitting parts 541 arranged in the longitudinal direction represent the longitudinal position. The position of the first injection port 121 can be identified by the intersection position between the longitudinal and lateral light emitting parts 541 to be turned on. This allows the operator to easily identify the first injection port 121 into which the first liquid 10 is to be injected. Each light emitting part 541 may be configured to emit light in a plurality of lighting states. In FIG. 33, each light emitting part 541 can switch between lighting A in the first color, lighting B in the second color and lights-out. Thereby, a plurality of the first injection ports 121 can be identified from each other. The lighting state may be distinguishable by continuous lighting and blinking, in addition to the light emitting color.

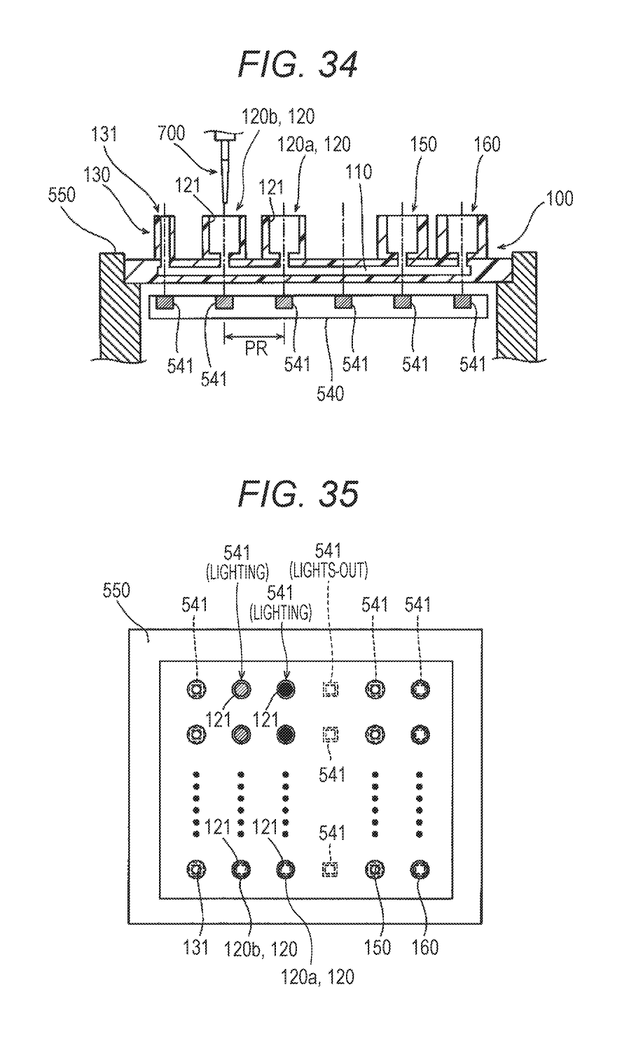

In the example of FIG. 34, the light emitting part 541 is disposed at a position overlapping with the first injection port 121 below the specimen processing chip 100 installed in the installation section 550. The light emitting part 541 emits light toward the lower surface of the upper specimen processing chip 100. In the case of FIG. 34, the specimen processing chip 100 shall have transparency or translucency. Thereby, as shown in FIG. 35, it is possible to irradiate light so that the first injection port 121 and the second injection port 131 are illuminated from the position just below the first injection port 121 and the second injection port 131. The light emitting part 541 located just below the first injection port 121 is turned on to illuminate the first injection port 121 or the first well 120, whereby it is possible to allow the operator who visually recognizes from the outside to identify it. In the case of FIG. 34, since the first well 120 having the first injection port 121 into which the first liquid 10 is to be injected glows, it is possible to make the operator easily and certainly recognize the first injection port 121 to be targeted.

In the examples of FIGS. 33 and 35, the light emitting parts 541 are arranged at intervals of a predetermined pitch PR. Therefore, in the configuration in which the first injection port 121, the second injection port 131, the collection holding section 160 and the discharge port 150 of the specimen processing chip 100 are arranged at the predetermined pitch PR, even when the arrangement position of the first well 120 having the first injection port 121 is different from the illustrated position according to the shape of the flow path 110, the position of the first injection port 121 can be certainly indicated only by switching the light emitting part 541 to be turned on. Therefore, it is possible to handle various kinds of specimen processing chips 100 with the same liquid feeder 500.

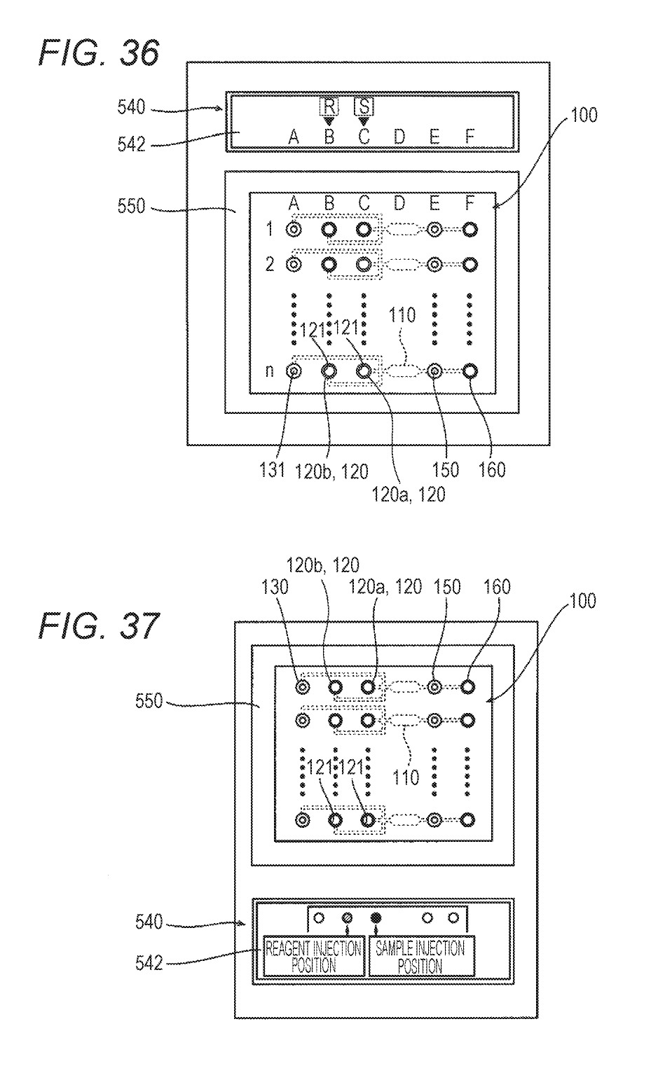

In the examples shown in FIGS. 36 and 37, the identification mechanism 540 includes a display section 542 for displaying the arrangement of the first injection port 121, in the specimen processing chip 100 installed in the installation section 550. The display section 542 is provided, for example, in the vicinity of the installation section 550. In FIG. 36, the display section 542 is provided at a position adjacent to the installation section 550. The display section 542 is configured to allow the operator to identify the arrangement of the first injection port 121 by displaying letters, figures, images, or the like. The display section 542 can be constituted by, for example, a liquid crystal display or the like. This allows the operator to easily and certainly recognize the first injection port 121 into which the first liquid 10 is to be injected, only by viewing a display on the display section 542.

In the example of FIG. 36, row numbers (1 to n) and column numbers (A to F) are attached to the specimen processing chip 100, and the first wells 120 are arranged side by side in the column direction (longitudinal direction). The C column is the first well 120a that holds the first liquid 10, and the B column is the first well 120b that holds the third liquid 30. The display section 542 displays the column numbers A to F, displays the image of “S” indicating the first liquid 10 above the column number C, and displays the image of “R” indicating the third liquid 30 above the column number B. This allows the operator to recognize at a glance that the first liquid 10 is injected into the first well 120a of the C column, and the third liquid 30 is injected into the first well 120b of the B column.

In the example of FIG. 37, the specimen processing chip 100 includes a plurality of unit flow path structures 101. The display section 542 displays an image of one unit flow path structure 101 and displays an arrow with a message to each of the first well 120a into which the first liquid 10 is to be injected and the first well 120b into which the third liquid 30 is to be injected. This allows the operator to visually recognize the position of each first well 120 by comparing the display of the display section 542 with the specimen processing chip 100 on the installation section 550.

In addition to this, an actual captured image of the specimen processing chip 100 installed in the installation section 550 may be displayed to allow the operator to identify the position of the first well 120. In addition, the position of the first well 120, the procedure of specimen processing using the specimen processing chip 100 and the like may be displayed by moving images. Audio navigation may be further added.

In each configuration example shown in FIGS. 33 to 37, the specimen processing chip 100 has a plurality of first wells 120. The first liquid feeding mechanism 510 feeds each of the plurality of types of the first liquids 10 to the flow path 110 from the plurality of types of the first liquids 10 stored in each of the plurality of the first wells 120. Then, the identification mechanism 540 is configured to allow the operator to identify each of the plurality of the first wells 120 as in the respective configuration examples shown in FIGS. 33 to 37. As a result, even when there is a plurality of first injection ports 121 into which the first liquid 10 is to be injected, the operator can distinguish each of the first injection ports 121 from each other while identifying the first injection port 121 from other structures such as the second injection port 131 by the identification mechanism 540. Thereby, even in a situation where there is a plurality of first injection ports 121 thus it is easy to make a mistake, it is possible to suppress a mistake of the liquid to inject into the first injection port 121.

(Configuration Example of Liquid Feeders)

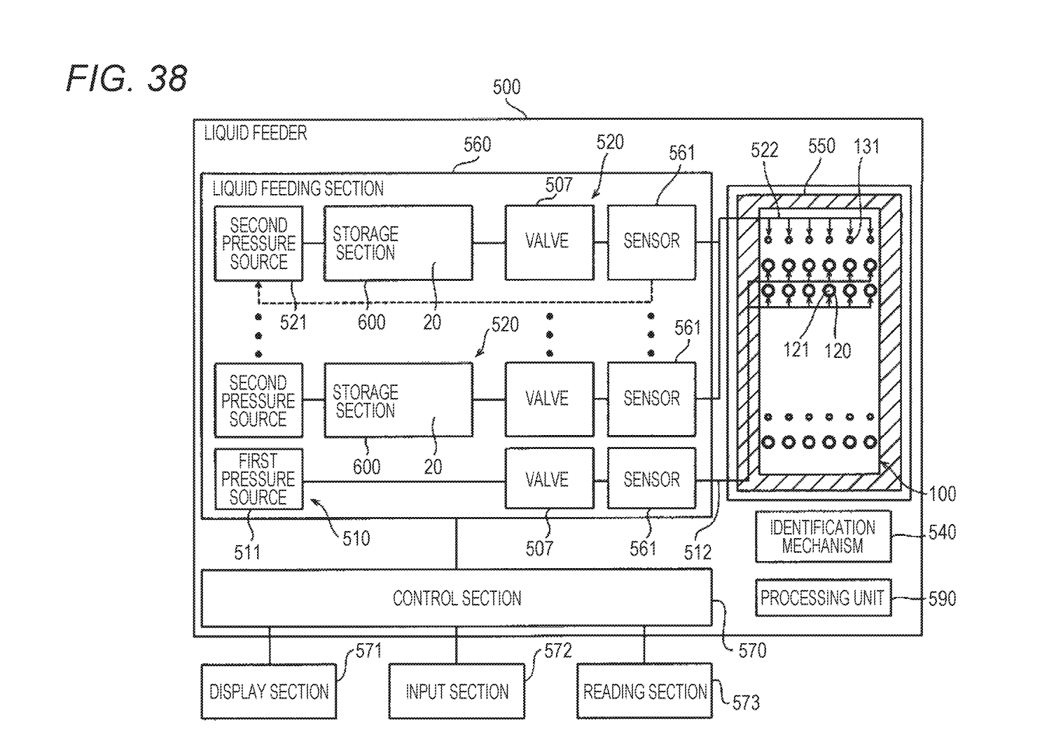

Next, a specific feeder configuration example of the liquid feeder 500 will be shown. In FIG. 38, the liquid feeder 500 includes an installation section 550, a liquid feeding section 560, and a control section 570 that controls the liquid feeding section 560.

The liquid feeding section 560 has a function of feeding various liquids to the specimen processing chip 100. That is, the liquid feeding section 560 includes each liquid feeding mechanism including at least a first liquid feeding mechanism 510 and a second liquid feeding mechanism 520.

The control section 570 supplies various liquids such as specimens and reagents to the specimen processing chip 100 so that a predetermined one or more processing steps corresponding to the structure of the specimen processing chip 100 are performed, and the control section 570 controls the liquid feeding section 560 so as to sequentially transfer them to a flow path 110.

Control of the liquid feeding section 560 is performed by controlling the supply pressure of the liquid feeding section 560 with, for example, by a flow rate sensor or a pressure sensor provided in a liquid supply path. In FIG. 38, the liquid feeding section 560 includes a flow rate sensor 561 that measures the flow rate of the liquid to be fed.

In the configuration of FIG. 38, the flow rate sensor 561 feeds back to the liquid feeding mechanism (the first liquid feeding mechanism 510, the second liquid feeding mechanism 520, etc.) that feeds liquid. The liquid feeding mechanism controls the pressure in accordance with the feedback from the flow rate sensor 561.

The flow rate sensor 561 may feed back to the control section 570. The control section 570 controls the pressure of the liquid feeding section 560 for transferring liquid, based on the flow rate measured by the flow rate sensor 561.

When processing units 590 used for various processing steps are installed in the liquid feeder 500, the control section 570 may control these processing units 590. Examples of units used for various processing steps include a heater unit or a cooling unit for controlling the temperature of the liquid, a magnet unit for applying a magnetic force to the liquid, a camera unit for imaging the liquid, a detection unit for detecting a specimen or a labeling in the liquid, and the like. These processing units 590 are configured to operate when performing a processing step in the flow path 110 of the specimen processing chip 100.

In addition to this, the liquid feeder 500 can include a display section 571, an input section 572, a reading section 573, and the like. On the display section 571, the control section 570 displays a predetermined display screen according to the operation of the liquid feeder 500. The display section 571 may be common to the display section 542 serving as the identification mechanism 540, or the position of the first injection port 121 may be displayed on the display section 571. The sub display section 542 for displaying the liquid injection position and the main display section 571 of the liquid feeder 500 may be separately provided. The liquid feeder 500 may be connected to an external computer (not shown) and displayed on the display section of the computer. The input section 572 is composed of, for example, a keyboard and has a function of receiving information input. The reading section 573 includes, for example, a code reader such as a bar code and a two-dimensional code, a tag reader such as an RFID tag, and has a function of reading information given to the specimen processing chip 100. The reading section 573 can also read information such as a specimen container (not shown) for storing a specimen containing a target component.

With such device configuration, the control section 570 controls the liquid feeding section 560 to cause the specimen processing chip 100 to allow the specimen and reagent containing the target component to the specimen processing chip 100. Thereby, in the specimen processing chip 100, one or more processing steps corresponding to the flow path configuration of the specimen processing chip 100 are performed.

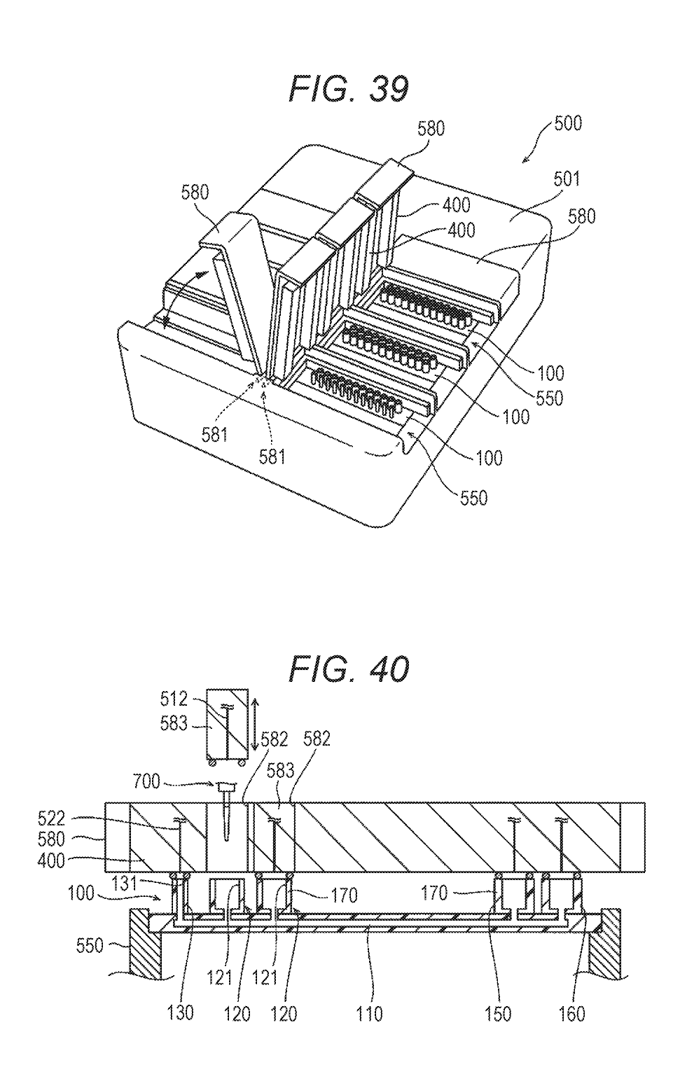

FIG. 39 is a schematic view showing the appearance of the liquid feeder 500. In FIG. 39, the liquid feeder 500 includes a lid 580 corresponding to the installation section 550. The lid 580 is connected to a feeder main body 501. The lid 580 may be detachably attached to the feeder main body 501. The installation section 550 is disposed on the upper surface of a box-shaped feeder main body 501. The lid 580 covers the specimen processing chip 100 on the installation section 550 by being closed, and exposes the specimen processing chip 100 to the outside on the installation section 550 by being opened.

The lid 580 includes a connector 400 for fluidly connecting the first liquid feeding mechanism 510 and the second liquid feeding mechanism 520 with each of the first injection port 121 and the second injection port 131 on the specimen processing chip 100. That is, the connector 400 includes a connection port to the first injection port 121 of the specimen processing chip 100 and a connection port to the second injection port 131. By connecting the connectors 400 to the first well 120 and the second injection port 131 of the specimen processing chip 100 installed in the installation section 550, respectively, it is possible to supply pressure to the first well 120 by the first liquid feeding mechanism 510, and feed the second liquid 20 to the second injection port 131 by the second liquid feeding mechanism 520.

The connector 400 may be detachably attached to the lid 580 or may be fixed to the lid 580. A plurality of connectors 400 may be provided so as to be connected to one first injection port 121 or second injection port 131.

Although not shown in detail in FIG. 39, the specimen processing chip 100 having a plurality of channels of unit flow path structures 101 is set in the installation section 550. The connector 400 is provided on the lower surface of the lid 580. The connector 400 is configured as a manifold that can be collectively connected to the first injection port 121 and the second injection port 131 provided in each of the unit flow path structures 101 of the plurality of channels. That is, the connector 400 integrally includes connection ports for the plurality of first injection ports 121 corresponding to the number of channels of the specimen processing chip 100, and connection ports for the plurality of second injection ports 131 corresponding to the number of channels. By closing the lid 580, the connector 400 and the first injection port 121 and the second injection port 131 provided in each of the unit flow path structures 101 of the plurality of channels are collectively connected.

As described above, in example of FIG. 39, the lid 580 is configured to be openable and closable with respect to the installation section 550. When the lid 580 is closed with respect to the installation section 550, the connector 400 is connected to each of the first injection port 121 and the second injection port 131. In the example of FIG. 39, the lid 580 is connected to the feeder main body 501 by a hinge 581, and is opened and closed by rotating around the hinge 581.

In FIG. 40, the identification mechanism 540 includes an opening window portion 582 provided in a part of the lid 580 so as to expose the first injection port 121 of the specimen processing chip 100 installed in the installation section 550. That is, with the lid 580 covering the specimen processing chip 100, the opening window portion 582 exposes only the formation position of the first injection port 121 to the outside. The second injection port 131, the collection holding section 160 and the discharge port 150 remain covered by the lid 580. The operator can inject liquid into the first injection port 121 through the opening window portion 582 using an injection tool 700 with the lid 580 closed. This allows the operator to recognize the first injection port 121 into which the first liquid 10 is to be injected, by exposing the first injection port 121 from the opening window portion 582 in a state where the specimen processing chip 100 is covered by the lid 580. Further, it is possible to prevent the operator from erroneously injecting the first liquid 10 into other than the first injection port 121, by covering other structures such as the second injection port 131 with the lid 580.

In the example of FIG. 40, the identification mechanism 540 includes an opening and closing member 583 for opening and closing the opening window portion 582. The opening window portion 582 can be opened by the opening and closing member 583 only when injecting the first liquid 10. As a result, even in the case where the opening window portion 582 that exposes the first injection port 121 is provided, entry of foreign matter or the like from the outside can be prevented.

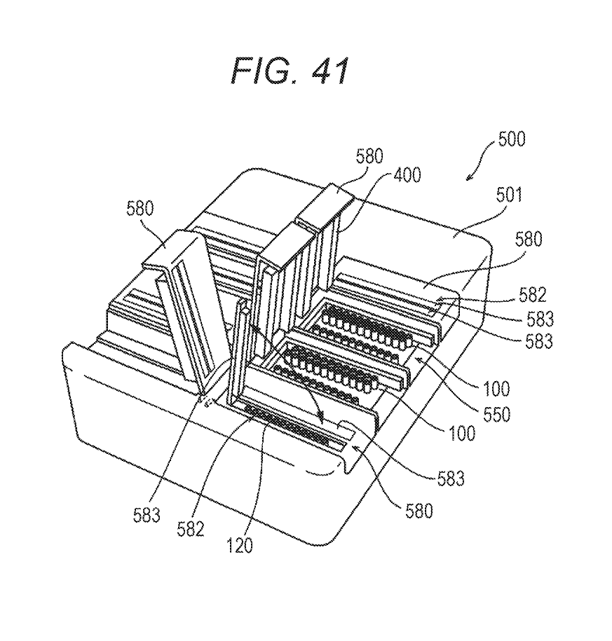

For example, as shown in FIG. 41, one end portion of the opening and closing member 583 is rotatably attached to the lid 580, and the opening window portion 582 can be opened and closed by rotating the opening and closing member 583. In addition, the opening and closing member 583 may have a shutter structure that slides so as to open and close the opening window portion 582. The opening window portion 582 may not be provided with the opening and closing member 583 and may remain open.

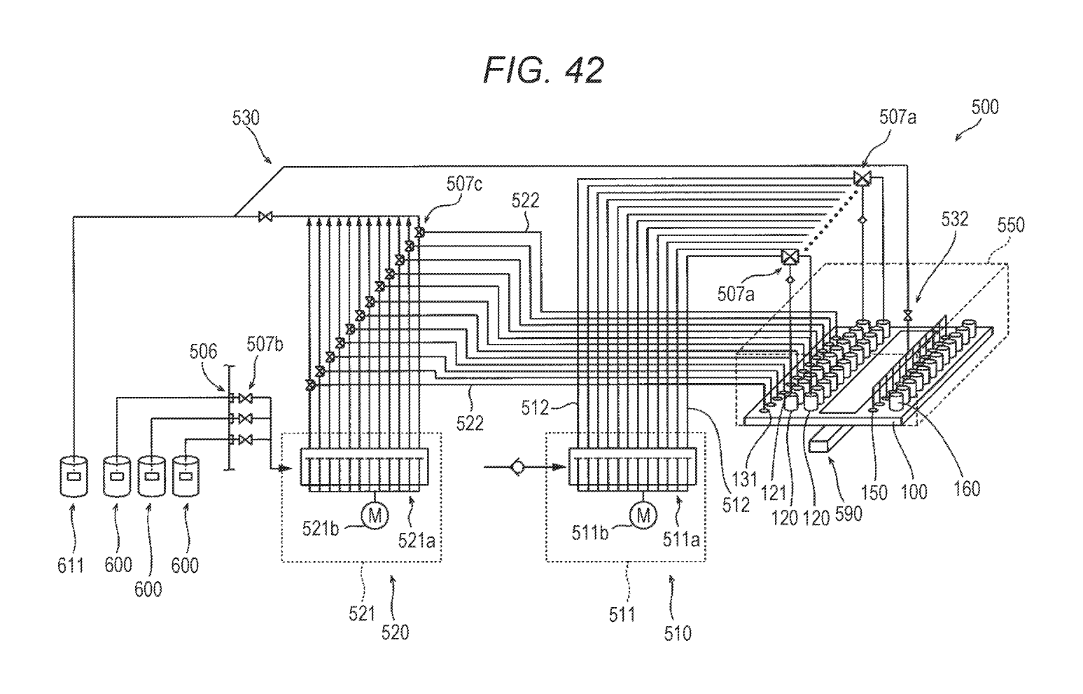

FIG. 42 shows a configuration example of a liquid feeder 500 that feeds liquid to a specimen processing chip 100 having a plurality of channels of unit flow path structures 101 including a flow path 110, a first well 120 having a first injection port 121 and a second injection port 131. In FIG. 42, the specimen processing chip 100 has a 12-channel configuration, and the specimen processing chip 100 has twelve unit flow path structures 101.

In the example of FIG. 42, a first liquid feeding mechanism 510 includes a first pressure source 511 comprising a syringe pump containing multiple syringes 511a and a motor 511b that collectively drives the multiple syringes 511a. The first liquid feeding mechanism 510 includes a plurality of (twelve) pressure paths 512 that individually connects each syringe 511a of the first pressure source 511 and the first well 120 of each channel. Each pressure path 512 is connected to a plurality of first wells 120 provided for each channel via a valve 507a comprising a multi-way valve. The first liquid feeding mechanism 510 collectively supplies pressure to each of the first wells 120 of the unit flow path structures 101 of the plurality of channels by switching the valve 507a and driving the first pressure source 511. In FIG. 42, the syringe 511a of the first pressure source 511 is connected to an air path, and the first pressure source 511 supplies air pressure.

A second liquid feeding mechanism 520 includes a second pressure source 521 comprising a syringe pump containing multiple syringes 521a and a motor 521b that collectively drives the multiple syringes 521a. The second liquid feeding mechanism 520 includes a plurality of (twelve) liquid feed pipes 522 that individually connects each syringe 521a of the second pressure source 521 and the second injection port 131 of each channel. The second liquid feeding mechanism 520 is connected to each storage section 600 via an external connection part 506 including a valve 507b. The second liquid feeding mechanism 520 switches a second liquid 20 to be fed by switching the valve 507b. The second liquid feeding mechanism 520 collectively feeds the selected second liquid 20 to each of the second injection ports 131 of the unit flow path structures 101 of the plurality of channels by driving the second pressure source 521 and switching the valve 507c.

FIG. 42 shows an example in which a third liquid feeding mechanism 530 capable of collectively feeding a fluid from the discharge port 150 of each channel to a collection container 611 is provided.

(Connection Structure with Specimen Processing Chip)

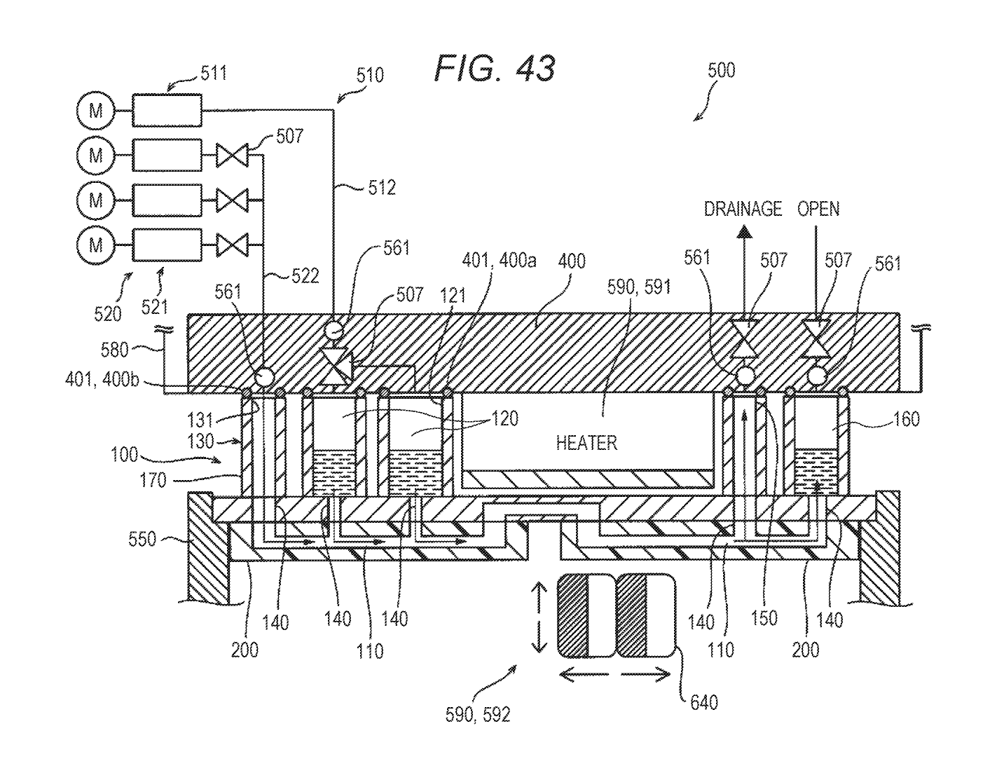

FIG. 43 shows a specimen processing chip 100 installed in an installation section 550 and a connector 400 provided in a lid 580 corresponding to the installation section 550. FIG. 43 shows, for example, one of the unit flow path structures 101 shown in the 12-channel specimen processing chip 100 shown in FIG. 42. The manifold type connector 400 is provided with a plurality of liquid feed pipes 522 and pressure paths 512. In a state where the lid 580 is closed, the liquid feed pipes 522 and the respective pressure paths 512, the second injection port 131 and the respective first injection ports 121 of the specimen processing chip 100 are collectively connected via the connector 400.

That is, in the example of FIG. 43, the liquid feeder 500 includes the lid 580 including a first connector 400a connected to the first injection port 121 and a second connector 400b connected to the second injection port 131. The first injection port 121 is configured to connect to the first connector 400a, and the second injection port 131 is configured to connect to the second connector 400b. With this configuration, it is possible to allow slight positional deviation when connecting the well to the connector, so that it is possible to easily position the well and the connector.

The connector 400 may include a valve 507 or a flow rate sensor 561. Inside the connector 400 of FIG. 43, a valve 507 and a flow rate sensor 561 are provided.

The seal member 401 seals between the connector 400 and the upper surface of the first well 120 and between the connector 400 and the upper surface of the second well 130.

As shown in FIG. 43, the lid 580 or the connector 400 can be provided with a processing unit 590 used for specimen processing. A processing unit 590 can also be provided in the installation section 550 in which the specimen processing chip 100 is installed. These processing units are provided according to the content of the specimen processing performed in the flow path 110. A processing unit 590 may not be provided in the connector 400 and the installation section 550.

(Example of Liquid Feeding)

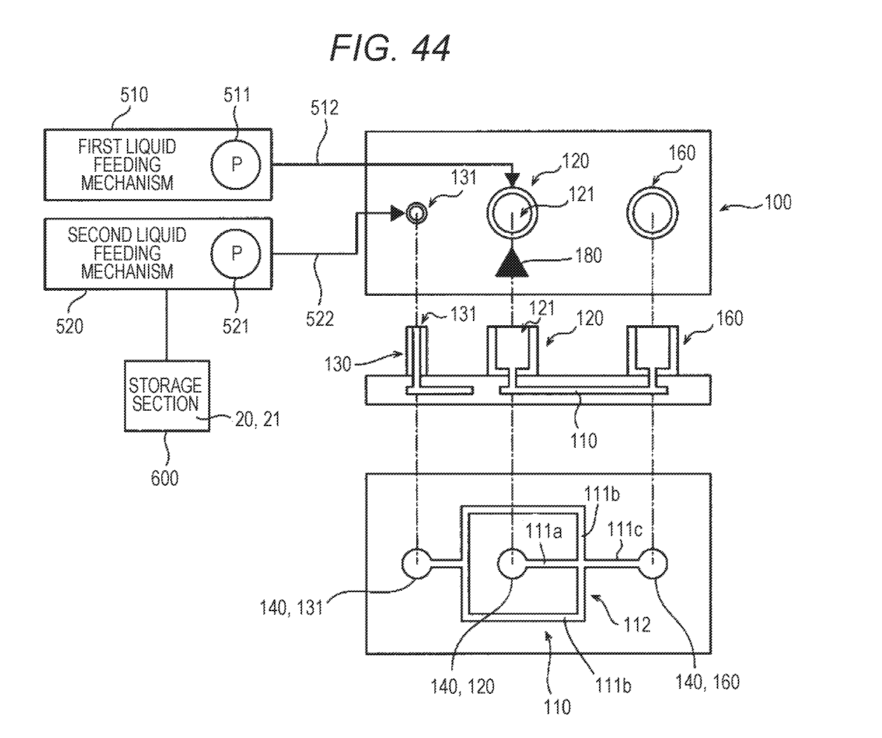

Next, an example of the liquid feeding method of the present embodiment performed by the liquid feeder 500 will be described. FIG. 44 shows an example of liquid feeding in which a step of forming a fluid in the emulsion state is performed. That is, a fluid in the emulsion state containing a second liquid 20 as a dispersion medium and a first liquid 10 as a dispersoid is formed in a flow path 110, by liquid feeding. Further, FIG. 44 shows a specimen processing chip 100 used for emulsion formation.

The first liquid 10 is held in a first well 120. A second injection port 131 is connected to a storage section 600 on the liquid feeder 500 side. The second liquid 20 is stored in the storage section 600.

In the case of performing the step of forming a fluid in the emulsion state, after starting feeding of the second liquid 20 to the flow path 110, feeding of the first liquid 10 to the flow path 110 is started to introduce the first liquid 10 into the flow of the second liquid 20, thereby forming a fluid in the emulsion state containing the second liquid 20 as a dispersion medium and the first liquid 10 as a dispersoid in the flow path 110. Thereby, an emulsion state can be efficiently formed by introducing the first liquid 10 into the flow of the second liquid 20.

The liquid feeder 500 feeds the first liquid 10 from the first well 120 by the first liquid feeding mechanism 510 and feeds the second liquid 20 from the second well 130 by the second liquid feeding mechanism 520, so as to form a fluid in the emulsion state containing the second liquid 20 as a dispersion medium and the first liquid 10 as a dispersoid in the flow path 110. Thereby, it is possible to form an emulsion state in which droplets 50 of the first liquid 10 are dispersed in the second liquid 20 using the specimen processing chip 100. When, for example, both the first liquid 10 and the second liquid 20 flow in from the second injection port 131 by mistaking the injection position of the first liquid 10, it is possible that an emulsion state cannot be formed. Therefore, the liquid feeder 500 of the present embodiment that can easily prevent an error in the injection position of the first liquid 10 by the identification mechanism 540 is suitable for liquid feeding of the specimen processing chip 100 that performs processing of forming an emulsion state.

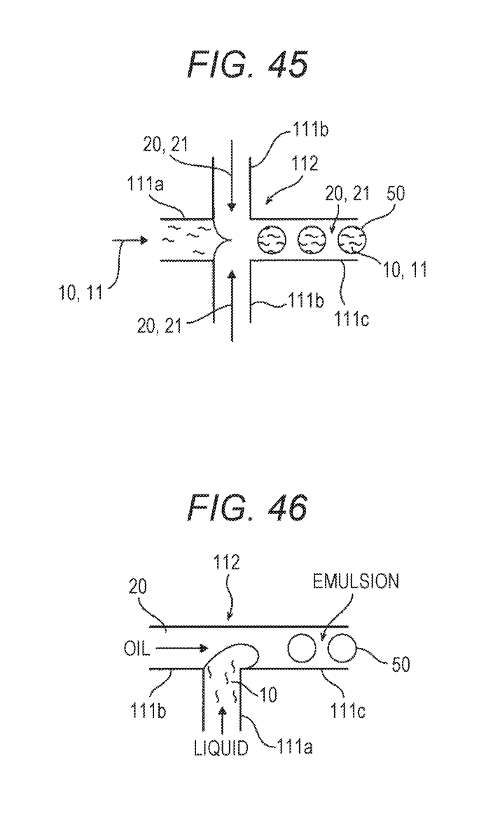

FIG. 45 shows an example of a flow path 110 for forming a droplet 50 of a first liquid 10 in a second liquid 20. In the examples of FIGS. 44 and 45, the first liquid 10 contains a living body-derived specimen 11, and the second liquid 20 is oil 21. The first liquid feeding mechanism 510 feeds the first liquid 10 containing the living body-derived specimen 11 to the flow path 110 by applying pressure to the first well 120, and the second liquid feeding mechanism 520 feeds the second liquid 20 that is the oil 21 to the flow path 110 by applying pressure to the storage section 600. The first liquid 10 is dispersed in the second liquid 20 in the flow path 110 by liquid feeding to become the droplet 50. That is, an emulsion in which the second liquid 20 is a dispersion medium, and the first liquid 10 present as the droplet 50 in the second liquid 20 is a dispersoid is formed.

In FIG. 45, the flow path 110 includes a first channel 111a and a second channel 111b crossing each other. When the first channel 111a and the second channel 111b are provided, a fluid in the emulsion state is formed, by feeding the first liquid 10 and the second liquid 20 respectively to the first channel 111a and the second channel 111b crossing each other provided in the flow path 110. Thereby, by applying a shear force due to the flow of the second liquid 20 to the first liquid 10 at the intersection portion of the first channel 111a and the second channel 111b, it is possible to efficiently form an emulsion state in which the droplets 50 of the first liquid 10 are dispersed in the second liquid 20.

In FIG. 45, the specimen processing chip 100 is configured by the first liquid 10 fed to the first channel 111a and the second liquid 20 fed to the second channel 111b, so as to form a fluid in the emulsion state containing the second liquid 20 as a dispersion medium and the first liquid 10 as a dispersoid. At the intersection portion 112 of the first channel 111a and the second channel 111b, the second liquid 20 flows in a direction transverse to the flow of the first liquid 10. The first liquid 10 is divided into droplets by the shear force generated by the flow of the second liquid 20 at the intersection portion 112. As a result, a droplet 50 of the first liquid 10 is formed in the second liquid 20.

As described above, by applying a shear force due to the flow of the second liquid 20 to the first liquid 10 at the intersection portion 112 of the first channel 111a and the second channel 111b, it is possible to continuously efficiently produce many droplets 50 of the first liquid 10 to form an emulsion state. Thereby, by dividing the components in the specimen into each unit and storing them in the droplet 50, the specimen processing for each unit component can be performed in the specimen processing chip 100. When, for example, both the first liquid 10 and the second liquid 20 flow in from the second channel 111b by mistaking the injection position of the first liquid 10, it is possible that an emulsion state cannot be formed at the intersection portion 112. Therefore, the specimen processing chip 100 of the present embodiment that can easily prevent an error in the injection position of the first liquid 10 by the identification section 180 is suitable for the specimen processing that forms an emulsion state.

The liquid feeder 500 forms a fluid in the emulsion state containing the second liquid 20 as a dispersion medium and the first liquid 10 as a dispersoid in the flow path 110, by feeding the first liquid 10 and the second liquid 20 respectively to a first channel 111a and a second channel 111b crossing each other provided in the flow path 110, by the first liquid feeding mechanism 510 and the second liquid feeding mechanism 520. Thereby, by applying a shear force due to the flow of the second liquid 20 to the first liquid 10 at the intersection portion 112 of the first channel 111a and the second channel 111b, it is possible to efficiently form an emulsion state in which the droplets 50 of the first liquid 10 are dispersed in the second liquid 20.

In FIG. 45, the first channel 111a and the second channel 111b are orthogonal to each other. In addition, a pair of second channels 111b is provided on both sides of the first channel 111a. Since the flow of the second liquid 20 in the pair of second channels 111b flows into the intersection portion 112 so as to sandwich the flow of the first liquid 10, the shear force for forming the droplet 50 efficiently acts. The crossing angle between the first channel 111a and the second channel 111b is preferably close to 90 degrees, for example, in the range of 90 degrees±10 degrees, in order to increase the shear force. The crossing angle may be, for example, in the range of 60 degrees or more and 120 degrees or less, or in the range of 45 degrees or more and 135 degrees or less. A mixed liquid of the droplet 50 of the first liquid 10 and the second liquid 20 flows from the intersection portion 112 toward a third channel 111c extending to the side opposite to the first channel 111a.

As shown in FIG. 46, the intersection portion 112 may be formed in a T shape by three channels 111. In the case of FIG. 46, the first liquid 10 flows in from the first channel 111a and the second liquid 20 flows in from the second channel 111b. Due to the shear force of the flow of the second liquid 20, the first liquid 10 becomes droplets in the second liquid 20 to form an emulsion.

When flowing the first liquid 10 into the flow path 110, for example, the first liquid 10 is introduced into the flow path 110 in the specimen processing chip 100 at a flow rate of 0.1 μL/min or more and 5 mL/min or less. The flow rate may be constant within this range or may vary. With this configuration, by feeding the first liquid 10 at a high flow rate of 0.1 μL/min or more and 5 mL/min or less, the specimen processing by the specimen processing chip 100 can be performed efficiently. Preferably, the first liquid 10 is introduced into the flow path 110 in the specimen processing chip 100 at a flow rate of 0.1 μL/min or more and 1 mL/min or less. Thereby, high throughput in IVD can be realized by feeding the first liquid 10 at a high flow rate of 0.1 μL/min or more and 1 mL/min or less. More preferably, the first liquid 10 is introduced into the flow path 110 in the specimen processing chip 100 at a flow rate of 0.1 μL/min or more and 200 μL/min or less. Thereby, it is possible to stably form droplets during emulsion formation.

For example, in the formation of the emulsion state, dispersoids of the first liquid 10 are formed at a rate of 600 pieces/min or more and 600 million pieces/min or less. The liquid feeder 500 forms the dispersoids of the first liquid 10 at a rate of 600 pieces/min or more and 600 million pieces/min or less, by the first liquid feeding mechanism 510 and the second liquid feeding mechanism 520. Thereby, it is possible to efficiently form a large number of dispersoids with a high efficiency of 600 pieces/min or more and 600 million pieces/min or less. In order to form a large number of dispersoids, it is necessary to further increase the flow rate of the second liquid 20 that is a dispersion medium, in addition to increase the flow rate of the first liquid 10 that is a dispersoid. The liquid feeding method and the liquid feeder 500 of the present embodiment in which the second liquid 20 is directly fed from the storage section 600 to the flow path 110 by the second liquid feeding mechanism 520 is suitable in that it is hardly subject to the structural restriction of the specimen processing chip 100 and the liquid amount of the second liquid 20 is easily secure, and that the flow rate of the second liquid 20 is easily increased. Preferably, in the formation of the emulsion state, the dispersoid of the first liquid 10 is formed at a rate of 3,000 pieces/min or more and 18 million pieces/min or less. The liquid feeder 500 preferably forms the dispersoids of the first liquid 10 at a rate of 3,000 pieces/min or more and 18 million pieces/min or less, by the first liquid feeding mechanism 510 and the second liquid feeding mechanism 520. Thereby, it is possible to efficiently form a large number of dispersoids with a high efficiency of 3,000 pieces/min or more and 18 million pieces/min or less. Further preferably, in the formation of the emulsion state, the dispersoids of the first liquid 10 is formed at a rate of 5000 pieces/min or more and 9 million pieces/min or less.

In the formation of the emulsion state, for example, dispersoids having an average particle size of 0.1 μm or more and 500 μm or less are formed by the first liquid 10. The liquid feeder 500 forms dispersoids having an average particle size of 0.1 μm or more and 500 μm or less from the first liquid 10, by the first liquid feeding mechanism 510 and the second liquid feeding mechanism 520. The average particle size means the number average diameter measured by the light scattering method. Thereby, it is possible to efficiently form an emulsion with uniform particle size, having an average particle size of 0.1 μm or more and 500 μm or less. Preferably, in the formation of the emulsion state, dispersoids having an average particle size of 0.1 or more and 200 μm or less are formed by the first liquid 10. With this configuration, it is possible to efficiently form an emulsion containing dispersoids having an average particle size of 200 μm or less suitable for biometric measurement. More preferably, in the formation of the emulsion state, droplets of dispersoids having an average particle size of 0.1 μm or more and 100 μm or less are formed by the first liquid 10.

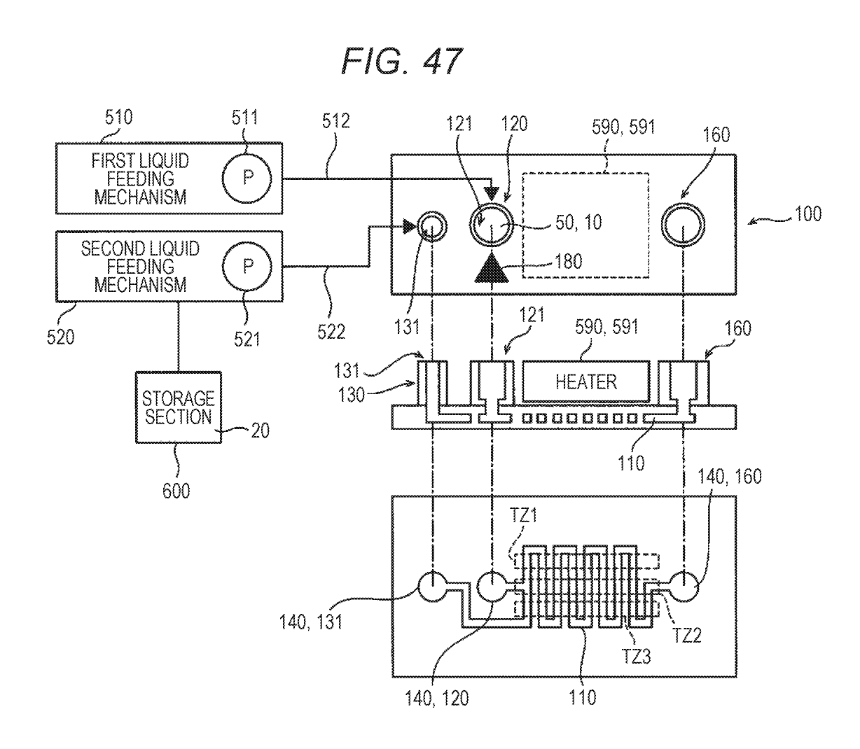

FIG. 47 shows an example of a specimen processing chip 100 that performs specimen processing on droplets 50 of a first liquid 10 containing a specimen. In FIG. 47, the droplet 50 supplied as the first liquid 10 contains DNA as a target component in the specimen, and a reagent includes a reagent for amplifying DNA by PCR (Polymerase Chain Reaction). The reagent for amplification contains primers and polymerases corresponding to DNA and the like.

In the example of FIG. 47, the first liquid 10 that is a fluid in the emulsion state in which the droplet 50 is present in the liquid is fed to a flow path 110 by pressure applied to a first well 120. The second liquid 20 for conveying the first liquid 10 that is an emulsion in the flow path 110 is fed from a second injection port 131 to the flow path 110 by pressure applied to a storage section 600. In the case of performing the PCR step, after feeding the first liquid 10 to the flow path 110, feeding of the second liquid 20 to the flow path 110 is started, and the first liquid 10 is conveyed so as to be pushed out by the second liquid 20. In the flow path 110, the first liquid 10 is conveyed by the second liquid 20. Thereby, the dispersoid of the first liquid 10 can be prevented from remaining in or adhering to the flow path 110 to remain.

In the case of FIG. 47, as the processing unit 590 shown in FIG. 43, a heater 591 for amplifying DNA by PCR in the flow path 110 is used. The heater 591 warms the specimen processing chip 100. The flow path 110 has such a structure that it passes through a plurality of temperature zones TZ1 to TZ3 formed by the heater 591 plural times. The number of the temperature zone TZ may also be any number other than three. The number of times that the channel 111 passes through each of the temperature zones TZ1 to TZ3 corresponds to the number of thermal cycles.

The first liquid 10 introduced from the first well 120 into the flow path 110 is pushed by the second liquid 20 fed from the second injection port 131 and moves in the flow path 110 at a predetermined speed. The DNA in the droplet 50 dispersed in the first liquid 10 is amplified in the process of flowing through the flow path 110. The droplet containing the amplified DNA is collected in the collection holding section 160. Unlike the case where PCR processing is collectively performed on a large number of DNA molecules, amplification processing is performed in the droplet 50, whereby it is possible to individually amplify individual DNAs segmented by one molecule unit.

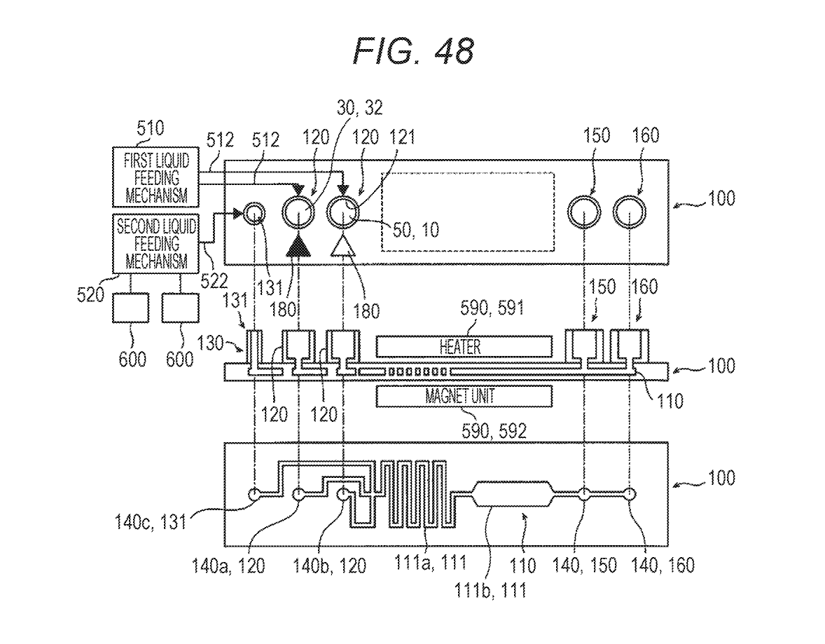

In FIG. 48, an example of liquid feeding in which a step of demulsifying a first liquid 10 in the emulsion state is performed is shown. For example, after the processing of emulsion formation, the droplet 50 in the formed emulsion is broken. The first liquid 10 is demulsified by breakage of the droplet 50. FIG. 48 shows a specimen processing chip 100 used for demulsification.

In the example of FIG. 48, a first well 120 includes a first well 120a for holding the first liquid 10 in the emulsion state containing a living body-derived specimen, and a flow path 110 includes a channel 111a for mixing a first liquid 10 and a second liquid 20 for demulsifying the first liquid 10. In the case where the first liquid 10 is an emulsion in which an aqueous phase droplet 50 is present in oil, one or more types of emulsion breaking reagents containing alcohol, surfactant or the like are used as the second liquid 20 for demulsification. The first liquid 10 and the second liquid 20 join in the channel 111a and are agitated in the process of passing through the channel 111a and are mixed sufficiently. By mixing the first liquid 10 and the second liquid 20, the interface of the droplet 50 is broken, and the components stored in the droplet 50 are taken out into the flow path 110. In the example of FIG. 48, a processing of breaking the droplet 50 contained in the first liquid 10 in the specimen processing chip 100 can be performed by demulsification. When, for example, the first liquid 10 and the second liquid 20 are not sufficiently mixed in the channel 111a by mistaking the injection position of the first liquid 10, it is possible that demulsification is inhibited. Therefore, the specimen processing chip 100 of this embodiment that can easily prevent an error in the injection position of the first liquid 10 by the identification section 180 is suitable for specimen processing that performs demulsification.

In the example of FIG. 48, a first liquid feeding mechanism 510 feeds the first liquid 10 that is a fluid in the emulsion state from the first well 120 to the flow path 110, and a second liquid feeding mechanism 520 feeds the second liquid 20 for demulsifying the first liquid 10 to the flow path 110 from a storage section 600 through a second injection port 131. A mixed liquid of the first liquid 10 and the second liquid 20 is formed in the flow path 110 by liquid feeding by the first liquid feeding mechanism 510 and the second liquid feeding mechanism 520. This makes it possible to perform the processing of breaking the droplet 50 contained in the first liquid 10 in the specimen processing chip 100 can be performed by demulsification. When, for example, the first liquid 10 and the second liquid 20 are not sufficiently mixed in the channel 111 by mistaking the injection position of the first liquid 10, it is possible that demulsification is inhibited. Therefore, the liquid feeder 500 of the present embodiment that can easily prevent an error in the injection position of the first liquid 10 by the identification mechanism 540 is suitable for liquid feeding of the specimen processing chip 100 that performs demulsification processing.

In the example of FIG. 48, the first liquid 10 is a fluid in the emulsion state in which a dispersoid containing a living body-derived specimen 11 and a carrier binding to the specimen 11 are present in the oil 21. Thereby, specimen processing is performed for each unit component, and components in the droplet 50 are taken out from the first liquid 10 in which the component carried on the carrier present in the state of the droplet 50 by demulsification, so that it can be collectively processed in the flow path 110.

In the example of FIG. 48, a process of reacting the demulsified first liquid 10 with a labeling substance 32 is further performed. In the example of FIG. 48, the first well 120 includes a first well 120b for holding a third liquid 30 containing the labeling substance 32 for detecting a specimen. The flow path 110 includes a channel 111 for mixing the first liquid 10 demulsified by mixing with the second liquid 20, and the third liquid 30. The first liquid 10 demulsified by mixing with the second liquid 20 and the third liquid 30 containing the labeling substance 32 for detecting the specimen 11 contained in the first liquid 10 are mixed in the channel 111. By mixing, a target component contained in the specimen 11 and the labeling substance 32 are bound, and detection based on the labeling substance 32 becomes possible.

The labeling substance 32 is a substance which specifically binds to the target component in the specimen 11 and can be measured with a detector. As the label, for example, an enzyme, a fluorescent substance, a radioactive isotope or the like is used. The labeling substance 32 is, for example, a fluorescent substance bound to a probe comprising DNA complementary to the target component DNA.

This makes it possible to perform a processing of labeling the components in the specimen 11 subjected to specimen processing for each unit component with the labeling substance 32 in the flow path 110. Since the labeling substance 32 differs depending on the component to be targeted, by holding the third liquid 30 in the first well 120b of the specimen processing chip 100, not in the storage section 600 on the liquid feeder 500 side, contamination of the labeling substance 32 can be prevented in the case of feeding liquid to a plurality of the specimen processing chips 100 by the same liquid feeder 500. On the other hand, by providing a first well 120b for holding the third liquid 30 in addition to the first well 120a for holding the first liquid 10, the injection positions of the first liquid 10 and the third liquid 30 are easily mistaken, whereas, in the present embodiment, it is possible to suppress an erroneous injection position by the operator, by the identification section 180.

In the example of FIG. 48, the first liquid feeding mechanism 510 feeds the third liquid 30 held in one of a plurality of first wells 120 provided in the specimen processing chip 100 to the flow path 110. The liquid feeder 500 mixes the first liquid 10 demulsified by mixing with the second liquid 20 and the third liquid 30 containing a labeling substance for detecting the specimen contained in the first liquid 10, in the flow path 110, by liquid feeding by the first liquid feeding mechanism 510 and the second liquid feeding mechanism 520.

This makes it possible to perform the processing of labeling the components in the specimen 11 subjected to the specimen processing for each unit component with the labeling substance 32 in the flow path 110 of the specimen processing chip 100. Since the labeling substance 32 differs depending on the component to be targeted, by holding the third liquid 30 in the first well 120 of the specimen processing chip 100, not in the storage section 600 on the liquid feeder 500 side, contamination of the labeling substance 32 can be prevented in the case of feeding liquid to a plurality of the specimen processing chips 100 by the same liquid feeder 500. On the other hand, in the case where the specimen processing chip 100 includes a plurality of the first wells 120, the injection positions of the first liquid 10 and the third liquid 30 are easily mistaken, whereas, in the present embodiment, it is possible to suppress an erroneous injection position by the operator, by the identification mechanism 540.

In FIG. 48, the first liquid 10 and the third liquid 30 are fed into the flow path 110 from a connection portion 140a and a connection portion 140b, respectively, and mixed with each other by a wide channel 111b for performing a labeling processing. In order to promote the binding between the target component and the labeling substance, heat, an electric field, a magnetic field or the like may be applied from the outside of the flow path 110. The first liquid 10 and the third liquid 30 are mixed in the channel 111b. An emulsion breaking reagent is fed from a connection portion 140c.

[Example of Assay Using Specimen Processing Chip]

Next, an example of a specific assay using the specimen processing chip 100 will be described.

(Emulsion PCR Assay)

An example in which an emulsion PCR assay is performed using the above-described liquid feeder 500 and the specimen processing chip 100 will be described.

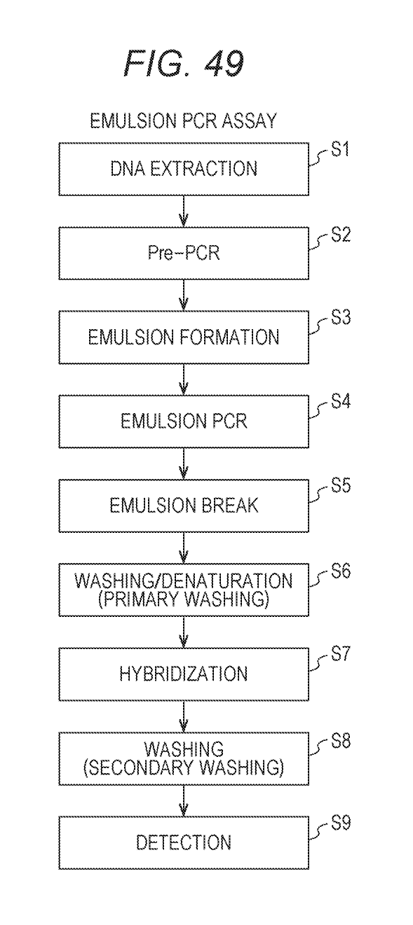

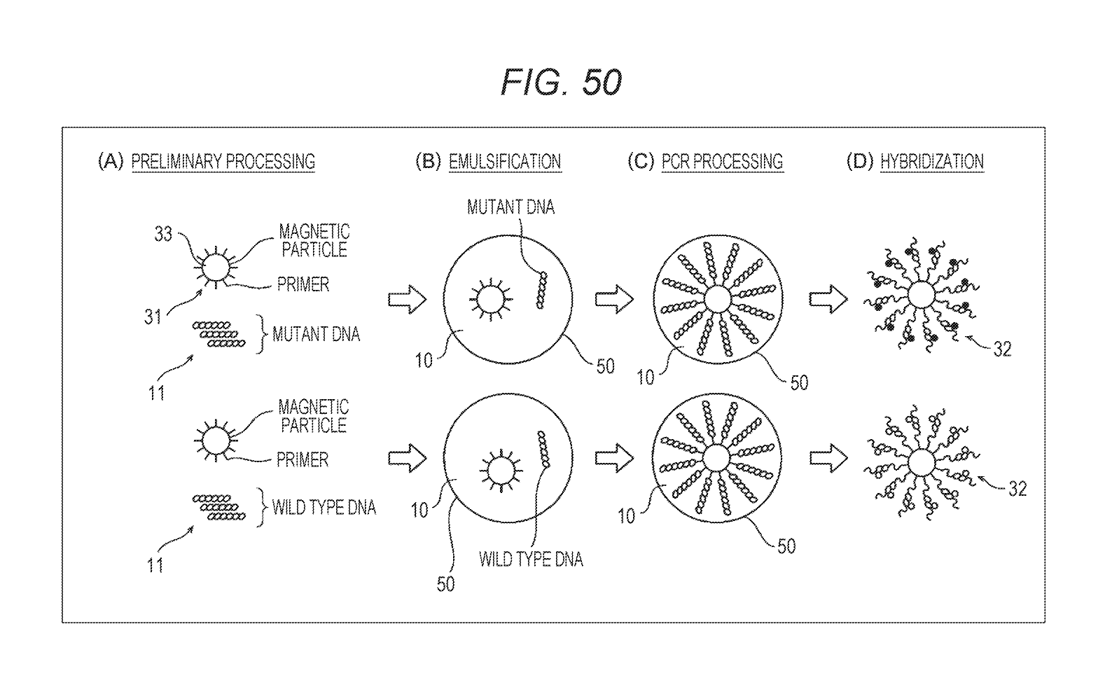

FIG. 49 shows an example of a flow of an emulsion PCR assay. FIG. 50 is a diagram for illustrating progress of the reaction in an emulsion PCR assay.

In step S1, DNA is extracted from a sample such as blood by preprocessing (see FIG. 50A). The preprocessing may be performed using a dedicated nucleic acid extractor, or a preprocessing mechanism may be provided in the liquid feeder 500.

In step S2, the extracted DNA is amplified by pre-PCR processing (see FIG. 50A). The pre-PCR processing is a processing of preliminarily amplifying the DNA contained in the extract liquid after the preprocessing to such an extent that the following emulsion formation processing becomes possible. In the pre-PCR processing, the extracted DNA is mixed with a reagent for PCR amplification containing a polymerase and a primer, and DNA in the mixed liquid is amplified by temperature control by a thermal cycler. The thermal cycler performs a thermal cycle processing of repeating one cycle of changing to a plurality of different temperatures on the mixed liquid a plurality of times.

Step S3 is an emulsion forming step in which a droplet containing a mixed liquid of nucleic acid (DNA) as a target component, a reagent for amplification reaction of the nucleic acid and a carrier of the nucleic acid is formed as a dispersoid in a dispersion medium. The reagent for amplification reaction of the nucleic acid contains substances necessary for PCR such as DNA polymerase. In step S3, an emulsion containing a reagent containing magnetic particles, polymerase and the like and DNA is formed (see FIG. 50B). In step S3, a droplet containing a mixed liquid of the reagent containing magnetic particles, polymerase and the like and DNA is formed, and a dispersoid comprising a large number of droplets is dispersed in a dispersion medium. For the magnetic particles confined in the droplet, a primer for nucleic acid amplification is provided on the surface. The droplets are formed so that each one of magnetic particles and target DNA molecules are contained in the droplets. The dispersion medium is immiscible with the mixed liquid. In this example, the mixed liquid is aqueous-based, and the dispersion medium is oil-based. The dispersion medium is, for example, oil.

Step S4 is an emulsion PCR step of amplifying the nucleic acid (DNA) in the droplet formed in the emulsion forming step. In step S4, by temperature control by the thermal cycler, DNA is bound to the primer on the magnetic particles within each droplet of the emulsion, and amplified (emulsion PCR) (see FIG. 50C). Thereby, the target DNA molecule is amplified within individual droplets. That is, an amplification product of the nucleic acid is formed within each droplet. The amplified nucleic acid binds to the carrier via the primer within the droplet.

Step S5 is an emulsion breaking step of breaking down a droplet containing a carrier (magnetic particle) carrying an amplification product of nucleic acid (DNA) in the emulsion PCR step. In other words, step S5 is a step of demulsifying a fluid in the emulsion state after the emulsion PCR step. After amplifying the DNA on the magnetic particles in step S4, the emulsion is broken in step S5, and the magnetic particles containing the amplified DNA are taken out from the droplets (emulsion breaking). For the breakage of the emulsion, one or more types of emulsion breaking reagents containing alcohol, surfactant or the like are used.

Step S6 is a washing step of collecting the carrier (magnetic particle) taken out from the droplets by breakage in the emulsion breaking step. In step S6, the magnetic particles taken out from the droplets are washed in the BF separation step (primary washing). The BF separation step is a processing step of removing unnecessary substances attached to the magnetic particles by allowing the magnetic particles containing the amplified DNA to pass through the washing liquid in a state of being magnetically collected by magnetic force. In the primary washing step, for example, a washing liquid containing alcohol is used. Alcohol removes oil films on the magnetic particles and denatures the amplified double-stranded DNA into single strands.

Step S7 is a hybridization step in which an amplification product on the carrier (magnetic particle) collected in the washing step is reacted with a labeling substance. After washing, in step S7, the DNA denatured to single strands on the magnetic particles is hybridized with the labeling substance for detection (hybridization) (see FIG. 50D). The labeling substance includes, for example, a fluorescent substance. The labeling substance is designed to specifically bind to the DNA to be detected.

In step S8, the magnetic particles bound to the labeling substance are washed in the BF separation step (secondary washing). The secondary BF separation step is performed by the same processing as the primary BF separation step. In the secondary washing step, for example, PBS (phosphate buffered saline) is used as a washing liquid. PBS removes unreacted labeled substances (including labeling substances nonspecifically adsorbed to the magnetic particles) not bound to DNA.

In step S9, DNA is detected via the hybridized labeling substance. DNA is detected, for example, with a flow cytometer. In a flow cytometer, magnetic particles containing DNA bound to a labeling substance flow through a flow cell, and the magnetic particles are irradiated with laser light. The fluorescence of the labeling substance emitted by the irradiated laser light is detected.

DNA may be detected by image processing. For example, magnetic particles containing DNA bound to a labeling substance are dispersed on a flat slide, and the dispersed magnetic particles are imaged by a camera unit. Based on the captured image, the number of magnetic particles emitting fluorescence is counted.

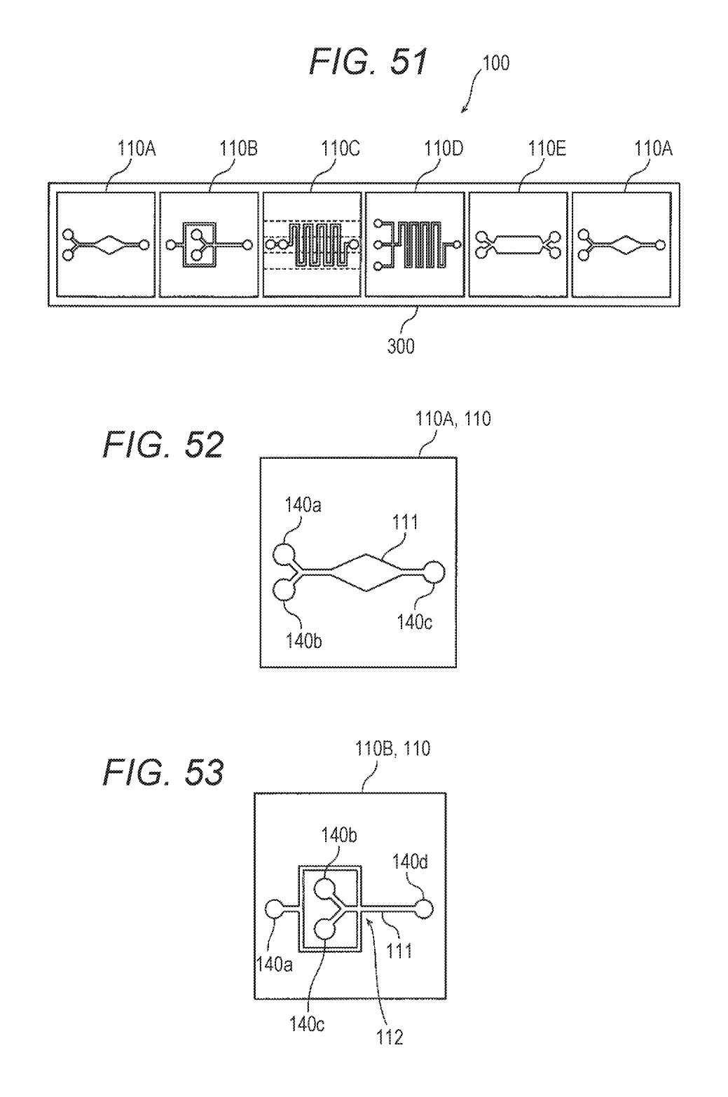

Below, a configuration example of a flow path 110 for performing emulsion PCR assay and an example of a liquid feeding method are shown. As shown in FIG. 51, each of the flow paths 110 described below may be formed in a single specimen processing chip 100. Or, as shown in FIGS. 44, 47 and 48, each of the flow paths 110 may be formed in a separate specimen processing chip 100. In the case where the flow paths 110 for performing different processing steps are formed in a single specimen processing chip 100, the liquid feeder 500 can collectively perform a plurality of processing steps in the single specimen processing chip 100. In the case of using a plurality of specimen processing chips 100 where the flow paths 110 for performing different processing steps are formed, a liquid feeding processing to a first specimen processing chip 100 is performed in accordance with the order of the processing steps, the processed sample is injected into a first well 120 of a second specimen processing chip 100, the liquid feeding processing to the second specimen processing chip 100 is performed, and the third and subsequent processing are performed in the same manner. As described above, a series of emulsion PCR assays can be performed by sequentially exchanging the specimen processing chip 100 and performing separate specimen processing steps.

<Pre-PCR>

FIG. 52 shows a configuration example of a flow path for performing pre-PCR processing. A flow path 110A has a channel 111, connection portions 140a and 140b for injecting a reagent and a specimen, and a connection portion 140c for discharging a liquid. The channel 111 is formed, for example, in a diamond shape for controlling the flow rate of the liquid.

The flow path 110A is formed of, for example, a material having high heat resistance such as polycarbonate. The height of the channel 111 is formed to, for example, 50 μm to 500 μm.

For example, the DNA extracted in the preprocessing is injected as a first liquid 10 from the connection portion 140a connected to a first well 120a by a first liquid feeding mechanism 510, and a reagent for PCR amplification is injected from the connection portion 140b connected to a first well 120b as the first liquid 10. The temperature of the mixed liquid of the DNA and the reagent is controlled by a heater 591 in the process of flowing through the channel 111. By temperature control, the DNA and the reagent react, and the DNA is amplified. The liquid containing the amplified DNA is transferred to an adjacent flow path 110 or a collection holding section 160 via the connection portion 140c.

<Emulsion Formation>

FIG. 53 shows a configuration example of a flow path 110B for performing emulsion forming processing. The flow path 110B has a channel 111, connection portions 140a, 140b and 140c into which a liquid such as a specimen or a reagent is injected, and a connection portion 140d from which the liquid is discharged. The channel 111 has an intersection portion 112 where at least two channels intersect. The width of each channel forming the intersection portion 112 is several tens of μm. In this example, the width of the channel is 20 μm. Only either of the connection portion 140b or 140c may be provided in the flow path 110B.

The height of the channel 111 of the flow path 110B is, for example, 10 μm to 20 μm. In order to improve wettability to oil, for example, the wall surface of the channel 111 is treated with a hydrophobic material or fluorine. The material of the flow path 110B is, for example, PDMS, PMMA or the like.

For example, a first liquid 10 containing DNA amplified by Pre-PCR is fed from a first well 120a to the connection portion 140b by the first liquid feeding mechanism 510. A third liquid 30 containing magnetic particles and a reagent for PCR amplification is fed from a first well 120b to the connection portion 140c by the first liquid feeding mechanism 510. The liquids injected from the connection portions 140b and 140c, respectively, are mixed in the channel 111 and flow into the intersection portion 112. The particle size of the magnetic particles is, for example, 0.5 μm to 3 μm. In order to feed liquid to the connection portions 140b and 140c, a first pressure source 511 of the first liquid feeding mechanism 510 adds a pressure P (1000 mbar≤P≤10000 mbar).

For example, a second liquid 20, which is an oil for emulsion formation, is fed to the connection portion 140a connected to a second injection port 131 by a second liquid feeding mechanism 520. The injected oil is branched into a plurality of paths in the channel 111 and flows into the intersection portion 112 from the branched plural paths. In order to feed oil to the connection portion 140a, a second pressure source 521 of the second liquid feeding mechanism 520 adds a pressure P (1000 mbar≤P≤10000 mbar).

As shown in FIG. 45, the mixed liquid of the first liquid 10 is divided into droplets by the shear force generated by being interposed by the oil at the intersection portion 112. The divided droplets are surrounded by the oil flowing into the intersection portion 112, thereby forming an emulsion. A sample stream which has become an emulsion is transferred to an adjacent flow path 110 or a collection holding section 160 via the connection portion 140d.

For example, the mixed liquid of DNA and a reagent flows into the intersection portion 112 at a flow rate of 0.4 μL/min to 7 μL/min, and the oil flows into the intersection portion 112 at a flow rate of 1 μL/min to 50 μL/min. The flow rate is controlled by the pressure applied by the second liquid feeding mechanism 520. For example, the mixed liquid of DNA and a reagent at a flow rate of 2 μL/min (about 5200 mbar) and the oil at a flow rate of 14 μL/min (about 8200 mbar) are respectively flown into the intersection portion 112, whereby droplets of about 10 million pieces/min are formed. The droplets are formed at a rate of, for example, about 600,000 pieces/min to about 18 million pieces/min (about 10,000 pieces/sec to about 300,000 pieces/sec).

<PCR>

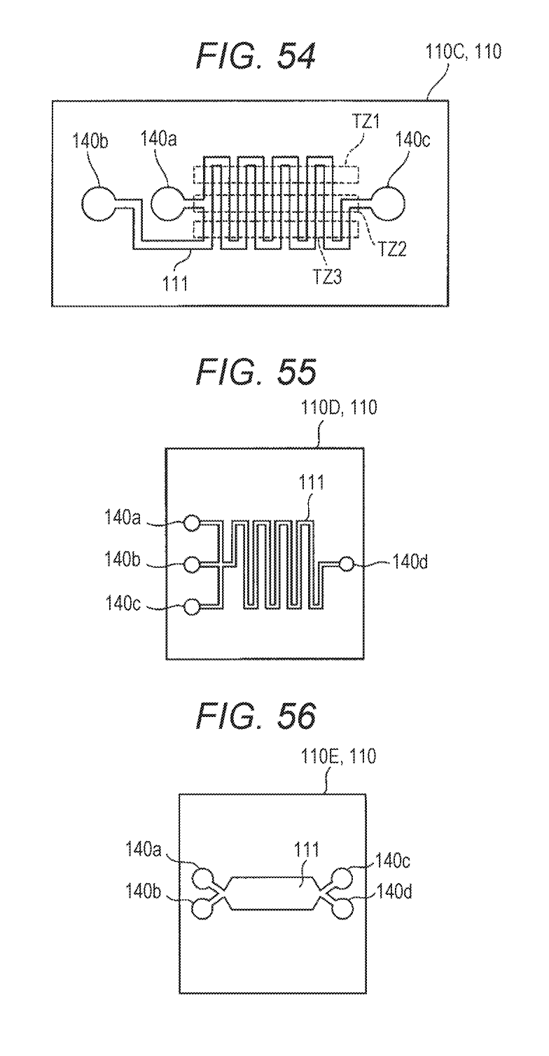

FIG. 54 shows a configuration example of a flow path 110C for performing emulsion PCR processing. The flow path 110C has a channel 111, connection portions 140a and 140b into which liquid flows, and a connection portion 140c from which the liquid is discharged.

The flow path 110C is formed of, for example, a material having high heat resistance like polycarbonate. The height of the channel 111 is formed to, for example, 50 μm to 500 μm.

The channel 111 has such a structure that it passes through a plurality of temperature zones TZ1 to TZ3 formed by a heater 591 plural times. The number of times that the channel 111 passes through each of the temperature zones TZ1 to TZ3 corresponds to the number of thermal cycles. The number of thermal cycles of emulsion PCR is set to, for example, about 40 cycles. Therefore, although shown in a simplified manner in FIG. 54, the channel 111 is formed in a reciprocating shape or meandering shape for the number of cycles according to the number of cycles so as to traverse each of the temperature zones TZ1 to TZ3 about 40 times.

For example, droplets 50 containing magnetic particles and a reagent for PCR amplification and the first liquid 10 that is an emulsion with oil are fed from a first well 120 to the connection portion 140a by the first liquid feeding mechanism 510. The second liquid 20 for conveying the first liquid 10 is fed to the connection portion 140b via a second injection port 131 by the second liquid feeding mechanism 520. The DNA in each droplet 50 in the first liquid 10 is amplified in the process of flowing through the channel 111. That is, as shown in FIG. 50C, the DNA is amplified in the individual droplet 50, and the amplification product of DNA is bound to magnetic particle 33 via a primer. A fluid containing the droplet 50 containing the amplified DNA is transferred to an adjacent flow path 110 or a collection holding section 160 via the connection portion 140c.

<Emulsion Breaking>

FIG. 55 shows a configuration example of a flow path 110D for performing processing of emulsion breaking. The flow path 110D has a function of mixing a plurality of liquids. The flow path 110D includes a channel 111, connection portions 140a, 140b and 140c into which an emulsion and a reagent for demulsification for emulsion breaking flow, and a connection portion 140d from which the liquid is discharged.

The flow path 110D is formed of, for example, a material having high chemical resistance like polycarbonate or polystyrene. The height of the channel 111 is formed to be, for example, 50 μm to 500 μm.

For example, a first liquid 10 comprising an emulsion subjected to the emulsion PCR step is fed from a first well 120 holding the first liquid 10 to the connection portion 140b by the first liquid feeding mechanism 510. A second liquid 20 containing a reagent for emulsion breaking is fed from a second injection port 131 to the connection portions 140a and 140c by the second liquid feeding mechanism 520. As an example, for example, the first liquid 10 comprising an emulsion is fed to the flow path 110D at a flow rate of about 2 μL/min, and the reagent for emulsion breaking is fed to the flow path 110D at a flow rate of about 30 μL/min. The emulsion and the reagent for emulsion breaking are mixed in the process of flowing through the channel 111, and the droplets in the emulsion are broken. The channel 111 is configured in a shape that promotes mixing of the liquid. For example, the channel 111 is formed so that the liquid reciprocates a plurality of times in the width direction of the specimen processing chip 100. The magnetic particles taken out from the droplet are transferred to the adjacent flow path 110 or the collection holding section 160 via the connection portion 140d.

<Washing (Primary Washing)>

FIG. 56 shows a configuration example of a flow path 110E used in a washing step (primary washing). The flow path 110E includes connection portions 140a and 140b into which liquid flows, connection portions 140c and 140d from which the liquid is discharged, and a channel 111.

The channel 111, for example, has a shape extending linearly in a predetermined direction, such as a substantially rectangular shape. Further, the channel 111 has a wide shape so as to sufficiently magnetically collect and disperse magnetic particles. The connection portions 140a and 140b on the inflow side are disposed on one end side of the channel 111, and the connection portions 140c and 140d on the discharge side are disposed on the other end side of the channel 111.

The flow path 110E is formed of, for example, a material having high chemical resistance like polycarbonate or polystyrene. The height of the channel 111 is formed to be, for example, 50 μm to 500 μm.

FIG. 57 shows an operation example of washing and concentrating the magnetic particles 33 carrying DNA by a flow path 110E. The liquid containing the magnetic particles 33 flows from the connection portion 140a to the connection portion 140c. For example, a first liquid 10 comprising an emulsion subjected to the emulsion PCR step is fed from a first well 120 holding the first liquid 10 to the connection portion 140a by the first liquid feeding mechanism 510. In the case of FIG. 57, as the processing unit 590 shown in FIG. 43, a magnet unit 592 for applying a magnetic force to the flow path 110 is used. The magnet unit 592 magnetically collects the magnetic particles 33 in the flow path 110 by a magnet 640. The magnetic particles 33 in the liquid are concentrated by a magnetic force of the magnet 640. The magnet 640 can reciprocate in the longitudinal direction of the channel 111. The magnetic particles 33 follow the reciprocating motion of the magnet 640 and aggregate while reciprocating in the channel 111.

The second liquid 20 comprising a washing liquid such as alcohol is fed from a second injection port 131 to the connection portion 140b by the second liquid feeding mechanism 520. The second liquid feeding mechanism 520 continuously feeds the washing liquid from the connection portion 140b to the connection portion 140d. The connection portion 140d is connected to a discharge port 150 and functions as a drain for discharging the washing liquid. In the flow of the washing liquid, the magnetic particles 33 reciprocate in the channel 111 following the operation of the magnet 640, whereby washing processing is performed. The magnetic particles 33 reciprocate in the channel 111 following the operation of the magnet 640, whereby the magnetic particles 33 are prevented from sticking to each other to form a lump.

In the primary washing step, a washing liquid containing alcohol is used as the second liquid 20. By the primary washing using the washing liquid, the oil films on the magnetic particles 33 are removed, and the amplified double-stranded DNA is denatured into single strands.

<Hybridization>

A third liquid 30 comprising a reagent containing a labeling substance 32 is fed from a first well 120 holding the third liquid 30 to a connection portion 140a by the first liquid feeding mechanism 510. As the processing unit 590 shown in FIG. 43, a heater 591 for amplifying DNA by PCR in a flow path 110 is used. The heater 591 warms the specimen processing chip 100. The magnetic particles after the primary washing step are mixed with the reagent containing a labeling substance 32 in the channel 111 and subjected to a thermal cycle. By the thermal cycle, the DNA on the magnetic particle and the labeling substance 32 are bound.

<Washing (Secondary Washing)>

A secondary washing step after hybridization (binding) with a labeling substance is performed in the channel 111. In the secondary washing step, PBS is used as a washing liquid. A second liquid 20 comprising PBS is fed from the second injection port 131 to the connection portion 140b by the second liquid feeding mechanism 520. The washing liquid flows through the channel 111 in a state where the magnetic particles 33 are magnetically collected in the channel 111 by the magnet 640 (see FIG. 57). By the secondary washing using the washing liquid, the unreacted labeling substance 32 (including the labeling substance nonspecifically adsorbed to the magnetic particles) not bound to the DNA is removed. The magnetic particles 33 containing the labeling substance 32 after the secondary washing are transferred to the collection holding section 160 via the connection portion 140c.

<Detection>

The magnetic particles containing the labeling substance after the secondary washing are detected by, for example, a flow cytometer or image analysis. In order to detect with a flow cytometer, the magnetic particles containing the labeling substance are collected, for example, from the collection holding section 160 of the specimen processing chip 100 and transferred to a flow cytometer provided separately. The liquid feeder 500 may be provided with a detection unit for detecting fluorescence or the like based on a label of the magnetic particles containing the labeling substance in the flow path 110 as the processing unit 590 shown in FIG. 43. In addition, the liquid feeder 500 may include a camera unit that captures the magnetic particles containing the labeling substance, as the processing unit 590. A captured image is analyzed by the liquid feeder 500 or a computer connected to the liquid feeder 500.

<Single Cell Analysis>

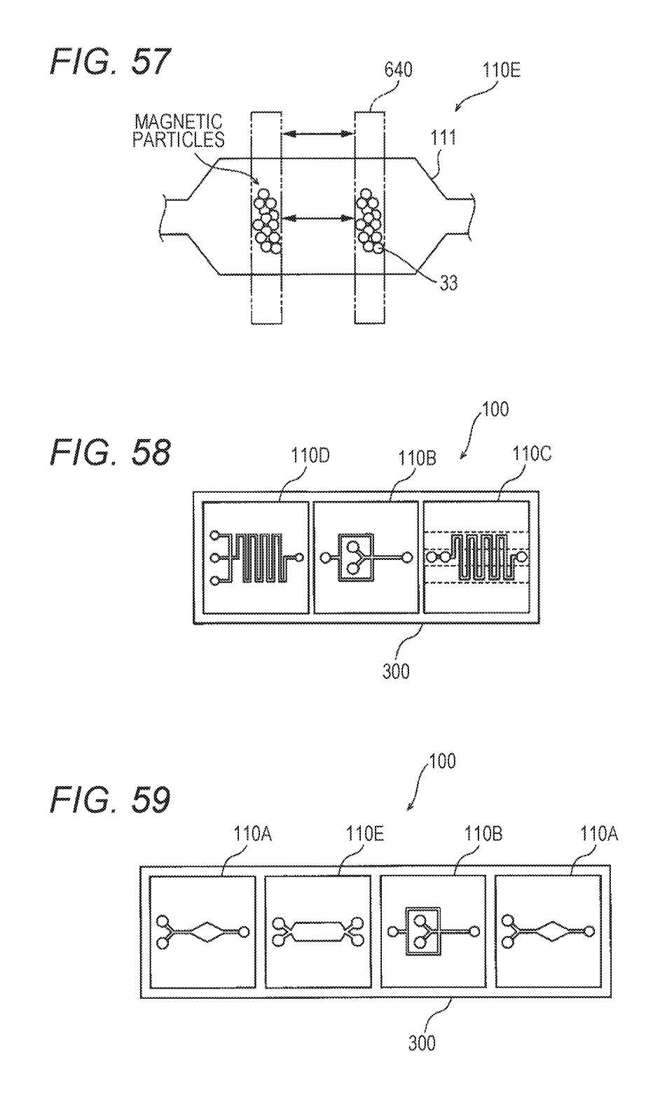

An example in which single cell analysis is performed using the above-described specimen processing chip 100 will be described. This is a method of performing analysis on a cell-by-cell basis using individual cells contained in a sample such as blood as analysis targets. FIG. 58 shows a configuration example of a specimen processing chip 100 used for single cell analysis.

The specimen processing chip 100 is constituted by, for example, a combination of a flow path 110D for mixing a liquid, a flow path 110B for emulsion formation, and a flow path 110C for PCR amplification.

Single cell analysis includes a step of mixing cells as a target component with a reagent for an amplification reaction of a nucleic acid in the cells (first step), a step of forming droplets containing a mixed liquid of a liquid mixed in the first step and a cell lysis reagent, in a dispersion medium (second step), and a step of amplifying in the droplets a nucleic acid eluted from the cells in the droplets in the second step (third step).

A specimen such as blood is injected from the connection portion 140b of the flow path 110D, and a reagent for PCR amplification is injected from the connection portions 140a and 140c. The cells contained in the specimen and the reagent for PCR amplification are mixed in the process of flowing through the channel 111. The mixed liquid is transferred to the adjacent flow path 110B via the connection portion 140d.

The mixed liquid of the cells, the reagent for PCR amplification and a fluorescent dye is injected from the connection portion 140b of the flow path 110B. A cell lysis reagent is injected from the connection portion 140c. From the connection portion 140a, an oil for emulsion formation is injected. The mixed liquid of the cells, the reagent for PCR amplification and the cell lysis reagent becomes droplets 50 surrounded by oil at an intersection portion 112, thereby forming an emulsion. The droplet 50 encapsulating the mixed liquid is transferred to the adjacent flow path 110C via the connection portion 140d. The cells within the droplet are dissolved by the cell lysis reagent in the process in which the emulsion is transferred to the flow path 110C. From the lysed cells, the intracellular DNA is eluted into droplets containing the reagent for PCR amplification.

The emulsion transferred to the flow path 110C is subjected to a thermal cycle in the process of flowing through the channel 111 of the flow path 110C. By the thermal cycle, the DNA eluted from the cells within the droplet is amplified. A protein eluted from the cells within the droplets may be replaced with enzyme or detected by substrate reaction or the like.

(Immunoassay <Digital ELISA>)

An example of performing immunoassay using the above-described specimen processing chip 100 will be described. In immunoassay, proteins such as antigens and antibodies contained in blood and the like are used as target components. FIG. 59 shows a configuration example of a specimen processing chip 100 used in Digital ELISA (Enzyme-Linked ImmunoSorbent Assay).

The specimen processing chip 100 is configured by a combination of a flow path 110A for temperature control, a flow path 110E for BF separation, a flow path 110B for emulsion formation, and a flow path 110A for temperature control.

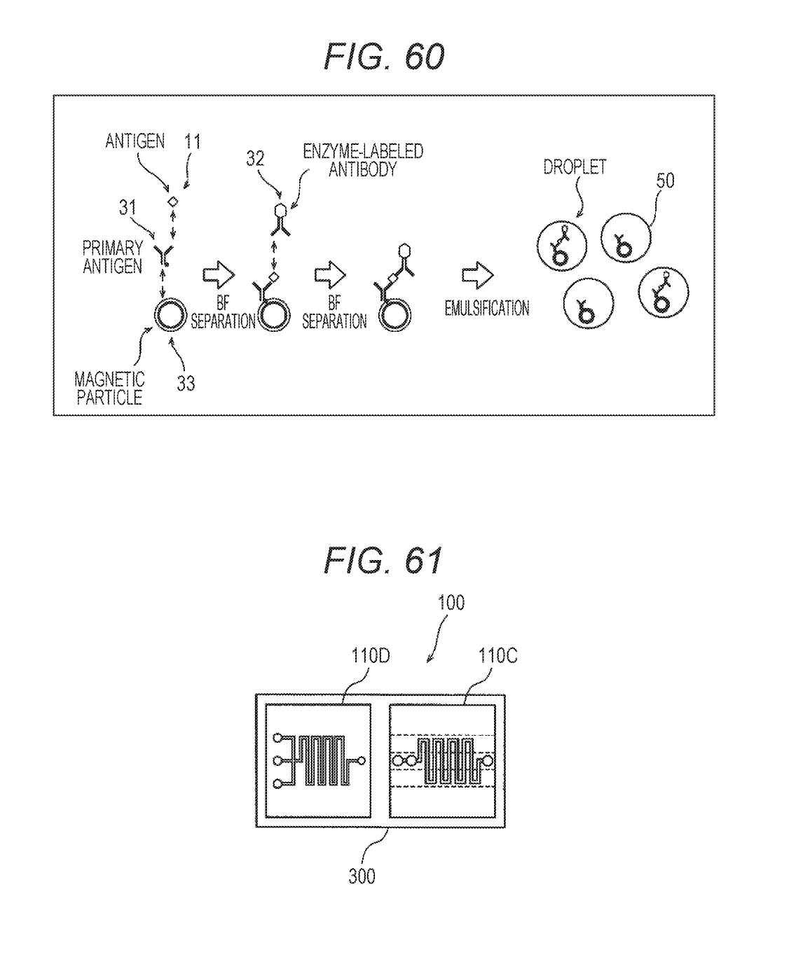

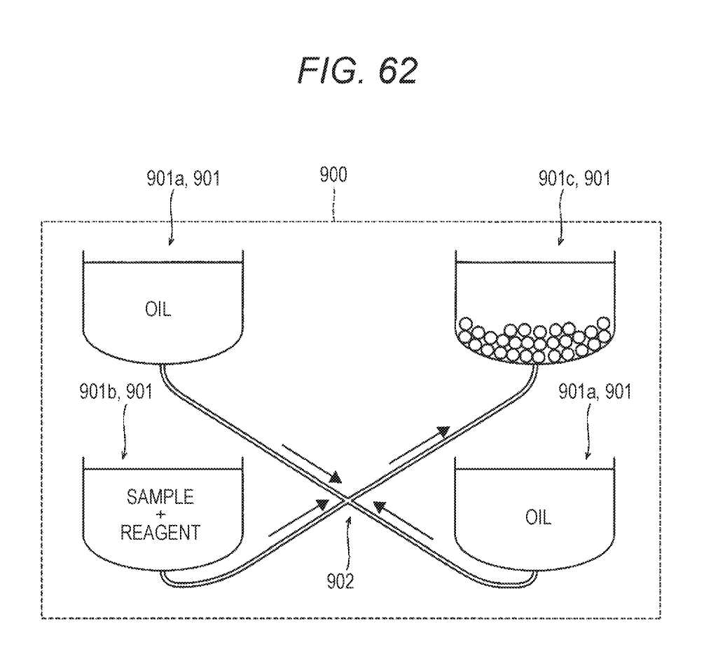

FIG. 60 shows the outline of Digital ELISA. ELISA is a method of forming an immunocomplex by carrying an antigen (which may be an antibody) to be a target component and a labeling substance on magnetic particles and detecting the target component based on the label in the immunocomplex. The Digital ELISA is a method of absolutely measuring the concentration of the target component in samples, by dispersing the samples subjected to a limiting dilution (diluted so that the target component becomes 1 or 0 in each microcompartment) in the microcompartment, and directly counting the number of microcompartments in which the signal based on the label is positive. In the case of FIG. 60, individual droplets in the emulsion are microcompartments. With the specimen processing chip 100, the assay shown in the example of FIG. 60 is performed.

More specifically, the Digital ELISA assay includes a step of forming an immunocomplex in which a target component (antigen or antibody) in a specimen 11 and a carrier are bound by an antigen-antibody reaction (first step), a step of reacting the formed immunocomplex in the first step with a labeling substance 32 (second step), a step of forming a droplet 50 including the immunocomplex bound with the labeling substance 32 in the second step and a substrate for detecting the labeling substance 32 in the dispersion medium (third step), and a step of reacting the substrate with the labeling substance 32 in the droplet 50 formed in the third step (fourth step).

A specimen containing an antigen is injected from the connection portion 140a of the flow path 110A, and a reagent containing a primary antibody and magnetic particles is injected from the connection portion 140b. The specimen and the reagent are mixed in the channel 111. The mixed liquid is subjected to temperature control in the channel 111, and an immunocomplex including an antigen, a primary antibody and magnetic particles is generated. The temperature is controlled from about 40° C. to about 50° C., and more preferably about 42° C. The liquid containing the generated complex is transferred to the adjacent flow path 110E via the connection portion 140c.

In the channel 111 of the flow path 110E, the complex containing the magnetic particles 33 is magnetically collected by the magnet 640 and washed (primary BF separation). After the primary BF separation, the influence of a magnetic force by the magnet 640 is eliminated, and the immunocomplex is dispersed. The dispersed immunocomplex is reacted with an enzyme-labeled antibody. After the reaction, the immunocomplex is magnetically collected again by the magnet 640 and washed (secondary BF separation). After washing, the immunocomplex is transported to the adjacent flow path 110B.

The complex is injected from the connection portion 140b of the flow path 110B, and a reagent containing a fluorescence/luminescent substrate is injected from the connection portion 140c. The oil for emulsion formation is injected from the connection portion 140a. The liquid containing the immunocomplex and the reagent containing the fluorescent/luminescent substrate are encapsulated by oil to form droplets at the intersection portion 112, thereby forming an emulsion. The emulsion is transferred from the connection portion 140c to the adjacent flow path 110A.

The emulsion transferred to the flow path 110A is warmed in the channel 111, the substrate and the immunocomplex react with each other within individual droplets, and fluorescence is generated. The detection unit as a processing unit 590 of the liquid feeder 500 detects fluorescence. As a result, detection of one molecule unit of the target component contained in individual droplets becomes possible.

(PCR Assay)

An example in which a PCR assay is performed using the above-described specimen processing chip 100 will be described. FIG. 61 shows a configuration example of a specimen processing chip 100 used in the PCR assay.

In the flow path 110D, a nucleic acid as a target component and a reagent for gene amplification are mixed. For example, in the amplification of a mutant gene by clamp PCR method, a reagent for gene amplification containing a probe selectively binding to a mutant gene is mixed with a target component. The mixed sample is transferred from the connection portion 140d to the adjacent flow path 110C. In the flow path 110C, PCR is performed by temperature control of a heater 591 in the continuous fluid. In the example of FIG. 61, a simple real-time PCR using a small specimen processing chip 100 becomes possible, so that it is possible to realize a small chip for point of care (POC) that performs inspection and diagnosis at the patient's treatment site.

The assay using the specimen processing chip 100 is not limited to the above example, and the specimen processing chip 100 may be configured for any other assay by combination of the flow paths 110.

It should be considered that the embodiment disclosed herein is an example in all respects and is not restrictive. The scope of the present invention is indicated not by the description of the above embodiment but by the scope of claims, and further includes meanings equivalent to the scope of claims and all changes (modifications) within the scope.

What is claimed is:

1. A specimen processing chip installed in a liquid feeder, the specimen processing chip comprising:
a flow path through which a first liquid and a second liquid flow;
a first well having a first injection port that receives the first liquid injected therethrough, and a first liquid feed port that feeds the first liquid injected from the first injection port to the flow path, the first liquid feed port having a diameter that is smaller than a diameter of the first injection port;
a second well having a second injection port that receives the second liquid fed from the liquid feeder injected therethrough, and a second liquid feed port that feeds the second liquid injected from the second injection port to the flow path, the second liquid feed port having a diameter that is smaller than a diameter of the second injection port; and
an identification section configured to distinguish between the first injection port and the second injection port.

2. The specimen processing chip according to claim 1, wherein the first well is configured to hold the first liquid containing a living body-derived specimen.

3. The specimen processing chip according to claim 1, comprising a plurality of the first wells, wherein
the identification section is provided to identify the first injection ports of a plurality of the first wells from each other.

4. The specimen processing chip according to claim 3, wherein the plurality of the first wells contains,
the first well holding the first liquid, and
the first well holding a third liquid containing a component corresponding to the inspection item of a specimen inspection using the specimen processing chip.

5. The specimen processing chip according to claim 1, wherein the identification section includes an identification mark provided on the surface of the specimen processing chip.

6. The specimen processing chip according to claim 5, wherein the identification mark includes at least any one of a printed mark, an engraved mark, and a label mark.

7. The specimen processing chip according to claim 1, wherein the identification section includes a colored part provided in the specimen processing chip.

8. The specimen processing chip according to claim 1, wherein the identification section includes a cylindrical structure constituting the first well, and is configured so that the first injection port into which the first liquid is to be injected can be identified, based on at least any one of an outer diameter, a planar shape and a height of the cylindrical structure.

9. The specimen processing chip according to claim 1, comprising a main body part where the flow path is formed, wherein
the first well is formed so as to protrude from the surface of the main body part, and is constituted of a cylindrical structure where the first injection port is formed at an upper end thereof, and
the second well is formed so as to protrude from the surface of the main body part, and is constituted of a cylindrical structure where the second injection port is formed at an upper end thereof.

10. The specimen processing chip according to claim 1, comprising a main body part where the flow path is formed, wherein
the first well is constituted of the first injection port formed on the surface of the main body part and a recessed portion recessed inside the main body part, and
the second well is constituted of the second injection port formed on the surface of the main body part and a recessed portion recessed inside the main body part.

11. The specimen processing chip according to claim 1, wherein the first injection port and the second injection port both have an opening shape into which a tip of an injection tool having a dispensing amount corresponding to the capacity of the first well can be inserted.

12. The specimen processing chip according to claim 1, wherein positions of the first injection port and the second injection port in the thickness direction of the specimen processing chip substantially coincide.

13. The specimen processing chip according to claim 1, comprising a plurality of unit flow path structures including the first well, the second well and the flow path, wherein
the identification section is configured to identify the first injection port into which the first liquid is to be injected, in each of the plurality of unit flow path structures.

14. The specimen processing chip according to claim 1, comprising a plurality of the first wells, wherein
the plurality of the first wells is arranged at a predetermined pitch.

15. The specimen processing chip according to claim 14, wherein the plurality of the first wells is arranged at a pitch conforming to the standard specification that defines a pitch between wells in a microplate.

16. The specimen processing chip according to claim 15, wherein the plurality of the first wells is arranged at a pitch corresponding to a pitch between wells in a 96-well microplate, and is provided side by side in eight or twelve in the arrangement direction.

17. The specimen processing chip according to claim 1, comprising the plurality of the first wells, wherein
the plurality of the first wells includes the first well for holding the first liquid containing a living body-derived specimen and the first well for holding a third liquid containing a component corresponding to the inspection item of a specimen inspection using the specimen processing chip, and
the identification section is at least provided in the first well for holding the first liquid.

18. A liquid feeder for a specimen processing chip, the liquid feeder configured to feed a liquid to the specimen processing chip, the processing chip having a flow path through which the liquid flows, the liquid feeder comprising:
an installation section that holds the specimen processing chip, the specimen processing chip having a first well and a second well therein;
a first liquid feeding mechanism that feeds a first liquid injected into the first well through a first injection port in the first well from a first liquid feed port to the flow path, the first liquid feed port having a diameter that is smaller than a diameter of the first injection port;
a second liquid feeding mechanism that feeds a second liquid to the second well through a second injection port in the second well from a second liquid feed port to the flow path, the second liquid feed port having a diameter that is smaller than a diameter of the second injection port; and
an identification mechanism that distinguishes between the first injection port and the second injection port in the specimen processing chip.

19. The liquid feeder for a specimen processing chip according to claim 18, wherein the identification mechanism includes a light emitting part for indicating the position of the first injection port, in the specimen processing chip installed in the installation section.

20. A liquid feeding method for feeding liquid to a specimen processing chip having a flow path through which the liquid flows, the method comprising:
providing an injection tool and injecting a first liquid through a first injection port of a first well in the specimen processing chip, the first injection port having an identification section;
providing a liquid feeder and feeding the first liquid from a first liquid feed port of the first well to the flow path, the first liquid feed port having diameter that is smaller than a diameter of the first injection port;
feeding a second liquid from the liquid feeder through a second injection port of a second well in the specimen processing chip, the second injection port lacking the identification section;
feeding the second liquid from the second well to the flow path from a second liquid feed port of the second well, the second liquid feed port having a diameter that is smaller than a diameter of the second injection port; and
forming a fluid containing the first liquid fed through the first liquid feed port and the second liquid fed through the second liquid feed port, in the flow path.
